(19) United States
(12) Patent Application Publication
(10) Pub. No.: US 2009/0012920 A1
(43) Pub. Date: Jan. 8, 2009

(54) Human Artificial Intelligence Software Program

(76) Inventor: Mitchell Kwok, Honolulu, HI (US)

Correspondence Address: Mitchell Kwok, 1675 Kamamalu Ave., Honolulu, HI, 96813, US

(21) Appl. No.: 12/014,742

(22) Filed: Jan. 15, 2008

Related U.S. Application Data
(63) Continuation-in-part of application No. 11/936,725, filed on Nov. 7, 2007.
Application No. 11/936,725 is a continuation-in-part of application No. 11/770,734, filed on Jun. 29, 2007.
Application No. 11/770,734 is a continuation-in-part of application No. 11/744,767, filed on May 4, 2007.
(60) Provisional application No. 61/015,201, filed on Dec. 20, 2007.
(60) Provisional application No. 60/909,437, filed on Mar. 31, 2007.

(51) Int. Cl. G06F 15/18; G06N 5/02

(52) U.S. Cl. 706/12; 706/50

(57) ABSTRACT

A method of creating human artificial intelligence in machines and computer software is presented here, as well as methods to simulate human reasoning, thought and behavior. The present invention serves as a universal artificial intelligence program that will store, retrieve, analyze, assimilate, predict the future and modify information in a manner and fashion which is similar to human beings and which will provide users with a software application that will serve as the main intelligence of one or a multitude of computer based programs, software applications, machines or compilation of machinery.

### CROSS REFERENCE TO RELATED APPLICATIONS

This application claims the benefit of U.S. Provisional Application No. 61/015,201 filed on Dec. 20, 2007, this application is also a Continuation-in-Part application of U.S. Ser. No. 11/936,725, filed on Nov. 7, 2007, entitled: Human Artificial Intelligence Software Application for Machine & Computer Based Program Function, which is a Continuation-in-Part application of U.S. Ser. No. 11/770,734, filed on Jun. 29, 2007, entitled: Human Level Artificial Intelligence Software Application for Machine & Computer Based Program Function, which is a Continuation-in-Part application of U.S. Ser. No. 11/744,767, filed on May 4, 2007, entitled: Human Level Artificial Intelligence Software Application for Machine & Computer Based Program Function, which claims the benefit of U.S. Provisional Application No. 60/909,437, filed on Mar. 31, 2007.

### STATEMENT REGARDING FEDERALLY SPONSORED RESEARCH OR DEVELOPMENT

(Not applicable)

### BACKGROUND OF THE INVENTION

1. Field of the Invention

This invention relates generally to the field of artificial intelligence. Moreover it pertains specifically to human artificial intelligence for machines and computer based software.

2. Description of Related Art

The best way to measure how intelligent an AI program is, isn't by using the Turing test, but by allowing that AI program to play videogames. There are many categories in videogames such as simulation, shooter, RPG, racing, adventure, strategy and sports. Each category comes with its own objective and rules. By allowing the AI program to play different games we can test how intelligent it is on all cognitive levels.

For the most part all videogames have one objective: to past all the levels in the game in the quickest time possible. But, each videogame has its own objectives and rules. The rules and objective of a baseball game is totally different from the rules and objective of a plane simulation game. The purpose of the AI program is to identify the objectives and rules of a videogame and use reasoning and logic to play the game.

Some games for the Playstation 2 are so hard it would take a human adult to past all the levels. Games like Contra require the player to use pattern strategies to beat the levels. By trying the game and observing the patterns of enemies, the player can devise many strategies to beat the game. Other games like Zelda for the Nintendo Wii require the player to solve problems and use sophisticated logic to past each level. Infact, the game requires the player to understand the meaning to language and to understand common sense behavior. During your adventure in the game, the player will interact with certain characters and they will give you instructions to follow to accomplish each level.

Playing videogames require an AI program to have the intelligence at a human-level (basically solving the hardest problem facing Artificial Intelligence). In prior art, there is no AI program that can play “all” videogames for all game consoles (NES, Genesis, Playstation 3, X-box 360, PSP, Wii and so forth).

### SUMMARY OF THE INVENTION

The present invention, also known as the human artificial intelligence program acts like a human brain because it stores, retrieve, and modify information similar to human beings. The function of the HAI program is to predict the future using data from memory. For example, human beings can answer questions because they can predict the future. They can anticipate what will eventually happen during an event based on events they learned in the past.

The human artificial intelligence program comprises: an artificial intelligent computer program repeats itself in a single for-loop to receive information, calculate an optimal pathway from memory, and taking action; a storage area to store all data received by said artificial intelligent program; and a long-term memory used by said artificial intelligent program.

The main for-loop in said artificial intelligent program comprises the steps of: entering said for-loop; receiving input from the environment in a frame by frame format or movie sequence called the current pathway; using the image processor and other functions to generate an initial encapsulated tree for said current pathway, searching for said current pathway in memory and finding the closest matches; calculating the future pathway of the matches found in memory and determining the optimal pathway to follow; generating an optimal encapsulated tree for said current pathway; storing said current pathway in the optimal pathway and self-organizing said current pathway with the data in a computer storage area called memory; following the future pathway of the optimal pathway, exiting said for-loop; and repeating said for-loop from the beginning.

According to an aspect of the present invention, the image processor breaks up the data in the current pathway into pieces called partial data (also called normalized visual objects). Each partial data will be searched separately in the network and slowly converge on the current pathway.

It is also a purpose of the present invention to have the ability to learn language and to understand the meaning to language. The human artificial intelligence program basically uses sentences to control every aspect of the machine. Everything from: searching for data, modifying data and storing data. Other functions are also included such as: reasoning, answering questions, solving problems, providing information or stereotypes about an object, planning tasks, solving interruption of tasks, executing tasks, thinking, sensing, focusing and so forth. All these functions are done via words and sentences.

It is also a purpose of the present invention to generate a conscious. The main function of the conscious comes from a very simple idea. During the search process, the AI program identifies target objects from the environment and activates element objects in memory that have strong association with the target objects. Two factors determine association between two objects: (1) the more times two objects are trained together, the stronger the association, (2) the closer the timing of the two objects are trained, the stronger the association. Association between two objects is actually the distance between the two objects—the closer they are the stronger the association. Two objects are considered equal when they have very strong association.

This patent application is devoted to improving on the AI program covered in patent application Ser. No. 11/936,725. Although, patent application Ser. No. 11/936,725 isn't flawed, the codes can be modified to optimize the performance of the AI program.

Two new discovers are made in this patent application. Because strong groupings in memory are chaotic and can't be predicted, an initial encapsulated tree must be created in such a way that its' encapsulated visual objects should correlate with pathways in memory. This is difficult because the strong pathways (or data) are chaotic and can't be predicted—not even with an expert image processor. My first discovery is that the image processor can generate “any” structure for the initial encapsulated tree and the initial encapsulated tree will still be compatible with the pathways in memory. My second discovery is that guess points doesn't match a memory object to a visual object, it matches a memory object to any visual object/s that fall in the coordinates of pixels in the memory object (this will be explained later). These two discovers provide a method that will correlate the initial encapsulated tree with pathways in memory so that the initial encapsulated tree doesn't have to go through physical re-organization (it only reorganizes visual objects matched).

This patent application will also explore two other subject matters not discussed in parent applications: future predictions and further discussion about conscious thoughts—most notably topics on forming complex intelligence in pathways.

The main purpose of pathways in memory is to create any form of intelligence. The pathways should contain patterns that will control the AI program to take action in an intelligent way. Patterns in pathways control the robot's body functions such as moving its arms and legs or searching/modifying/storing information in memory or thinking consciously of intelligent ways to solve problems.

The pathways in memory can form for-loops, while-loops, if-then statements, and-statements, or-statements, assignment statements, sequence data, patterned data, random data, static data and all the different combinations. The pathways are also able to form any type of computer program, including: databases, expert systems, genetic programs, and AI programs. Simple computer programs like a word processor or complex computer programs like the internet can form in pathways. The pathways can even form self-learning and self-accomplishing behavior to solve arbitrary problems.

As always patterns and meaning to sentences is the key to forming different types of intelligence. The robot gets its data from the environment (most notably from teachers). Teachers will teach the robot how to form these intelligent pathways. The robot will simply compare similar examples and average out pathways to find “patterns”.

This method will replace the old idea of manual insertion of rules and data into an artificial intelligence program. Most of the artificial intelligence subject matters are not used in the present invention, including: neural networks, language parsers, expert AI programs, rule-based systems, semantic models, Bayesians probability theories, genetic programming, agent programs, and recursive planning programs. The HAI program is a self-learning, self-awared, self-teaching, and self-modifying computer program that can play any videogame for any game console, drive a car, fly an airplane, build a house, write a book, start a business, cook, clean the floors or mow the lawn.

### BRIEF DESCRIPTION OF THE DRAWINGS

For a more complete understanding of the present invention and for further advantages thereof, reference is now made to the following Description of the Preferred Embodiments taken in conjunction with the accompanying Drawings in which:

FIG. 1 is a software diagram illustrating a program for human artificial intelligence according to an embodiment of the present invention.

FIG. 2 is a diagram depicting how frames are stored in memory.

FIGS. 3A-3B are flow diagrams depicting forgetting data in pathways.

FIGS. 4A-4B are illustrations to demonstrate how 2-dimensional movie sequences can be represented in a 3-dimensional way.

FIGS. 5A-5B are diagrams depicting iterations of the current pathway.

FIG. 6 is a diagram depicting the data structure of the initial encapsulated tree for the current pathway.

FIG. 7 is an illustration to demonstrate priority percents of visual objects.

FIG. 8 is a block diagram to depict the structure of a visual object.

FIG. 9 is an illustration depicting how visual objects are compared.

FIGS. 10-11 are illustrations to demonstrate image layers dissected by using previous optimal encapsulated trees.

FIG. 12 is an illustration of generating alternative variations to one visual object.

FIG. 13 is a diagram depicting an equation to average one variable in one visual object.

FIG. 14 is an illustration to demonstrate the existence state of pixels or visual objects in a cartoon sequence.

FIG. 15 is an illustration depicting the average values of normalized points.

FIGS. 16-17 are illustrations to demonstrate the existence state of visual objects from one frame to the next.

FIG. 18 is a diagram depicting the storage of pathways in memory.

FIG. 19 is a diagram to depict how search points search for a visual object recursively.

FIGS. 20A-20B are diagrams depicting the search process for guess points.

FIG. 21 is a diagram depicting an initial encapsulated tree for the current pathway.

FIG. 22 is a diagram depicting how the first search function finds search areas for visual objects in the initial encapsulated tree.

FIG. 23 is a diagram depicting the search function limiting multiple copies of a visual object.

FIG. 24 is a diagram to depict the structure of a search point.

FIGS. 25A-25B are diagrams showing the process of how guess points search for matches.

FIG. 25C is a cartoon illustration representing memory objects in FIGS. 25A-25B.

FIG. 26-28 are diagrams showing the search process for search pts and guess pts.

FIGS. 29A-29B are diagrams depicting the initial encapsulated tree and the optimal encapsulated tree for the current pathway.

FIGS. 30A-30C are diagrams depicting re-organization of visual objects in the optimal encapsulated tree by using learned groups.

FIGS. 31-32 are diagrams showing the formation of the optimal encapsulated tree for the current pathway.

FIGS. 33A-33B are illustrations demonstrating the search process based on 4 data types.

FIGS. 34A-34B are diagrams illustrating the initial encapsulated tree and the optimal encapsulated tree for sequence data.

FIGS. 35A-35C are diagrams showing the retraining process.

FIGS. 36-44 are diagrams showing the 4 deviation functions.

FIG. 45 is a diagram depicting the follow pathway.

FIG. 46 is a diagram depicting the worth of future pathways.

FIGS. 47A-47C are diagrams showing how floaters are created for visual objects.

FIGS. 48A-48C are diagrams showing how floaters are created for encapsulated objects.

FIGS. 49A-49B are illustrations showing how the word walk is represented.

FIGS. 50-53B are diagrams of how objects are assigned meaning.

FIG. 54 is a diagram depicting target objects and activated element objects.

FIG. 55 is a diagram depicting assigning meaning to words.

FIGS. 56A-58 are diagrams depicting target objects and element objects.

FIG. 59 is a diagram depicting a universal worksheet.

FIGS. 60A-60C are diagrams showing how the robot learns measurement words.

FIGS. 61-65 are diagrams showing insertion, deletion, and modification of tasks in pathways.

FIGS. 66-69 are diagrams showing how conscious thoughts are used to play videogames.

FIGS. 70-70B are diagrams depicting how the robot learn and follow rules.

FIG. 71 is a diagram depicting how the robot learn and follow instructions.

FIG. 72 is a diagram depicting a universal brain.

### DESCRIPTION OF THE PREFERRED EMBODIMENTS

Topics: (1) overall AI program (2) image processor, (3) search function, (4) future prediction and (5) topics on the robot's conscious.

Overall AI Program

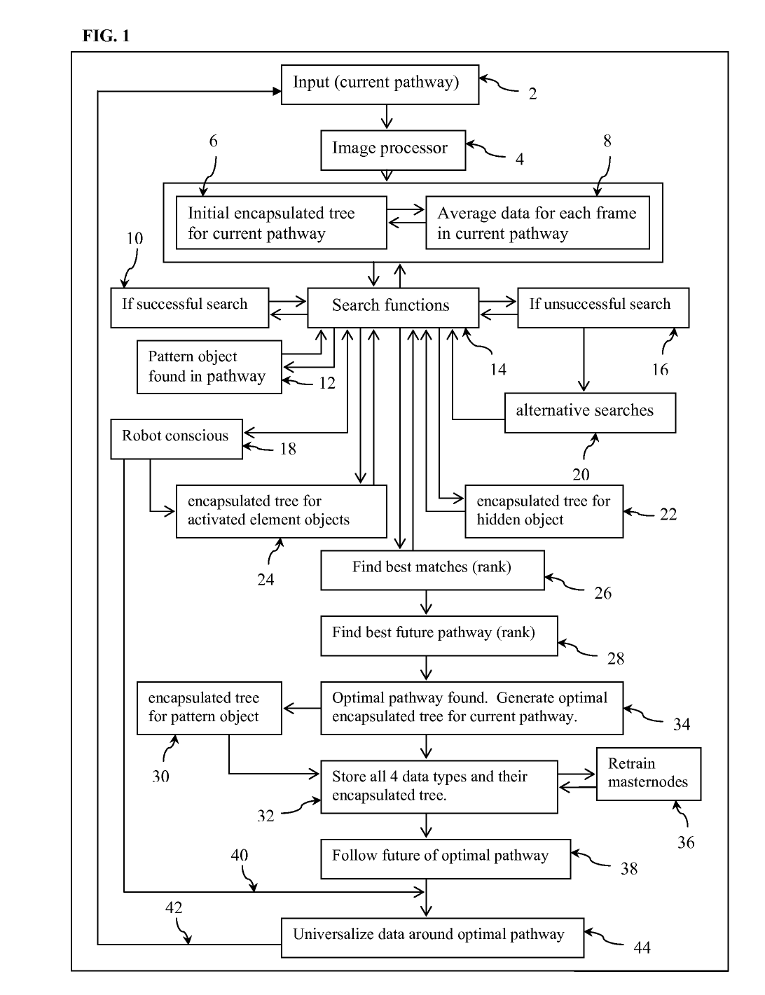

Referring to FIG. 1, the present invention is a method of creating human artificial intelligence in machines and computer based software applications, the method comprising:

an artificial intelligent computer program repeats itself in a single for-loop to receive information, calculate an optimal pathway from memory, and taking action; a storage area to store all data received by said artificial intelligent program; and a long-term memory used by said artificial intelligent program.

Said an AI program repeats itself in a single for-loop to receive information from the environment, calculating an optimal pathway from memory, and taking action. The steps in the for-loop comprises:

1. Receive input from the environment based on the 5 senses called the current pathway (block 2).

2. Use the image processor to dissect the current pathway into sections called partial data (also known as normalized visual objects). For visual objects, dissect data using 6 dissection functions: dissect image layers using previous optimal encapsulated trees, dissect image layers that are moving, dissect image layers that are partially moving, dissect image layers by calculating the 3-dimensional shape of all image layers in the movie sequence, dissect image layers using recursive color regions, and dissect image layers based on associated rules (block 4).

3. Generate an initial encapsulated tree for the current pathway and prepare visual object variations to be searched (block 6).

Average all data in initial encapsulated tree for the current pathway and determine the existence state of visual objects from sequential frames (block 8).

4. Execute two search functions to look for best pathway matches (block 14).

The first search function uses search points to match a visual object to a memory object. Uses breadth-first search because it searches for visual objects from the top-down and searches for all child visual objects before moving on to the next level.

The second search function uses guess points to match a memory object to a visual object. It uses depth-first search to find matches. From a visual object match in memory the search function will travel on the strongest-closest memory encapsulated connections to find possible memory objects. These memory objects will be used to match with possible visual objects in the initial encapsulated tree. This search function works backwards from the first search function.

The first search function will output general search areas for the second search function to search in. If the second search function deviates too far from the general search areas, the second search function will stop, backtrack and wait for more general search areas from the first search function.

The main purpose of the search function is to search for normalized visual objects separately and slowly converge on the current pathway (the current pathway is the root node in the initial encapsulated tree). All visual objects in the initial encapsulated tree must be matched. Search points and guess points call each other recursively so that top-levels of normalized visual objects will eventually be searched as well as bottom-levels of normalized visual objects.

5. Generate encapsulated trees for each new object created during runtime and include it in the initial encapsulated tree.

If visual object/s create a hidden object then generate encapsulated tree for said hidden object. Allocate search points in memory closest to the visual objects that created the hidden object (block 22).

If visual object/s activates element objects (or learned object) then generate encapsulated tree for said activated element objects. Search in memory closest to the visual object/s that activated the element object (block 24).

If pathways in memory contain patterns determine the desirability of pathway (block 12).

6. If matches are successful or within a success threshold, modify initial encapsulated tree by increasing the powerpoints and priority percent of visual object/s involved in successful search (block 10).

If matches are not found or difficult to find, try a new alternative visual object search and modify initial encapsulated tree by decreasing the powerpoints and priority percent of visual object/s involved in unsuccessful search. If alternative visual object search is a better match than the original visual object match modify initial encapsulated tree by deleting the original visual object/s and replacing it with said alternative visual object (block 16 and 20).

7. Objects recognized by the AI program are called target objects and element objects are objects in memory that have strong association to the target object. The AI program will collect all element objects from all target objects and determine which element objects to activate. All element objects will compete with one another to be activated and the strongest element object/s will be activated. These activated element objects will be in the form of words, sentences, images, or instructions to guide the AI program to do one of the following: provide meaning to language, solve problems, plan tasks, solve interruption of tasks, predict the future, think, or analyze a situation. The activated element object/s is also known as the robot's conscious (block 18 and pointer 40).

8. Rank all best pathway matches in memory and determine their best future pathways. A decreasing factorial is multiplied to each frame closest to the current state (block 26 and block 28).

9. Based on best pathway matches and best future pathways calculate an optimal pathway and generate an optimal encapsulated tree for the current pathway. All 5 sense objects, hidden objects, and activated element objects (learned objects) will construct new encapsulated trees based on the strongest permutation and combination groupings leading to the optimal pathway (block 34).

If the optimal pathway contains a pattern object, copy said pattern object to the current pathway and generate said pattern object's encapsulated tree and include it in the optimal encapsulated tree (block 30).

10. Store the current pathway and the optimal encapsulated tree (which contains 4 data types) in the optimal pathway (block 32).

Rank all objects and all of their encapsulated trees from the current pathway based on priority and locate their respective masternode to change and modify multiple copies of each object in memory (block 36).

11. Follow the future pathway of the optimal pathway (block 38).

12. Universalize data and find patterns in and around the optimal pathway. Bring data closer to one another and form object floaters. Find and compare similar pathways for any patterns. Group similar pathways together if patterns are found (block 44).

13. Repeat for-loop from the beginning (pointer 42)

The basic idea behind the AI program is to predict the future based on pathways in memory. The AI program will receive input from the environment based on 5 sense data called the current pathway. The image processor will break up the current pathway into pieces called partial data. The image processor also generates an initial encapsulated tree for the current pathway. Each partial data will be searched individually and all search points will communicate with each other on search results. Each search point will find better and better matches and converge on the current pathway until an exact pathway match is found or the entire network is searched. During the search process, visual objects will activate element objects (learned objects) or create hidden objects. Each new object created by the visual object/s will generate their respective encapsulated tree and included in the initial encapsulated tree. The optimal pathway is based on two criteria: the best pathway match and the best future pathway. After the search function is over and the AI program found the optimal pathway, the AI program will generate an optimal encapsulated tree for the current pathway. All 5 sense objects, all hidden objects, all activated element objects (or learned objects) and all pattern objects will recreate (or modify) encapsulated trees based on the strongest encapsulated permutation and combination groupings leading up to the optimal pathway. Next, the current pathway and its' optimal encapsulated tree will be stored near the optimal pathway. Then, the AI program follows the future instructions of the optimal pathway. Next, it will self-organize all data in and around the optimal pathway, compare similar pathways for any patterns and universal data around that area. Finally, the AI program repeats the function from the beginning.

Image Layers

The purpose of the storage area is to store large amounts of images and movie sequences so that data is organized in an encapsulated format to compress data and prevent unnecessary storing of repeated data. All data are also stored in memory based on association. There are two factors that will associate one object with another object: the more times two objects are trained together, the stronger the association and the closer the timing of the two objects are, the stronger the association. Objects can be images or movie sequences.

Storing 2-Dimensional Movie Sequences in a 3-Dimensional Network

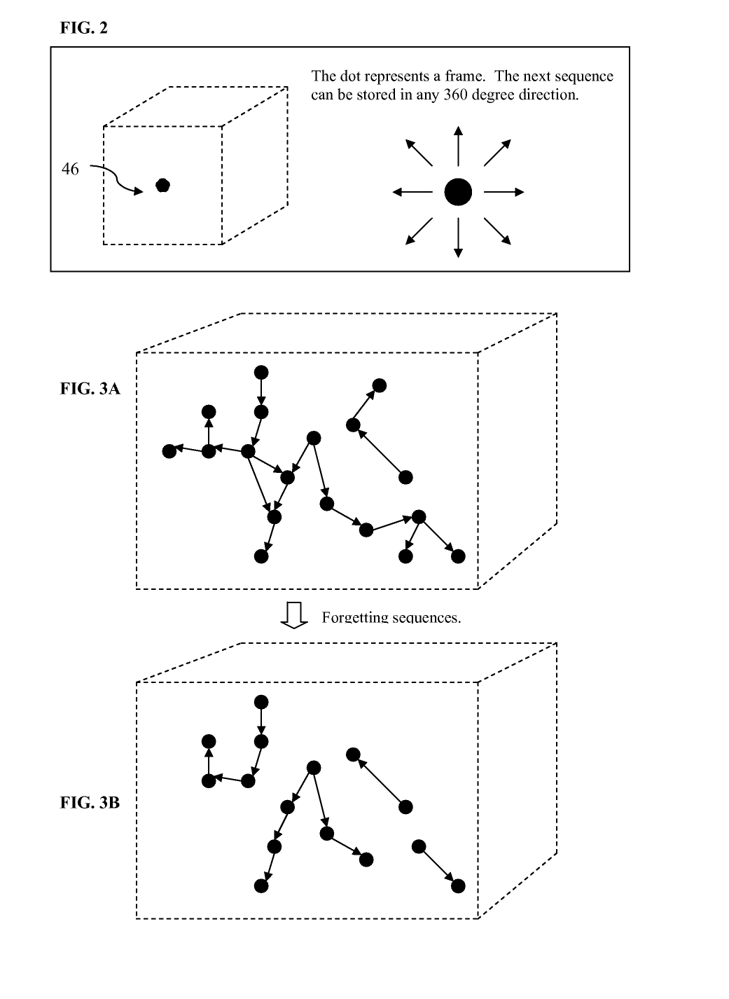

The storage area is made up of a 3-dimensional grid. Each space in the 3-d grid contains a 360 degree view. This means that each point inside the network can store the next sequence in the movie from 360 degrees. To better understand how this works, the diagram in FIG. 2 shows a 3-d grid with dot 46 in the middle. Dot 46 represents one frame in the network; and the next frame can be stored in any 360 degree direction.

This is important because life in our environment is 360 degrees at any given space. A person can stand in one place and look at the environment from the top, bottom, left, right and all the directions in between. The brain of this robot must have the means of storing every frame sequence.

The human brain stores information not in an exact manner, but in an approximate manner. The movie sequences that are trained often will be stored in memory while the movie sequences that are not trained often will not be stored in memory. For an object like a house, if a human being has seen the house from the front and side, but not from the back, then his/her memory will only have movie sequences of the house from the front and side. In fact, when data begins to forget only sections of the house from the front and side are stored in memory. This happens because data in frames forget information. FIGS. 3A-3B shows how movie pathways are forgotten.

Fabricating 3-d Data from 2-d Images

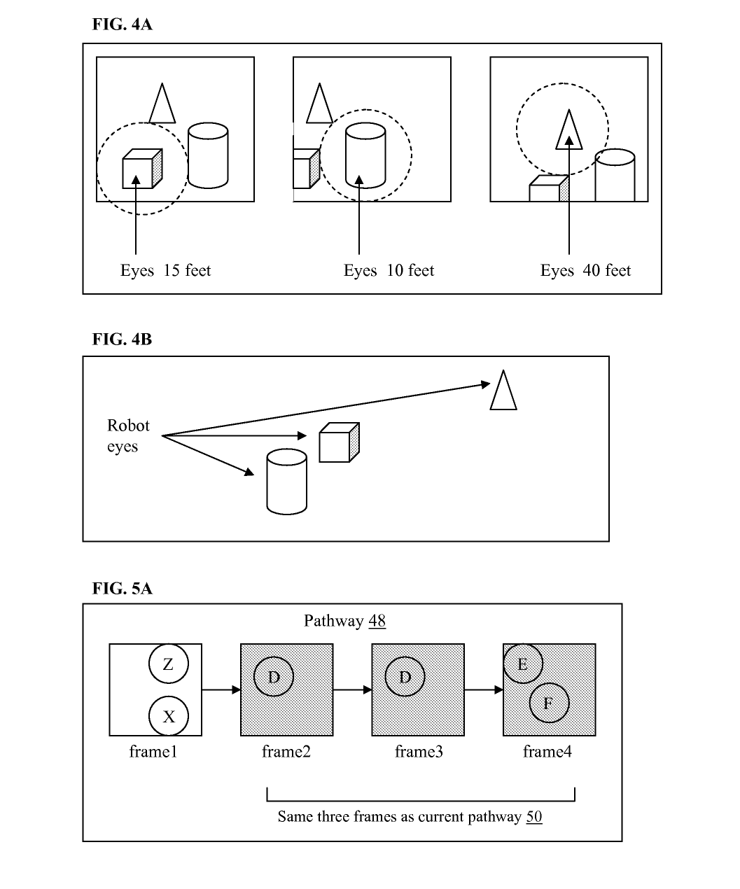

The movie sequences that are sensed by the robot are actually 2-dimensional. In order to make the robot understand the movie sequence is actually 3-dimensional we have to use focus and eye distance. Referring to FIG. 4A, human eyes are different from frames in a movie because the human eye can focus on an object while a frame from a movie has equal visibility. The focus area is clear while the peripheral vision is blurry. As the eyes focus on a close object the retinal widens, and when the eyes focus on far objects the retinal shortens. The degree in which the eye widens or shortens determine the distance between the object seen and the robot's eyes. This will give 2-d images in movie sequences dept; and provide it with enough information to interpret the data as 3-dimensional.

Based on the focus factor the robot will create 3-d data from 2-d images. This means that if there exist two images that are exactly the same in terms of pixels, it doesn't mean that they are the same 3-dimensionally. One image can be a picture of a house and the other image can be a real-life view of a house. Both are exactly the same, but the real life-view contains dept and distance. The robot will store these two images in the same group, but the distance data will be different.

Referring to FIGS. 4A-4B, the distances of the images are also important. The triangle is far away, but the cube and the cylinder is close by. If we train the example in FIG. 4A with equal frequency, then the cylinder will have higher powerpoints than the triangle because of the distance. The size of the object is also a factor in how strong (powerpoints) each object will be. The cylinder takes up more pixels than the triangle, therefore the cylinder will have more powerpoints.

The focus and eye distance is supposed to create a 3-d grid around the 2-d images. This creates dept on the 2-d images and this information will be used to break up the pixels into probable pieces. Each pixel in the frame will try to connect to each pixel in the next sequence. This is called “the existence of pixels” where the computer tries to find what objects in the movie sequences are: existing, non-existing, or changed. For example, if a human face is staring at the robot and the next frame is the human face turning to the right, the robot needs to know that the shape of different encapsulated objects has changed. It has to lock onto the morphing image of the nose, eyes, mouth, cheek bones, forehead, hair, ears, neck and so forth. Sometimes pixels in images disappear or new pixels that wasn't there before appear.

In order to recognize all these changing things the AI program has to group images together based on a variety of rules. Repetition is the key; the more the sequence is encountered the more the robot will learn the sequence. Another way of learning the existence of an object is through the human conscious where the robot learns language and activates sentences that will tell the robot what is happening in the movie sequence. All these rules will be explained further in later sections.

Image Layers and Movie Sequences

Some terminology must be established first before explaining the functions of the image processor. Objects are the items we are searching for in memory. This one object is made up of sub-objects and these sub-objects are made up of other sub-objects. One example is a movie sequence: Pixels are encapsulated in images, images are encapsulated in frames, frames are encapsulated in movie sequences and movie sequences are encapsulated in other movie sequences.

Image layers are the combination of pixels. Each image layer comprises one or more pixels. Pixels on the image layer do not have to be connected; they can be scattered or connected (Most likely pixels will be connected because the image processor group connected pixels more than scattered pixels). Sequential image layers are image layers that span in sequential frames. They can have a number of image layers in each frame. Some of these image layers can be connected or scattered (depending on the training and the robot's conscious). These image layers from frame to frame can also be existing, non-existing, or changed.

Definition and Generation of an Encapsulated Tree

Generating an encapsulated tree for a given movie sequence or individual frame can be accomplished by using dissection functions to dissect and group visual objects exclusively into a tree-like structure, the steps comprising:

1. a dissect recursion is applied to a movie sequence or individual frame whereby each recursive thread will dissect its own group into a plurality of sub-groups exclusively,
2. each recursive thread will stop when each group is broken down into its elemental parts, said elemental parts comprises individual pixels or predefined groups of pixels.

Image Processor

The image processor is designed to break up the current pathway into pieces (called partial data) so that the strongest image layers or movie sequences are dissected and grouped together in a tree-like structure. The output of the image processor is to generate an initial encapsulated tree for the current pathway. (For simplicity purposes, this invention will cover images and movie sequences only; all nodes in the encapsulated tree for the current pathway are called visual objects).

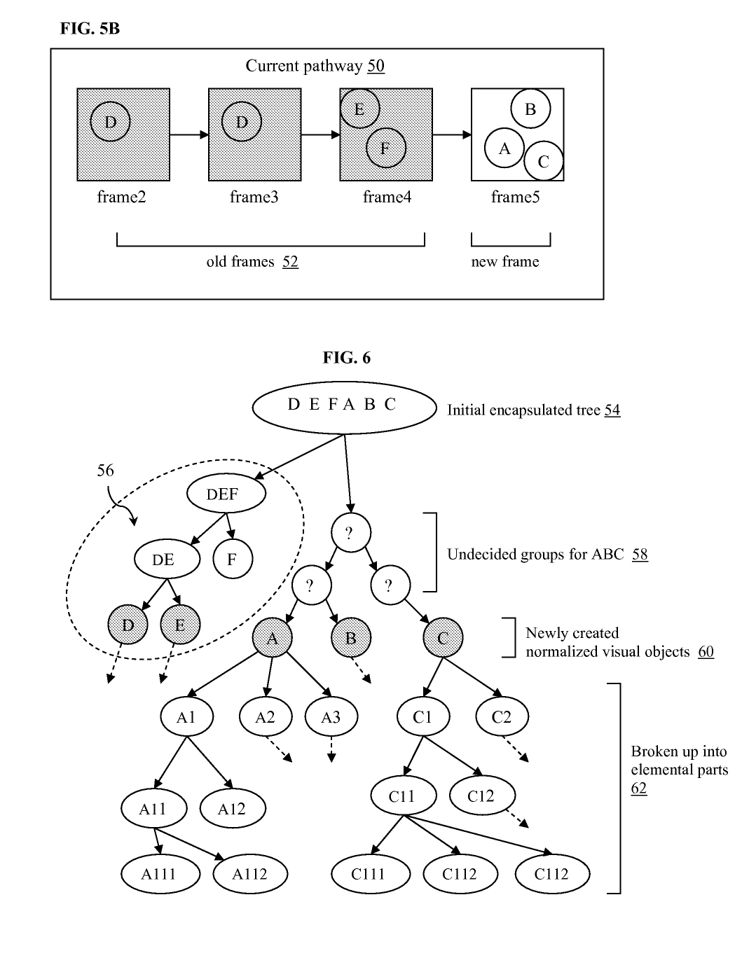

The AI program receives input from the environment through its 5 senses: sight, sound, taste, touch and smell. The length of the input will be defined by the programmer. In FIG. 5B the length of the input, or current pathway 50, is 4 frames. During each iteration of the for-loop the AI receives one extra frame from a camera and this frame will be attached to the front of the current pathway; designated as the current state. The last frame of the current pathway will be deleted. The current pathway will be the fixed pathway searched in memory at each iteration of the for-loop (on occasions, 2 or more new frames will be attached to the current pathway at each iteration of the for-loop).

The current pathway includes previously encountered frames (called old frames). FIG. 5A-5B are diagrams showing that current pathway 50 has the same 3 frames as pathway 48 (indicated by grey nodes). Frame2, frame3 and frame4 in current pathway 50 already have a previous optimal encapsulated tree, the new frame5 doesn't. The image processor is designed to break up new data or modify previous optimal encapsulated trees (most notably the new frame or previous frames close to the new frame. Referring to FIG. 5B, frame5 is the new frame from the environment, but frame2, frame3 and frame4 are old frames 52. This means sections of the initial encapsulated tree has already be constructed—encapsulated trees for frame2, frame3, and frame4 can be copied from previous optimal encapsulated trees. Visual objects in frame2, frame3 and frame4 can also be modified.

Referring to FIG. 6, the image processor has to delineate possible visual objects in the current pathway by applying the 6 dissection function. Possible visual objects are called normalized visual objects 60. Each normalized visual object will be further broken down into its elemental parts—groups of pixels or individual pixels (block 62). Visual objects are broken down exclusively and can only have one copy in separated groups. Each visual object can't be shared among separated groups (this only applies to 5 sense objects, specifically visual objects. Later on, learned objects, hidden objects and pattern objects are broken down non-exclusively and exclusively).

Referring to FIG. 6, when the normalized visual objects 60 are delineated then the image processor must break down recursively each normalized visual object into its elemental parts—groups of pixels or individual pixels (block 62). How many recursive groups are created is primarily based on the image processor. Referring to block 58, normalized visual objects can't be grouped together, they are separated and are considered partial data (or visual objects). During the search process, these partial data will be searched in memory separately and slowly converge on the current pathway.

Each node in the initial encapsulated tree is called a visual object. The top node is called a visual object, the middle-level nodes are called visual objects and the bottom-level nodes are called visual objects. FIG. 8 illustrates a visual object 66 and all information attached to it. Each visual object comprises: a frame sequence with at least one frame, three variables: (A) average pixel color (B) average total pixel count (C) average normalized point; a priority percent; a powerpoint; an existence state, encapsulated connections with other visual objects; a domain number, and search data 68.

Visual objects can be pixels, image layers, frames or frame sequences. Each frame will have its own sub-encapsulated tree. If frame sequences contain 10 frames then an encapsulated tree will be generated for each frame. The initial encapsulated tree in this case will contain all 10 encapsulated trees for all 10 frames.

Each visual object will have a priority percent. The priority percent is the importance of that visual object in a given domain. Each visual object will have a priority percent to indicate to the search function how important this visual object is. This will give the search function a better idea of what should be searched first, where should the search be done, and what possible search areas to search in. When all priority percent from all visual objects are added up, within a given domain, it will equal 100%. The current pathway is the domain for all visual objects in the initial encapsulated tree.

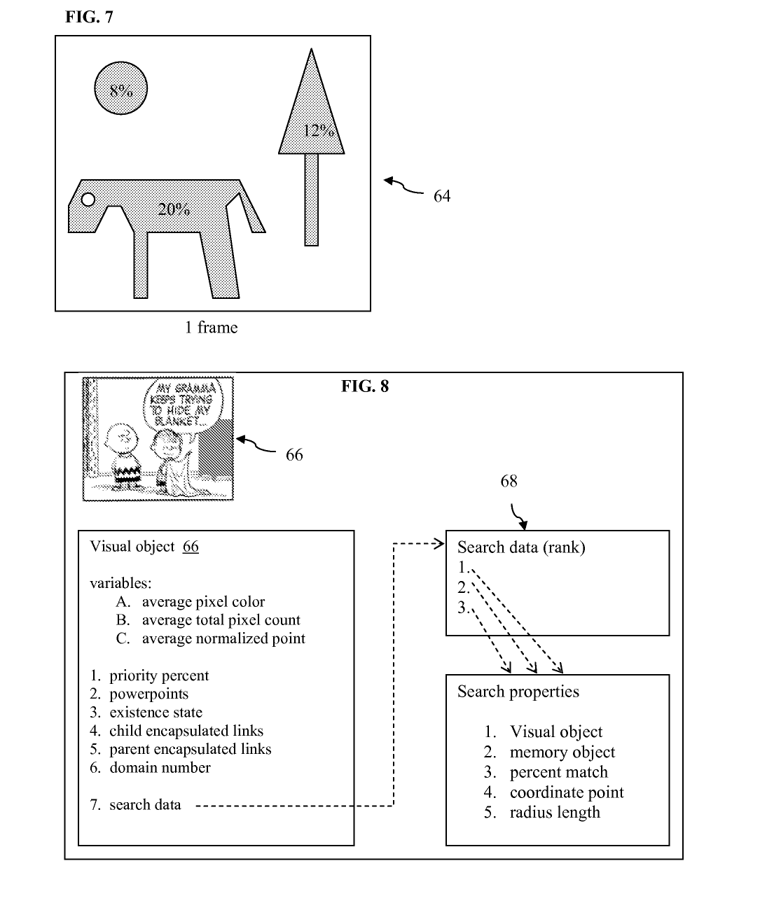

FIG. 7 shows the priority percent of visual objects in one frame. If the domain is 1 frame 64 then all images that make up that 1 frame 64 will equal 100%. In this example the image processor found the horse to be 20%, the tree 12%, the sun 8%, and the rest of the image layers make up 60%. If the tree and the horse are grouped together in a visual object then that visual object's priority percent is 32%.

Comparing Visual Objects

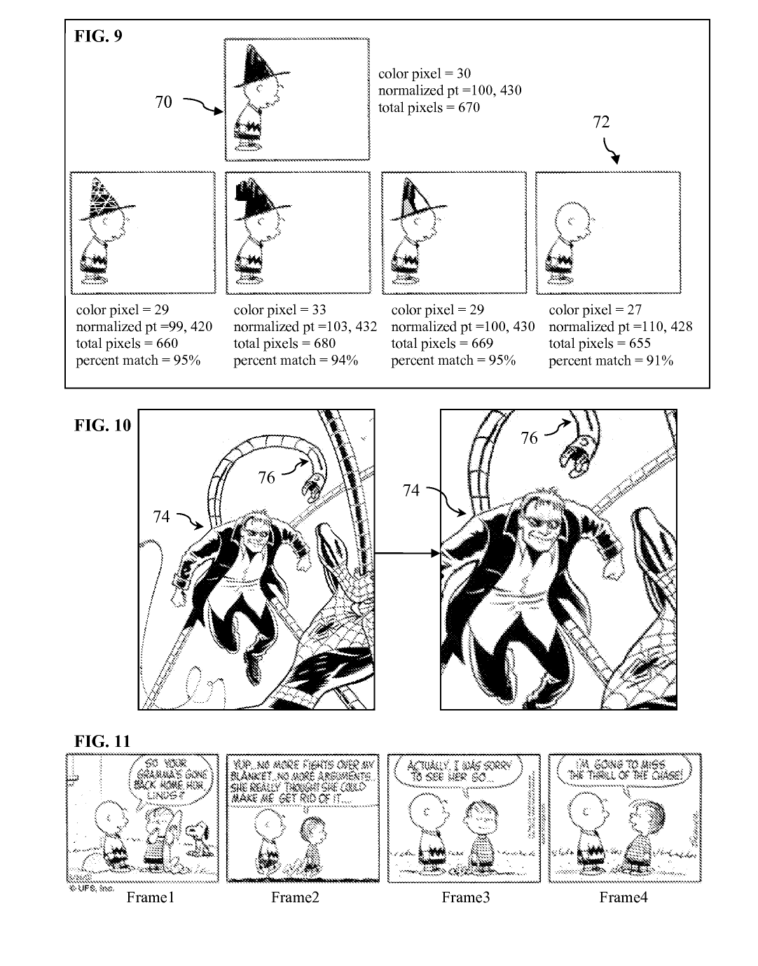

When comparing visual objects, the three variables (or comparing variables) establish the overall data to compare. The closer two visual objects are in terms of all three variables the better the match. FIG. 9 shows visual object 70 is compared to 4 similar visual objects in memory. Visual object 70 is 91% similar to visual object 72.

The image processor will use certain dissection functions to cut out prominent image layers from images and movie sequences. There are basically 6 dissection functions: dissect image layers using previous optimal encapsulated trees, dissect image layers that are moving, dissect image layers that are partially moving, dissect image layers by calculating the 3-dimensional shape of all image layers in the movie sequence, dissect image layers by calculating dominant color regions using recursion, and dissect image layers using associated rules.

The two functions that really work for still pictures is “dissecting image layers by calculating dominant color regions using recursion” and “dissecting image layers using associated rules”. Since still pictures have no pre-existing information these two functions provide a heuristic way of breaking up image layers and grouping them together.

The first four functions work well with movie sequences. In the case of “dissecting image layers that are partially moving”, the image processor will try to combine this dissection function with the last two dissection functions to cut out the remaining probable image layers.

Dissect Image Layers Using Previous Optimal Encapsulated Trees

Most of the frames in the current pathway have already been searched and therefore have a previous optimal encapsulated tree. This previous optimal encapsulated tree can be used to cut out image layers and to delineate normalized visual objects. FIG. 10 is an animation illustrating how sequential visual objects can delineate image layers in the new frame. Without this function the image processor will still be able to cut out image layer (74 and 76) because the image layer is moving. The unique thing about this dissection function is that image layers can be cut out from non-moving image layers or multiple image layers that are both moving and non-moving. FIG. 10 is an illustration of doctor octopus. Notice that in the first frame, doctor octopus 74 and his tentacle 76 are clearly one image layer. On the second frame, the image processor broken up doctor octopus into 2 image layers because each image layer is moving, but they are not connected. If the previous encapsulated tree was used to show that visual objects exist from one frame to the next, the image processor will understand that the 2 image layers from the second frame are actually one image layer.

This dissection function can also work for non-moving objects. FIG. 11 illustrates that Charlie brown is moving from frame 1 and frame 2. On frame 3 and frame 4, Charlie brown is not moving. By using previous optimal encapsulated trees the image processor will know that the non-moving image layer is Charlie brown from either finding a sequential copy in memory or by identifying the existence of color pixels from one frame to the next.

Dissect Image Layers that are Moving

This dissection function is very simple to understand. If one image layer is moving in the environment and the total image layer is found, then cut out that image layer. This means that the cut is very clean and the entire image layer is cut out from beginning to end. It's kind of like cutting out one image from a real picture, if the image can be taken out of the picture that means it's a clean cut.

Dissect Image Layers that are Partially Moving

If the cut is not clean and the image is still attached to the picture then that image is partially cut. This is what happens when some visual objects move while other visual objects stay still. One example is a human being. Someone can stand still in front of a camera and wave his arm back and forth. The arm is moving, but the human being is standing still. The image processor will not know that the arm is part of the human being.

Dissect Image Layers by Calculating Dominant Color Regions Using Recursion

The initial encapsulated tree has the average pixel color of all visual objects. The average pixel color at the top of the initial encapsulated tree will decide how important average pixel colors are in the lower-levels. Dominant colors can be computed by following a chain of parent visual objects. This information will provide the image processor with possible color regions that are considered dominant and other color regions that are considered minor. With this technique, the image processor can cut out probable image layers from still pictures.

Dissect Image Layers by Calculating the 3-Dimensional Shape of all Image Layers in Movie Sequences

By analyzing the 2-dimensional movie sequences and adding in focus and distance to the images, a 3-dimensional grid will pop up. The robot will be viewing real-life images from the environment. This grid will guide the breaking up of data in memory because it will tell the image processor where the edges of any given objects are. Focus and distance is used to show dept in a still image. Close objects will be cut out compared to far objects. For example, if there exist one frame with a still hand in front and a still human being in the background, the image processor will understand that the hand is one object that is closer to the robot than the human being. The hand is focused on so it is clear, while the human being is farther away and is fuzzy. This prompts the AI program to cut out the hand and designate that as one visual object.

Dissecting Image Layers Using the Associated Rules

The image processor will dissect image layers based on the strongest groups in memory. Grouping image layers should be based on: closest neighbor pixels, closest neighbor images, closest timing of images, closest strongest strength of images and closest training of images. Grouping movie sequences should be based on: closest next (or before) frame sequences, closest timing of frame sequences, closest training of frame sequences and closest strength of frame sequences.

A combination of criterias to store images and movie sequences above are used for storing data in memory. These criterias establish the rules to break up and group data in images and movie sequences. When an image is sensed by the AI program there are no information to establish what is on that image. There are no rules as well to break up the images into pieces. Certainly, the computer can't just randomly break up the input data and randomly group the pieces together—all objects should have defined and set boundaries. The associated rules provide a “heuristic way” to break up frame sequences into the best possible encapsulated visual objects.

The AI program receives input visually in terms of 2-dimensional movie sequences. The AI program will use hidden data from moving and non-moving objects in the movie sequences to create a 3-d representation of the 2-d movie sequences; and store the 2-d movie sequences in such a way that a 3-d environment is created.

With this said, there exist a third set of associated rules for grouping 3-d images and 3-d movie sequences. 3-d movie sequences should be grouped together based on: closest 3-d neighbor of pixels, closest 3-d neighbor of images, closest 3-d strength of images, closest 3-d training of images, closest 3-d timing of images, closest 3-d next (or before) frame sequences, closest 3-d timing of frame sequences, and closest 3-d strength of frame sequences. The image processor will dissect image layers based on the strongest groups in memory.

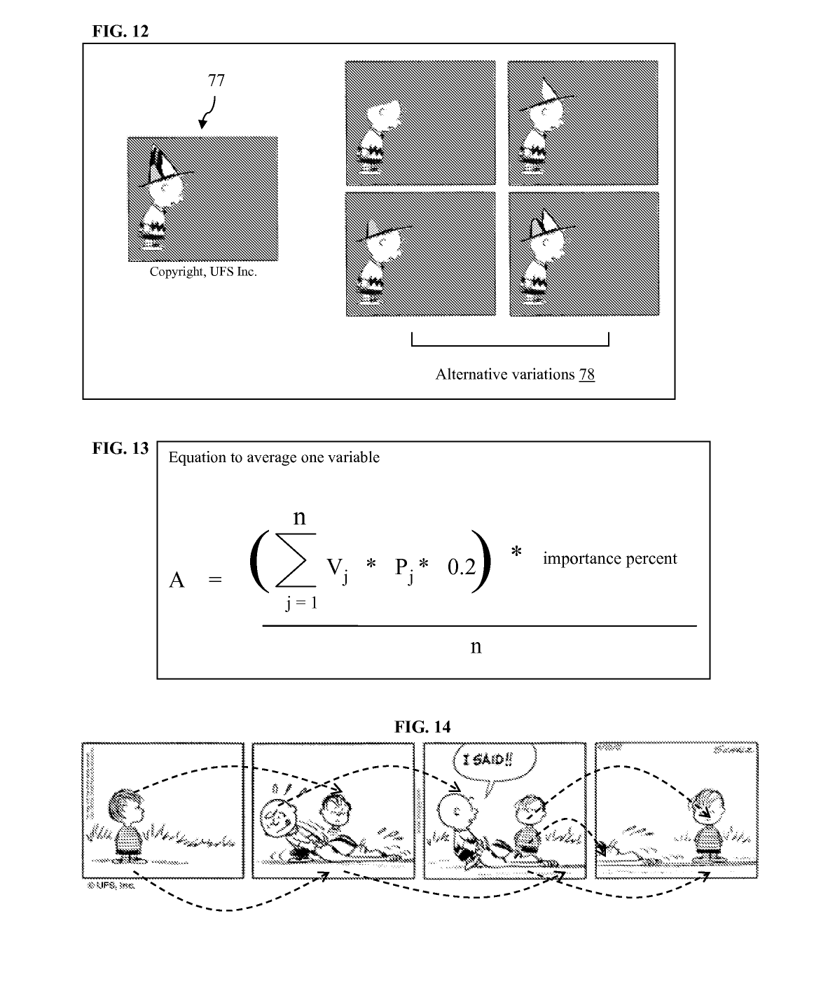

The image processor will cut out most of the image layers on the frames and also cut out most of the encapsulated visual objects in each image layer. It will also find alternative variations of visual objects to use to search for matches in memory. FIG. 12 shows visual object 77 and the different variations 78 of the same object (The grey areas are empty pixels).

When the AI program generates the encapsulated tree for a visual object, it is important that the AI program generates the same or similar encapsulated tree for the same visual object. Infact, when a similar image is encountered the AI will generate a similar encapsulated tree for that image. If imageA is encountered once the AI program generates encapsulated tree 1A. If imageA is encountered a second time the AI program will generate encapsulated tree 1A or something very similar. If imageB is an image that is similar to imageA and the AI program generates 1B, then 1B should be similar to encapsulated tree 1A. This is important because if the encapsulated tree is different for similar images it takes longer to find a match.

The image processor should be a fixed mathematical equation where it generates the same or very similar results for the same visual object. Similar visual objects will generate similar encapsulated trees.

The priority percent for each encapsulated object is determined by the 6 dissection functions. The priority percent of image layers is determined by the 6 dissection functions in this order:

(1). dissect image layers using previous optimal encapsulated trees
(2). dissect image layers that are moving
(3). dissect image layers that are partially moving
(4). dissect image layers by calculating the 3-dimensional shape of all image layers in movie sequences.
(5). dissect image layers by calculating dominant color regions using recursion
(6). dissecting image layers using associated rules

Image layers that are cut out with the higher-level functions will have a higher priority percent. For example, if an image of Charlie brown is cut out (clean cut), it has more priority than a partially cut image.

An image layer that is cut out with both function 3 and function 4 will have higher priority than an image layer that is cut out from function 4 and function 5. Tweaking the importance of each function and the combination of functions is up to the programmer.

The reason that a clean cut is a good image layer search is because that image layer has been delineated perfectly and all the edges of the object are cut out. The reason the sixth function is last is because the image processor isn't sure what the edges of the image layers are. Given that a 2-d image is provided, the AI program has to rule out using expert probable systems to cut out image layers. The fourth function will have a better idea of the edges from a still picture because the edges can be calculated based on the closest objects. Off course, the fourth function can only work with real-life views of the environment. It will not work for truly 2-d images.

When the AI program isn't sure what the edges of the image layers are it has to fabricate alternative image layer combinations. It will rank them and test out which image layers are better than others by matching them with image layers in memory. When the search function finds out it has made an error in terms of delineating certain still image layers, it will change the image layer's encapsulated visual objects by modifying branches of the initial encapsulated tree and changing the priority percent of visual objects that are involved in the error search (from here on image layers will be referred to as visual objects)

FIG. 6 shows the initial encapsulated tree for current pathway 50. We have learned that the current pathway 50 (emphasis on visual objects) use the image processor to generate the initial encapsulated tree. The initial encapsulated tree contains the hierarchical structure of visual objects and broken up into strongest encapsulated visual objects. Each visual object in the encapsulated tree is given a priority percent. The priority percent determines their strength in the initial encapsulated tree for the current pathway 50. (The grey areas are empty pixels).

FIG. 6 illustrates the structure of the initial encapsulated tree for current pathway 50. The newly created normalized visual objects are created by the image processor (block 60). There are no groupings between newly created normalized visual objects A B C (block 58). The groupings of newly created normalized visual objects will only be created when the search function is over and the AI program generates an optimal encapsulated tree. The next step for the image processor is to create encapsulated trees for each newly created normalized visual object. Newly created normalized visual object A, B and C are further broken down into its encapsulated trees (block 62).

Sections of the initial encapsulated tree has already been constructed and searched. Referring to FIG. 6, visual objects D, E and F are contained in old frames in current pathway 50 and have already been searched. FIG. 6 illustrates previous normalized visual objects D, E and F. There groupings are shown in radius 56. Only previous optimal encapsulated trees have groupings between normalized visual objects. The previous optimal encapsulated tree also contains the encapsulated trees for each normalized visual object.

The very strong visual objects (or image layers) are at the top-levels while the weak visual objects are stationed at the bottom. If I were to show the initial encapsulated tree at the lower tree levels, the unimportant visual objects will be there. The “noise” of the current pathway will be filtered out to the lower levels. When the search function searches for information it will search for important visual objects first before moving on to less important visual objects.

The purpose of the lower-levels in the initial encapsulated tree is not to search for data in memory, but to break up the current pathway recursively into its smallest elemental parts (groups of pixels or individual pixels) so that when the current pathway gets stored in memory, self-organization will knit similar groups together. Thus, bringing association between two or more pathways (or visual objects).

The next step is to average out all visual objects in the initial encapsulated tree for the current pathway.

Averaging Data in the Initial Encapsulated Tree

After the initial encapsulated tree is created for the current pathway, all visual objects from the initial encapsulated tree will be averaged out. Each visual object in the initial encapsulated tree will average the value of each of its variables based on its' child visual objects. For example, if a parent visual object has 3 child visual objects then the parent visual object will add up all the values for one variable and divide by 3. If a parent visual object has 10 child visual objects then the parent visual object will add up all the values for one variable and divide by 10. All visual objects in the initial encapsulated tree will have the average value for each of its variables.

Each variable in a visual object will also have an importance percent. The importance percent is defined by the programmer to describe how important that variable is to the visual object. Each variable will have an importance percent. If you add up all the importance percent for all variables it will add up to 100%.

There is one more factor added to the equation. The priority percent of a child visual object should influence the average value of one variable. The higher the priority percent the more that child visual object should influence the average value of one variable. A factorial (0.2) is also multiplied to indicate that the priority percent of a child visual object should not matter that much in the average value. 0.2 is used because the worth of the visual object shouldn't over power the average value of a given variable for all child visual objects.

The equation to calculate the average value for one variable in one visual object is presented in FIG. 13. V represents one variable, A represents the average value of V, n represents the number of child visual objects, P represents the priority percent of a child visual object, the importance percent is for variable V.

I use this technique because when the AI program searches for possible matches it won't search every single pixel in a visual object. The visual object should contain the average value of a variable from all of its encapsulated visual objects. So, when the AI program searches for matches, it only needs to compare three variables: average normalized point, average total pixels, and average pixel color. These three variables sum up the visual object compactly so that the search function doesn't have to match every pixel in an image or rotate or scale the image to find a match or convolute the image to find a match.

FIG. 15 shows how the average value is computed for the normalized point. The grey areas indicate empty pixels. Visual object 80 has a normalized point close to the center of the frame. The normalized point should be in the center only if all image layers are equal in priority. The fact that some image layers are more important than others influence the average normalized point. In this case, Charlie brown and the character with the blanket have more priority, so their normalized points matter more. In the case when there are two separate image layers, such as in visual object 82, the normalized point will fall in the center of both image layers.

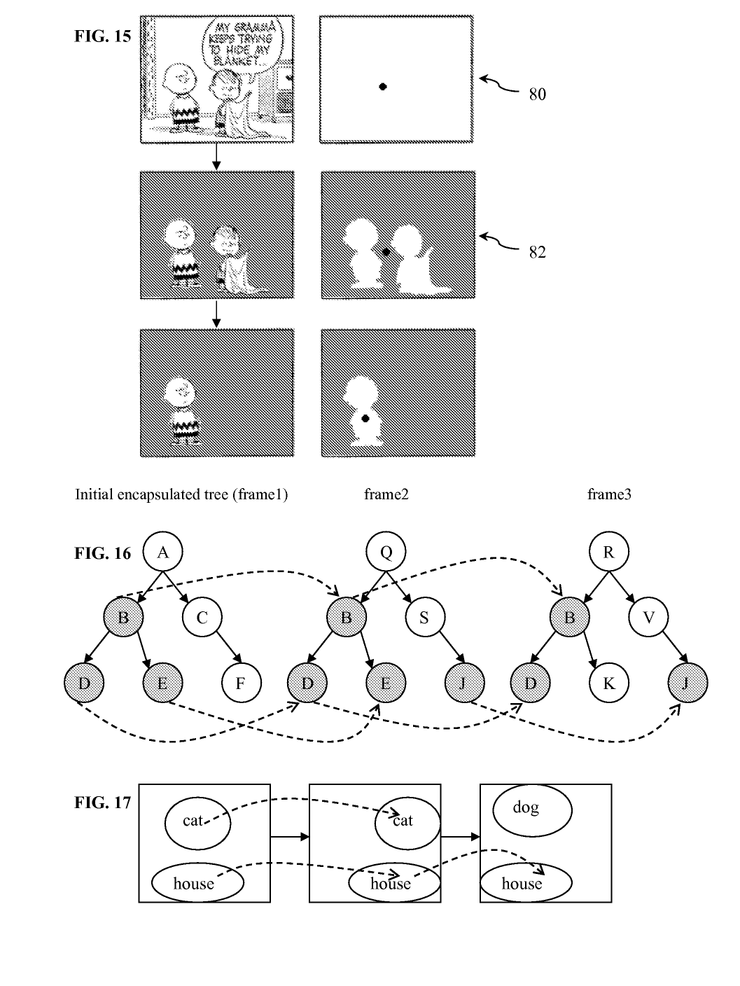

In addition to averaging data, the AI program has to determine the existence state of each visual object in the initial encapsulated tree. All visual objects have to be identified from one frame to the next according to one of three values: existing, non-existing or changed. For each frame all pixels, all image layers, and all combinations of image layers have to be identified from one frame to the next. In FIG. 16, the initial encapsulated tree records what visual objects are existing for three frames. Notice that visual object B exists for all three frames. Visual object E only exist in frame 1 and frame 2, but not in frame 3. Visual object J only exists from frame 2 to frame 3, but not in frame 1.

FIG. 17 shows the existence of learned objects. Learned object “cat” only exist in frame 1 and frame 2. Learned object “house” exist in all three frames. Learned object “dog” only exist in frame 3. The special thing about learned objects is that the image layers from frame to frame can look totally different, but the AI program will still classify it as the same learned object. For example, the learned object “cat” can be any cat image in the cat floater. The cat image can be an image of a cat from the front or back or side, the learned object “cat” will identify them as the same image layers.

FIG. 14 shows a cartoon illustration of visual object and their existence state. Every pixel in the cartoon from one frame to the next must be identified. The AI program will try to lock on and determine what pixels, image layers or combination of image layers exist from one frame to the next.

Forgetting Information in Image Layers and Movie Sequences

The initial encapsulated tree for the current pathway will forget information by deleting visual objects starting on the lowest level and traveling up the tree levels. The strongest visual objects will be forgotten last and the weak visual objects will be forgotten first. Specifically for images and movie sequences, the average pixel color will represent the overall value of a visual object. If all child visual objects are forgotten, the pixel cells they occupy will be represented by the average pixel color from its parent visual object. Initially, the movie sequence will have sharp resolution, but as the movie sequences forget information the images are pixelized. Important image layers will be sharp and the minor image layers will be pixelized or gone. Movie pathways will also break apart into a plurality of sub-movie sequences.

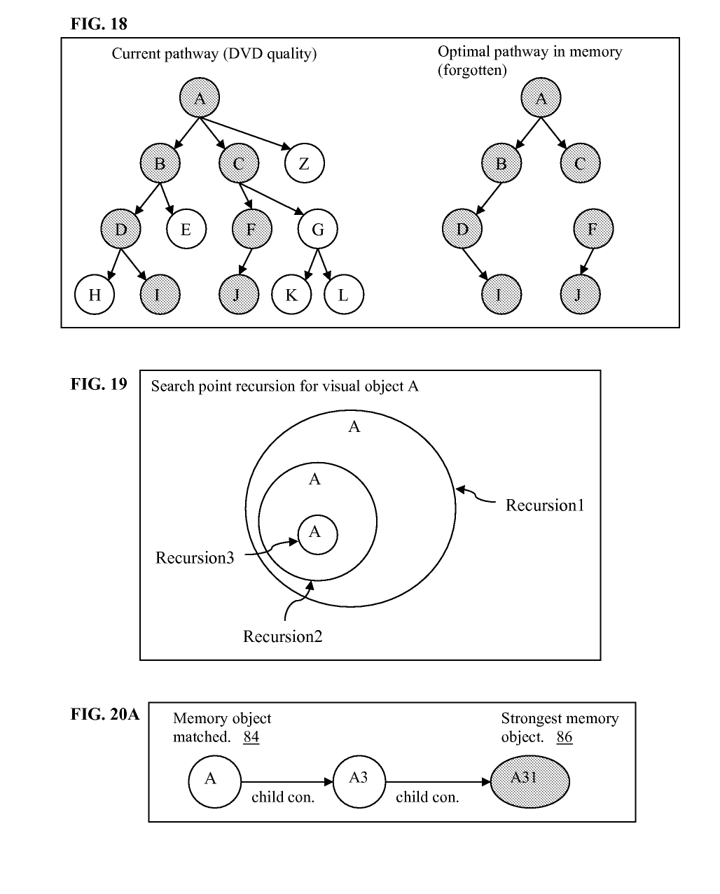

Self-organization for forgotten and new movie sequences is not a problem because of the encapsulated tree. New movie sequences with DVD quality will construct its encapsulated tree with a long tree structure. Forgotten movie sequences will forget data in the lower-levels of the tree, but the top level of the tree is still intact. FIG. 18 illustrates how forgotten movie sequences and new movie sequences self-organize. When the current pathway is stored in the optimal pathway the grey nodes will self-organize—common groups will bring themselves closer together.

Search Function

The initial encapsulated tree for the current pathway is what the search function wants to find in memory. Each element in the initial encapsulated tree is called a visual object. The data we want to compare are called memory encapsulated trees (or pathways). Each element in the memory encapsulated tree is called a memory object.

Visual objects that are searched in the initial encapsulated tree are based on visual objects that are not found. There are sections of visual objects in the initial encapsulated tree that has already been found by previous search results. The search function is concerned with searching for new visual objects that are not found—most notably visual objects from the new frame (or visual objects that were not found in previous searches or modified visual objects in the initial encapsulated tree).

Previous search results will be used to find new visual objects in the network. The search function will be sending search points and guess points from pathway rankings from previous search results. The previous search results are areas where the new visual objects are most likely in. The search function will find unsearched visual objects closest the current state and slowly search for visual objects farther away from the current state.

The more visual objects matched in the initial encapsulated tree the better the pathway match. The more accurate each visual object match is the better the pathway match.

The search functions can only travel on memory encapsulated connections that belong to the same pathway (or memory encapsulated tree). In later sections, this problem is solved when I explain about universalizing pathways. For example, if a search point was traveling on memory encapsulated connections for pathway1 then it can't travel on memory encapsulated connections for pathway2.

The search function will execute two functions to look for pathways in memory: first search function and second search function. Both functions will work together to find the best pathway matches.

The first search function uses “search points” to match a visual object to a memory object. It uses breadth-first search because it searches for a visual object from the top-down and searches for all child visual object before moving on to the next level.

The second search function uses “guess points” to match a memory object to a visual object. This search method uses depth-first search to find matches. From a memory object match in memory the search function will travel on the strongest-closest memory encapsulated connections to find possible memory objects. These memory objects will be used to match with possible visual objects in the initial encapsulated tree. This search function works backwards from the first search function.

Search Points

Each search point has a visual object to search, a memory object to match, percentage of match between visual object and memory object, a radius length to search and a location for the best match so far.

Each search point have radius points, said radius points are equally spaced out points that can have 1 or more copies of itself to triangulate an average location a visual object might be located in memory.

Each radius point will lock onto a different memory object and compare said visual object to a memory object and output a match. All radius points will process the data and triangulate an optimal memory object to be matched with said visual object.

Each search point goes through recursion: If search_point(visual object) has a successful match (memory object) then execute two recursions:

(1). search_point(visual object)
(2). guess_point(memory object)
else if search_point(visual object) has an unsuccessful match (null) then execute one recursion:
(1). search_point(visual object)

Each search point has a recursion timer. The recursion timer will indicate how long to execute the next recursive thread. If the recursion timer is low that means it takes longer for the recursive thread to execute (thus, less search points devoted to search for that visual object). If the recursion timer is high that means it will be faster for the recursive thread to execute. (thus, more search points devoted to search for that visual object).

The criteria for the recursion timer are: if the search point finds better matches increase the recursion timer and decrease the radius length. If the search point finds worst matches slow down the recursion timer and increase the radius length to search for the same visual object in the next recursive thread.

Each search point will go through recursion to find better and better matches. The first recursion will pinpoint a general area. The second recursion will pinpoint a more narrow area. The third recursion will pinpoint an even narrower search area. This will go on and on until the search point finds an exact match or there are no better matches left to find. FIG. 19 is a diagram of the narrowing of search areas after every recursive iteration. If better matches are found, visual object “A” will change its search area. Child visual objects that depend on visual object “A” will have there search area changed as well.

Guess Points

From a memory object match in memory the search function will travel on the strongest-closest memory encapsulated connections to find possible memory objects. These memory objects will be used to match with possible visual objects in the initial encapsulated tree. This search function works backwards from the first search function.

There are 2 criteria to determine what memory object to designate for a search: 1. the stronger the memory encapsulated connections leading to the memory object are the better chance it will be picked. 2. the stronger the powerpoints of the memory object is the better chance it will be picked

As soon as the memory object is picked, the function will determine if the memory object is a parent memory object or a child memory object. Next, the function will identify the coordinates of all pixels and the actual pixels in the memory object. Then, the function will identify all visual objects from the initial encapsulated tree that approximately falls in the coordinates of the pixels and the actual pixels in the memory object.

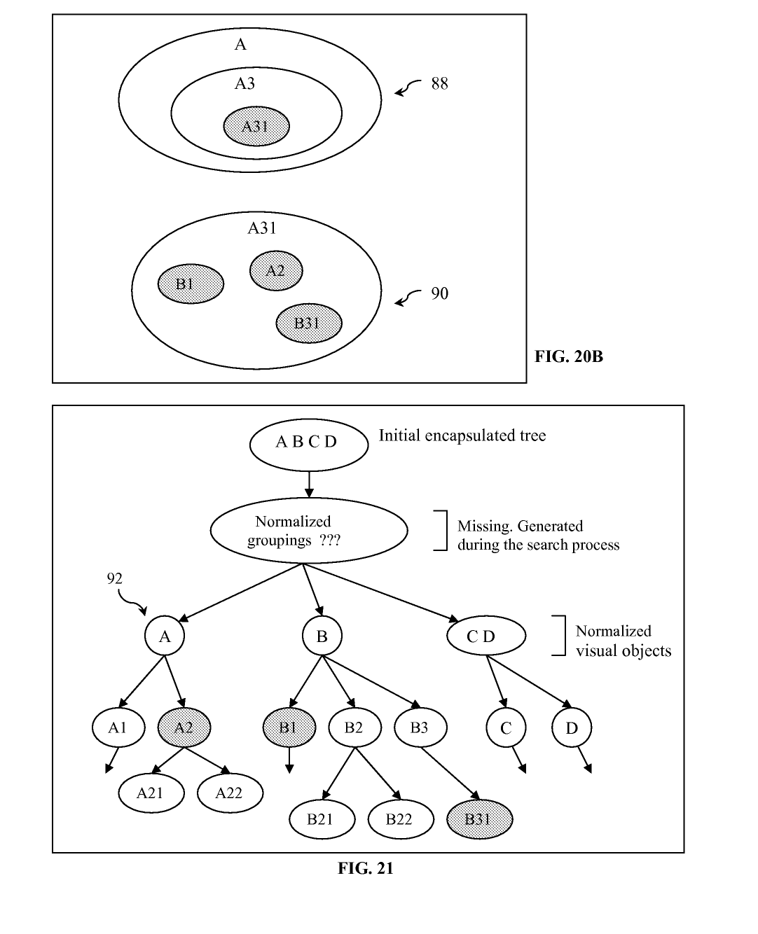

Referring to FIG. 20A-21, Memory object 84 has already been found a visual object 92 match in the initial encapsulated tree (FIG. 21). The guess point will travel on the strongest encapsulated connections to find a memory object to compare. In this case, memory object 86 was selected. The connections between A, A3 and A31 are child connections. Referring to FIG. 20B, memory object A31 is encapsulated in memory object A3 and memory object A3 is encapsulated in memory object A (diagram 88). The next step is to find the visual objects in the initial encapsulated tree that contains the coordinate and the pixels that approximately fall into memory object A31. Finding an exact visual object match is rare. In this case diagram 90 found visual object A2, visual object B1 and visual object B31 to match memory object A31. Notice that the matched visual objects are scattered in the initial encapsulated tree? The creation of the initial encapsulated tree can be in any exclusive permutation or combination, the guess point is only concerned with the coordinates of the pixels and the actual pixels that fall within memory object A31. Guess points can also travel on parent connections. For example, A→ABCD. Later on, more examples will be given on guess points.

Each guess point goes through recursion: If guess_point(memory object) has a successful match (visual object/s) then execute two recursions:

(1). guess_point(memory object)
(2). search_point(visual object/s)
else if guess_point(memory object) has an unsuccessful match (null) then execute one recursion:
(1). guess_point(memory object)

In the search point there is a last step that wasn't mentioned (for simplicity purposes). The last step is: when the search point finds a match it will locate the match's masternode. If there are multiple copies of one visual object in memory the masternode is the strongest copy of the visual object and the masternode has reference points to all copies in memory. If multiple copies of the same visual object are in the same general area the search function will use this data for future searches.

Main Steps of the Search Function

Referring to FIG. 6, the main steps in the search function is to search for normalized visual objects first then slowly find encapsulated objects in each normalized visual object; and unite matches to converge on the current pathway (search for mainly newly created normalized visual objects). All normalized visual objects will be searched at the same time. The top root node of the initial encapsulated tree will “not” be searched initially. The search function will only converge on the root node (current pathway). The reason for this is because the AI program is not concerned with the overall pathway to be searched. It is more concerned with searching the most important objects in the pathway first.

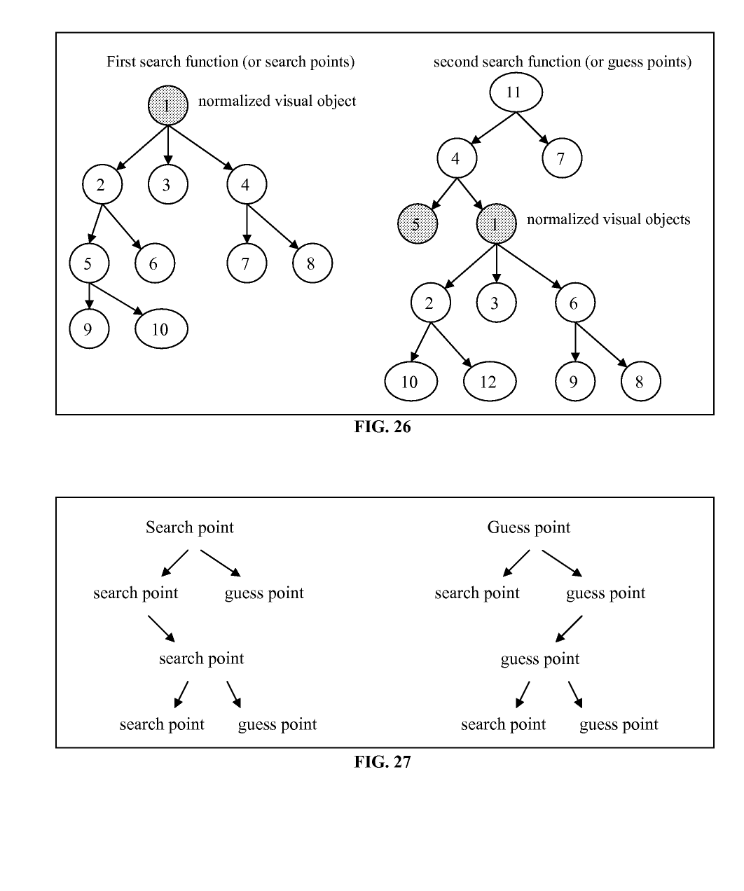

Search points searches for data in a top-down manner (FIG. 26), while guess points searches for visual objects up the initial encapsulated tree or down the initial encapsulated tree (FIG. 26). All search points and guess points will communicate with each other on their search results and uniting their matches until all visual objects in the initial encapsulated tree are found.

In addition to finding newly created normalized visual objects, the search function will also find visual objects from:

1. previously searched visual objects from previous optimal encapsulated tree.
2. previously unsearched visual objects from previous optimal encapsulated tree.
3. modified visual objects from previous optimal encapsulated tree.

The search functions might find a better visual object match from previous search results. This is why previously matched visual object can be researched. Sometimes the search function can find visual objects that were not found by previous search results. Lastly, visual objects in the initial encapsulated tree can be modified and the search function has to search for the modified visual objects.

The two search functions, first search function and second search function is fully automated and they recursively find better and better visual object matches in the initial encapsulated tree. Both search points and guess points will be working together to find matches and each search point goes through recursion and each guess point goes through recursion. These search points and guess points will communicate with each other on where to allocate their efforts in memory. If search points or guess points are not finding enough matches then the search function will allocate search points and guess points in other areas in memory. If search points or guess points are finding better matches then the search function will allocate more search points and guess points in that area.

The search functions will slowly converge on the current pathway. The more visual object matches in the initial encapsulated tree the better the pathway match. The more accurate the visual objects are the better the matches. Unlike my previous patent application Ser. No. 11/936,725, during the search process, the initial encapsulated tree is not modified. The initial encapsulated tree serves as a template to find pathways in memory. When the optimal pathway is found the AI program will generate an optimal encapsulated tree based on the strongest pathways that lead to the optimal pathway. This optimal encapsulated tree will be the final data stored in memory.

Search Point Example

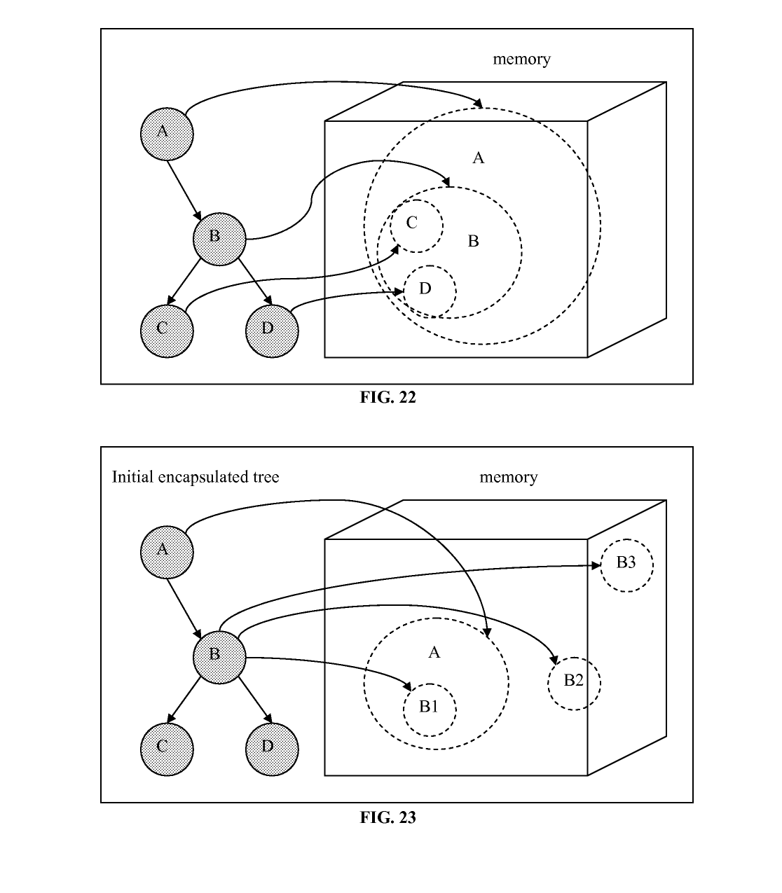

The parent visual objects provide a general search area for its child visual objects. In FIG. 22, visual object “A” has a big search area. Visual object “B” is contained in visual object “A”s search area. Visual object “C” is contained in visual object “B”s search area. These hierarchical search areas provide boundaries for the search function to limit the search area.

The search area radius is calculated by the accuracy of the match. If the percent match is 50% then the radius will be wide. If the percent match is 80% then the radius will be narrower. If the percent match is 100% then the radius is very narrow (depending on how much data is in memory. In some cases that is a 100 percent match). Another factor of the search area is the tree-level the visual object is located. If the visual object is the top visual object then the radius is wider. If the visual object is at the middle tree-levels then the radius is narrower.

The AI program will collect information on most search points and use that to determine where to allocate search points to maximize the search results. If some search areas are not finding enough matches the AI program will devote search points in other search areas. If some search areas are finding lots of matches the AI program will devote more search points in that area.

Multiple Copies of a Visual Object

If there are multiple copies of a visual object, the search function will limit the search to only the copies that are contained in the parent's search area. In FIG. 23, visual object B has 3 copies in memory (visual object B1, B2, B3). The search function will exclude B2 and B3 because they are not within the boundaries of visual object “A”s search area.

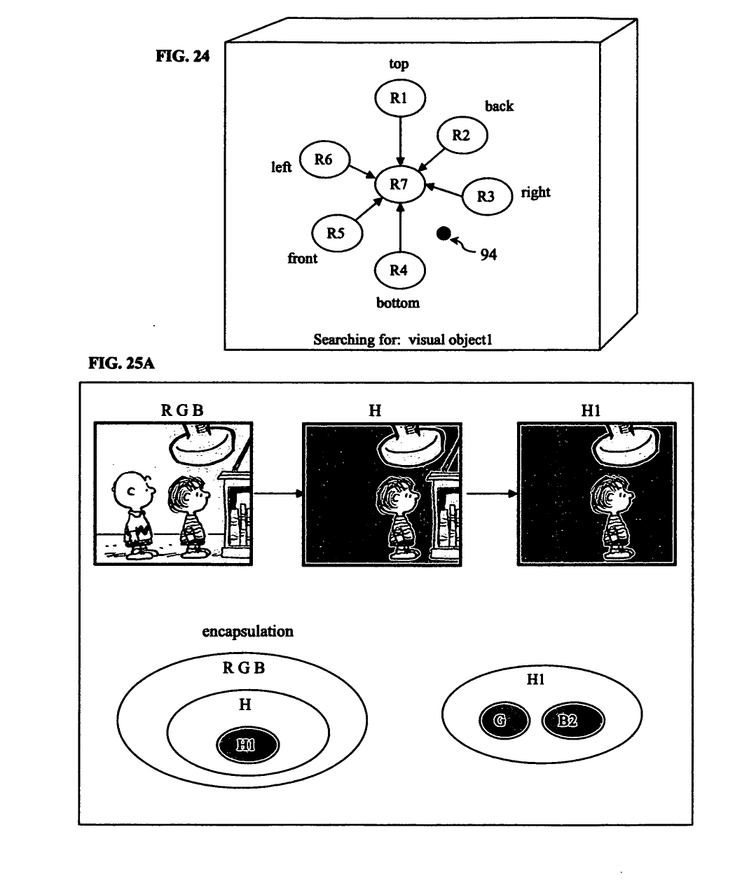

FIG. 24 is an illustration of a search point. The search point is given a visual object to compare called visual object1. R1, R2, R3, R4, R5, R6, and R7 are radius points and they are equally spaced out. In FIG. 24 the radius points are structured in a top, bottom, front, back, left, right and center manner. Each radius point will lock onto a dominant memory object in their area and compare with visual object1. When all matches are made, the AI program will triangulate a probable area to find the optimal memory object. The optimal memory object is identified by pointer 94. Visual object1 will be compared to the optimal memory object and output a percent match. The percent match will be assigned to the search point.

The radius points can be in any configuration. It can be configured in a ring shape, triangle shape, sphere shape, or arbitrary shape. The number of radius points can be 1 or more, but an adequate amount is 7 to cover a search area in 360 degrees.

Guest Point Example

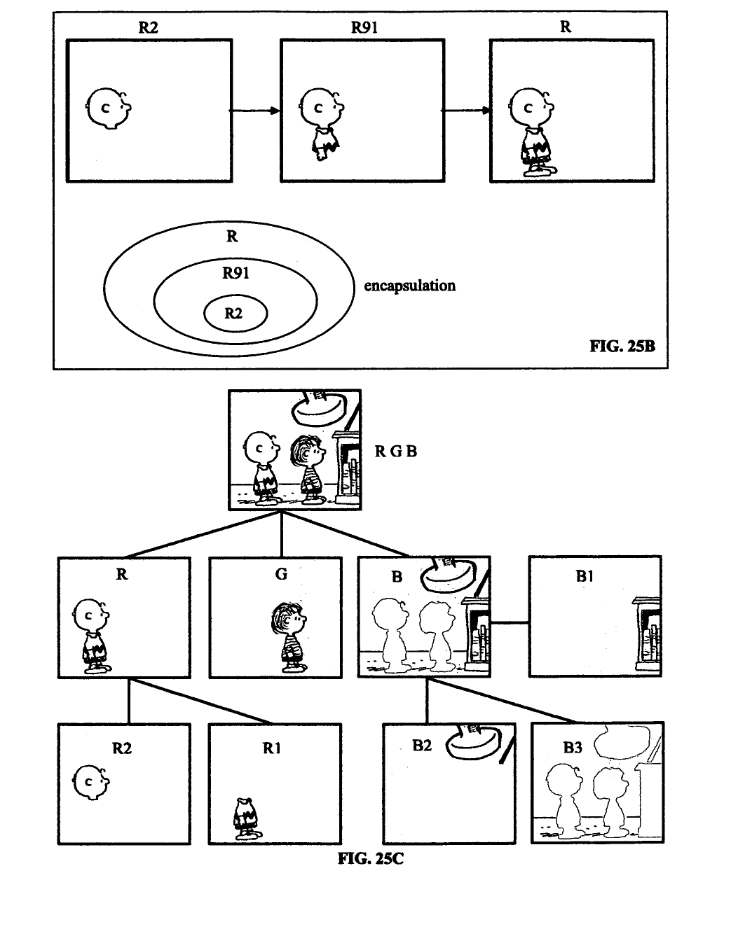

Two examples will be given for guess points. From a memory object match in memory the guess point will travel on encapsulated connections to find a memory object to compare with visual objects in the initial encapsulated tree. Guess points can travel on parent encapsulated connections or child encapsulated connections. This will allow the guess point to guess the strongest parent memory objects or guess the strongest child memory objects. FIG. 25B illustrates how the guess point will travel on the parent encapsulated connections and FIG. 25A illustrates how the guess point will travel on the child encapsulated connections.

Traveling on Child Encapsulated Connections

Referring to FIG. 25A, Hypothetically, if RGB has been found the search function has to also find its lower-level visual objects. From memory object RGB, the guess point will travel on the strongest encapsulated connections (in this example, child connections are used) to find a memory object to compare. In this case, the guess point found H1 to be the strongest memory object. It will then find a visual object or several visual objects that match H1 in the initial encapsulated tree. In order to find the visual object/s the AI program has to find out the coordinates of all pixels and the actual pixels in H1. Any visual object that fall into the approximate coordinates will be used as a match. Referring to FIG. 25C, visual object G and visual object B2 fall into the coordinates of pixels in H1. The actual pixels in H1 are also a match.

Traveling on Parent Encapsulated Connections

Referring to FIG. 25B, Hypothetically, if R2 has been found the search function has to also find its upper-level visual objects. From memory object R2 the guess point will travel on the strongest encapsulated connections (in this example, parent connections are used) to find a memory object to compare. In this case, the guess point found R to be the strongest memory object. It will then find a visual object or several visual objects that match memory object R in the initial encapsulated tree. In order to find the visual object/s the AI program has to find out the coordinates of all pixels and the actual pixels in memory object R. Any visual object that fall into the approximate coordinates will be used as a match. Referring to FIG. 25C, visual object R fall into the coordinates of pixels in memory object R. The actual pixels in memory object R are also a match.

These two examples show that the guess points search for matches in a bi-directional manner where it can travel on parent encapsulated connections or child encapsulated connections. The actual comparing of visual object to memory object is approximates and not exact. Some matches can be 50 percent and other matches can be 90 percent. The higher percentage matches will replace the lower percentage matches. For each search point and guess point, the recursion is needed to find better matches of the “same” object. For example, if visual object RGB is found in memory with a 50 percent match and later on, during the search process a guess point found a visual object RGB with 90 percent match then the better match will replace the previous match.

Referring to FIG. 26, the first search function (uses search points) finds matches in a top-down fashion. It also provides search information for the second search function. The second search function (uses guess points) travels chaotically in all directions to find matches in the initial encapsulated tree. Referring to FIG. 27, each search point calls itself recursively to find better matches for the same object, and if matches are found, the search point will call a guess point recursively. Each guess point calls itself recursively to find better matches for the same object, and if matches are found, the guess point will call a search point recursively. Referring to FIG. 27, search points calls guess points and vice versa. The diagram shows that search points jump to guess points and guess points jump to search points. These two search functions will work together and communicate with each other to find better and better matches until the entire network is searched or a specific search time runs out.

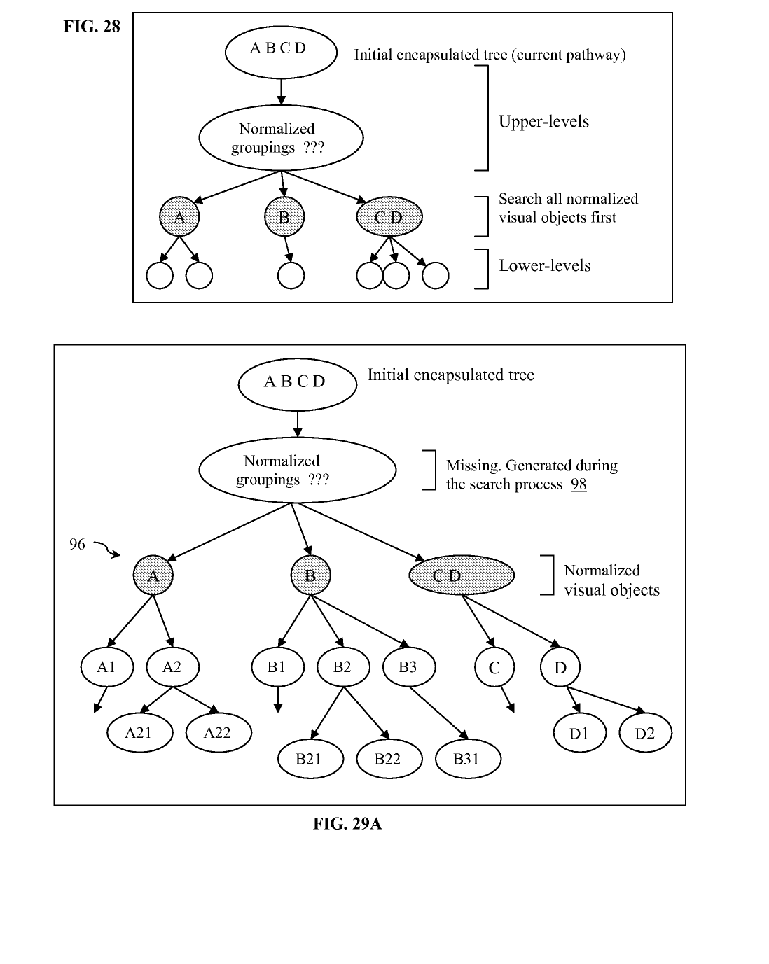

In FIG. 28, the first search function is applied to each normalized visual object in the initial encapsulated tree (visual objects A, B, CD). The root node is not applied. The first search function will go through recursion to find the lower levels of each normalized visual object. All recursive search points and guess points will communicate with each other and slowly converge on the root node (the current pathway).

New Objects Created by Visual Objects

During the search process, there are two main objects that are generated by visual objects: hidden objects and activated element objects. When visual objects exist from frame to frame they generate hidden objects. Also, when visual objects interact with each other hidden objects are generated. When these hidden objects are generated an encapsulated tree must be created for each hidden object. This encapsulated tree will be included in the initial encapsulated tree to be searched. Generation of the encapsulated tree for hidden objects is based on an expert program.

Another object generated by visual objects (or 5 sense objects) are activated element objects. Activated element objects can be any object, it can be 5 sense objects, hidden objects, learned objects or pattern objects. Whatever the activated element object is an encapsulated tree will be created and included in the initial encapsulated tree. Since activated element objects is located in memory, the encapsulated tree for the activated element object can be copied from memory. The image processor is not needed to generate the encapsulated tree for activated element objects.

Pattern objects are not generated during the search process. Pattern objects are only generated when the AI program self-organizes data and compares similar pathways in memory. The pattern objects are either copied from the optimal pathway (if any exist) or pattern objects are activated by the robot's conscious. In either case an encapsulated tree is generated for the pattern object and included in the initial encapsulated tree.

Generate an Optimal Encapsulated Tree for the Current Pathway (Visual Objects Only)

When the optimal pathway is found, the AI program will generate an optimal encapsulated tree for the current pathway. This optimal encapsulated tree is constructed totally based on the strongest permutation and combination groupings leading up to the optimal pathway. The image processor will only assist in creating the optimal encapsulated tree by dissecting and grouping new data that doesn't exist in memory.

The optimal encapsulated tree will also have groupings for its normalized objects. These groupings are undecided in the initial encapsulated tree. Normalized visual objects for the optimal encapsulated tree may not be the same as the normalized visual objects for the initial encapsulated tree, but they should be similar.

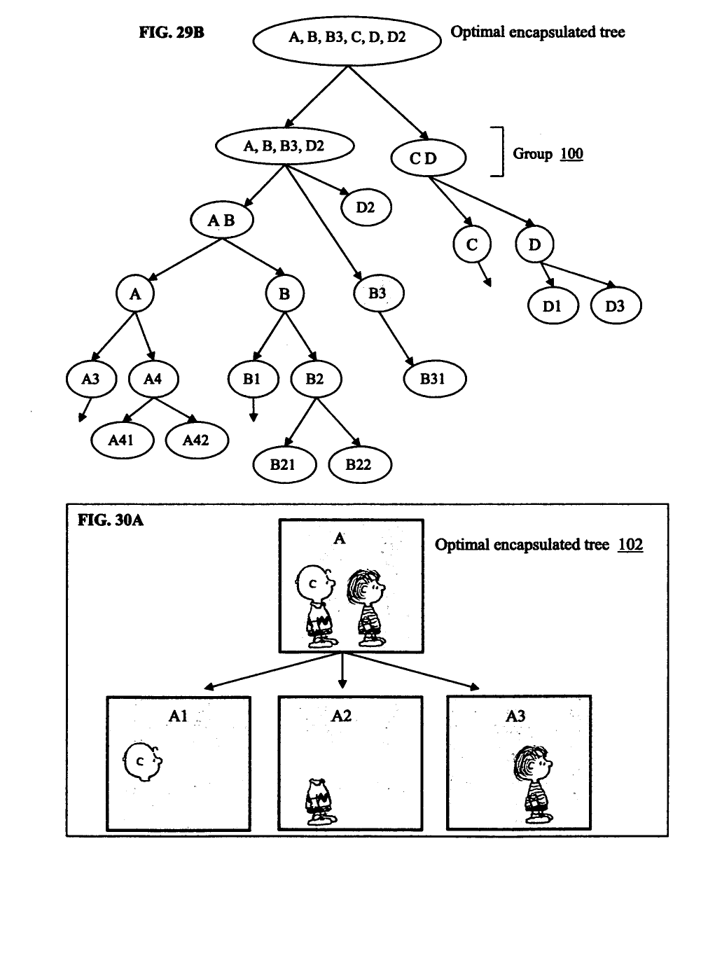

FIG. 29A is a diagram illustrating the initial encapsulated tree generated by the image processor. The normalized visual objects are indicated by grey nodes (block 96). The normalized visual objects are: A, B, CD. The normalized visual objects are not grouped together (block 98).

Referring to FIG. 29B, after the search process is over and the AI program found an optimal pathway, an optimal encapsulated is generated for the current pathway. Notice that the normalized visual objects are different from the initial encapsulated tree. The normalized visual objects are: AB, D2, B3, C, D. Groupings for the normalized visual objects are also created (block 100). Sometimes unimportant visual objects in the lower levels of the initial encapsulated tree are normalized visual objects in the optimal encapsulated tree. D2 and B3 are two examples.

Generate an Optimal Encapsulated Tree for the Current Pathway (for Visual Objects, Hidden Objects, Activated Element Objects and Pattern Objects)

The above example is the construction of the optimal encapsulated tree for only visual objects. There are four different data types and there should be one encapsulated tree for each data type. 5 sense objects will have an encapsulated tree, hidden objects will have an encapsulated tree, activated element objects will have an encapsulated tree and pattern objects will have an encapsulated tree. When all 4 data type constructs its own encapsulated tree, all encapsulated objects in all encapsulated trees will combine together to form hybrid combination and permutation groups. The result is a fusion of encapsulated objects from all four data types grouped together based on the strongest permutations and combinations (FIG. 31).

The encapsulated tree for the 5 sense objects breaks down data exclusively, meaning two groups can't share the same data. The encapsulated tree for the other three data types breaks down data non-exclusively and exclusively. There main goal is to break down data with the least amount of intersections.

Hidden objects have reference pointers to visual objects that created it. Learned objects also have reference pointers to visual objects that are equal to it. Pattern objects also have reference pointers to visual objects or hidden objects that are involved in the pattern.

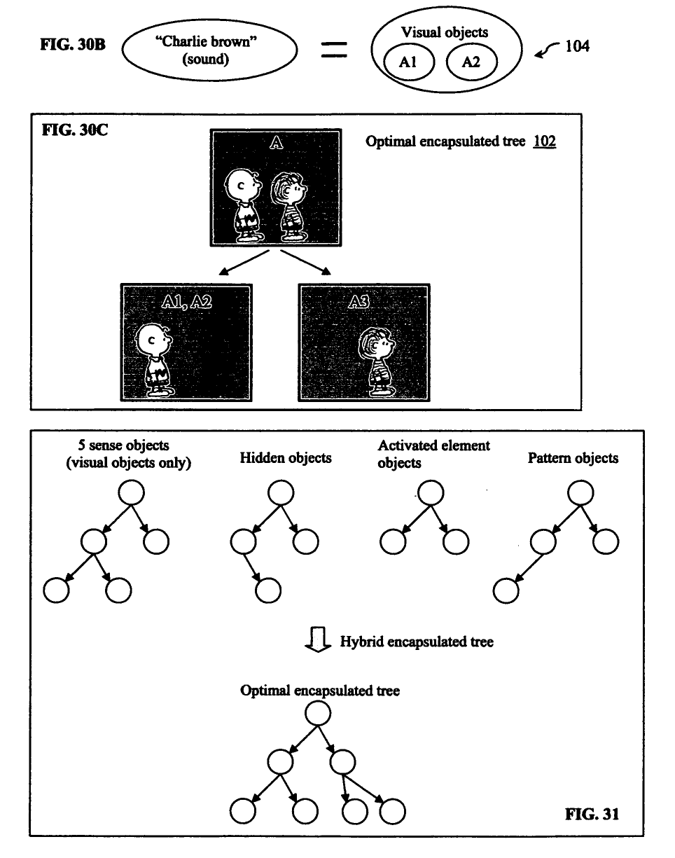

All four data types influence each other in terms of what objects are to be grouped. For example, FIG. 30B illustrates that “Charlie brown” is a sound word that represent a group of visual objects (diagram 104). Referring to FIG. 30A, visual object A1 and visual object A2 from optimal encapsulated tree 102 are the least amount of visual objects that represent “Charlie brown”. The learned group Charlie brown will influence the groupings in the optimal encapsulated tree 102. In FIG. 30C, optimal encapsulated tree 102 has been modified and visual object A1 and visual object A2 are now combined.

Sometimes there are intersections between learned objects. For example, if there exist two learned object: eyes and nose, the eyes will have some part of the bridge of the nose and the nose will have some part of the eye area. In order to solve this problem the learned objects has to reference which visual objects are included in each learned object. Two or more learned objects can reference the same visual object. The learned objects will guide the visual objects to break up into the best possible groups that have the least amount of intersections.

Hidden objects such as a jump will also influence the way visual objects are grouped together. Breaking up a picture is hard enough, but breaking up a movie sequence is even harder. Visual object sequences don't have equal weight for each sequential connection. There are strong sequences and weak sequences in a visual object. It's up to self-organization and training to determine how strong sequences are. The sequences in a visual object will break apart into sub-sequences based on all 4 data types. Hidden object such as a jump sequence will help break apart visual object sequences.

Referring to FIG. 31, all encapsulated tree for all 4 data types will be combined into one encapsulated tree. Referring to FIG. 31, all groupings will be a combination of the 4 different data types. Each data type will have references to each other. For example, if a learned object is the same exact object as a visual object then the learned object will have a reference to the visual object (or visual objects) and vice versa. Hidden objects will have reference pointers to the visual objects that generated it. Pattern objects will have reference pointers to any object that involves the pattern.

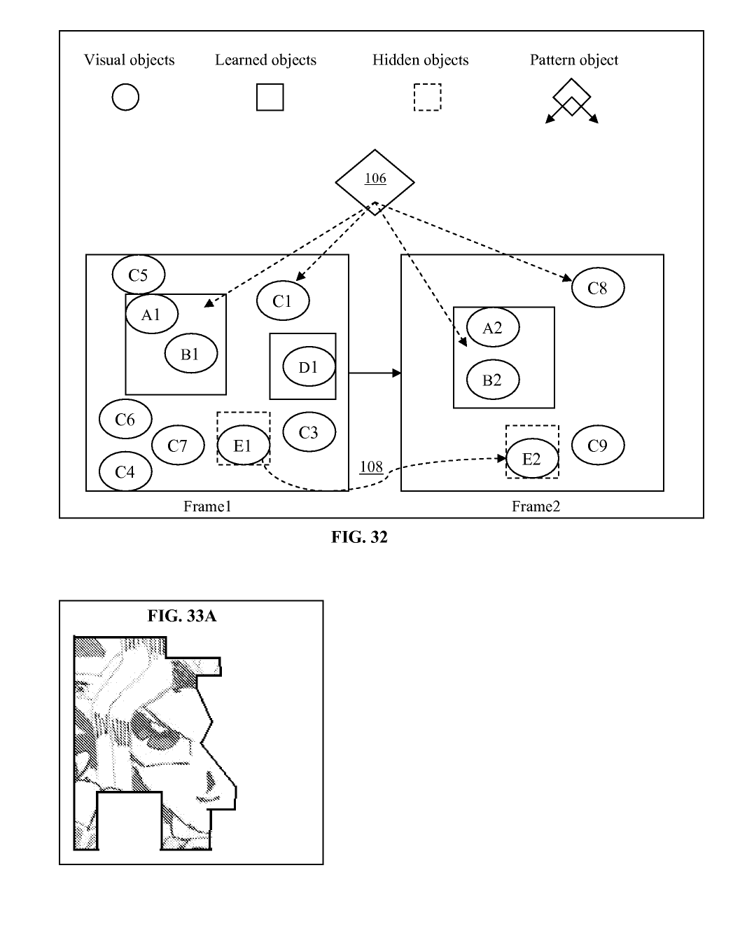

Referring to FIG. 32, a legend is on the top of the diagram. Any visual object is represented by a circle, any learned object is referenced by a square, any hidden object is referenced by a dotted square and any pattern object is referenced by a diamond with pointers pointing to objects that are involved in the pattern. Visual object A1 and B1 is incased in a learned object. Visual objects E1 and E2 generated a hidden object. Pointer 108 shows that the hidden object is continuous from frame1 to frame2. Pattern object 106 exist in multiple frames with pointers pointing to visual objects, learned objects, hidden objects or other pattern objects that are involved in the pattern.

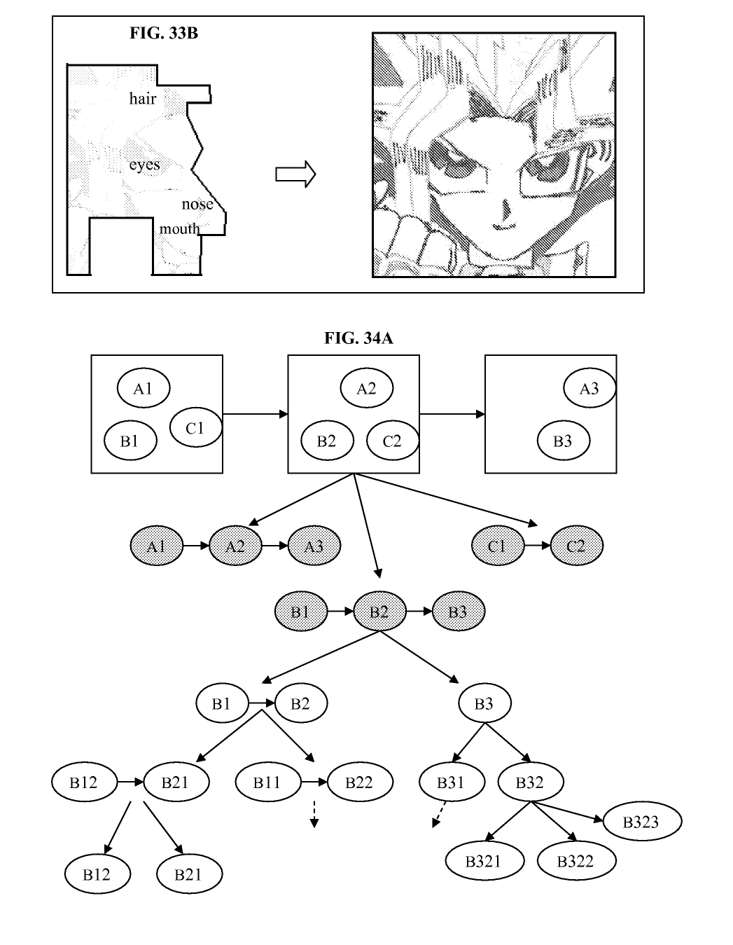

Referring to FIG. 33A-33B, searching for data will then be governed by all four data types. If the AI program is given a partial image of a face (FIG. 33A), whereby the AI program identifies the nose, eyes, and eye brows along with all there physical images, then most likely the AI program can guess that the chin is below the mouth, the neck is below the chin, the cheeks are between the nose and mouth and so forth (FIG. 33B). The visual image of the eyes and nose might be different, but the learned object is what brings order in the partial image.

Universalize Pathways in Memory

This topic is discussed in patent application Ser. No. 11/936,725

Constructing an Encapsulated Tree for Movie Sequences

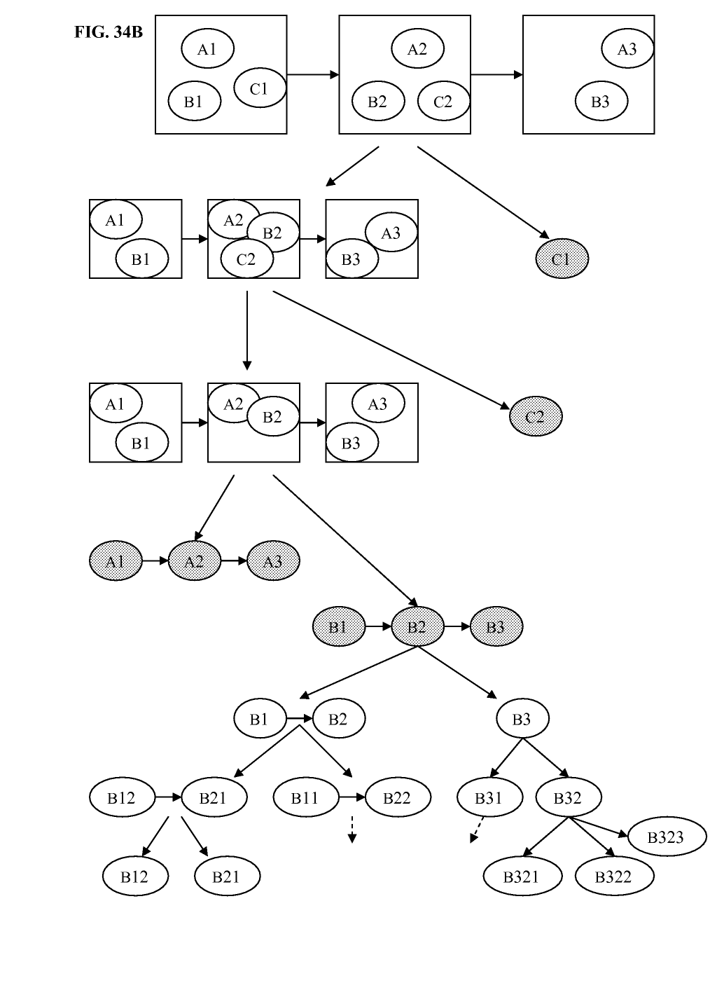

Referring to FIG. 34A, breaking down movie sequences into an encapsulated tree is very difficult. The image processor will first identify the normalized objects. In this case sequential visual object A, B and C are normalized objects. Each visual object will have its sequential image layer cut out from one frame to the next and grouped as one object respectively. Next, the image processor will break up each normalized sequences into sub-encapsulated visual objects. This will occur over and over again until each sequence is broken up into individual frames and individual frames are broken up into image layers and finally, image layers are broken up into groups of pixels or individual pixels (notice that there are no groupings based on the normalized visual objects).

Breaking up sequences is a little tricky. Notice that visual object sequence B1 B2 broke up into B12 B21 and B11 B22. This shows that sequences can break up into infinite possibilities. Instead of breaking B1 B2 into separate frames, it broke up image layers from B1 and image layers from B2 into two separate sequences. The dissection of movie sequences is based on the 6 dissection functions used by the image processor. This technique is used only for the initial encapsulated tree. The optimal encapsulated tree will break up the movie sequence into pieces using the strongest encapsulated connections leading to the optimal pathway (FIG. 34B).

Retraining Masternodes

There are many copies of the same visual object in memory. Retraining of data occurs after the current pathway and its optimal encapsulated tree is stored near the optimal pathway. The strongest copy of a visual object is called the masternode. All copies of the same visual object will have a pointer to the masternode. The AI program will only devote a specific amount of time to retrain data in the optimal encapsulated tree. Each visual object in the optimal encapsulated tree, starting from the root node, will be identified and retrained.

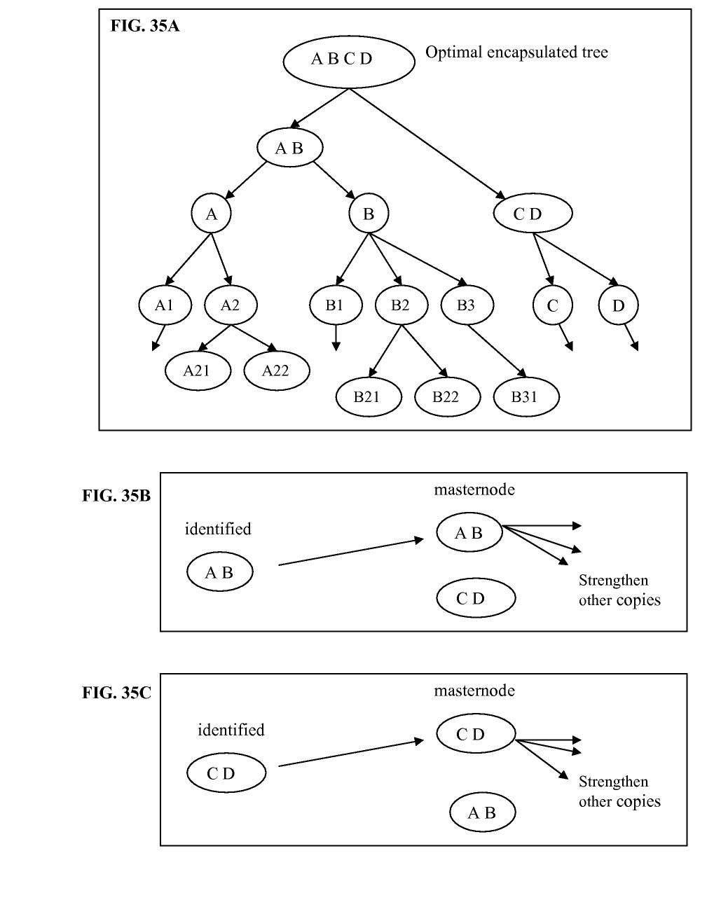

When the AI program identifies a visual object in memory it will locate that visual object's masternode. For each visual object identified in memory a residue of its sibling visual object will be stored in their masternode. Referring to FIGS. 35A and 35B, visual object AB has one sibling, visual object CD. When visual object AB locates its masternode, a residue of visual object CD will be stored close by. Another example is visual object A has one sibling, visual object B. When visual object A locates its masternode, a residue of visual object B will be stored close by. Another example is visual object B1 has two sibling, visual object B2 and visual object B3. When visual object B1 locates its masternode, a residue of visual object B2 and visual object B3 are stored close by (siblings can also be sequences, so by retraining siblings, sequences are also retrained).

Referring to FIG. 35B, visual object AB is identified and sends a signal to its masternode. When the masternode is located a residue of visual object CD is stored there. Next, the masternode strengthens other copies of itself in memory. Referring to FIG. 35C, the opposite will happen, visual object CD is identified and sends a signal to its masternode. When the masternode is located a residue of visual object AB is stored there. Next, the masternode strengthens other copies of itself in memory. The definition of residue of a visual object, in this case, is a weaken copy of the original visual object.

Retraining of data is done only with the strongest encapsulated groups in the optimal encapsulated tree. Out of all the permutations and combinations, the strongest encapsulated groups will be retrained. The AI program will retrain data from the top-down where the higher levels will be retrained first before moving on to retrain the lower levels. The higher levels will also have a stronger retraining than the lower levels.

Future Prediction

The main purpose of the AI program is to predict the future based on pathways in memory. From all the pathways in memory the AI program has to pick an optimal pathway. The optimal pathway is based on two factors: best pathway match and best future prediction. In order to predict the future all possible sequential outcomes of a game must be stored in memory.

It's easy to store all the possibilities of a simple game like tic-tac-toe. All the possibilities of the game can be stored in a network. The weight of pathway connections can be strengthened through repeated training. Simple games with small possible outcomes are easy to implement. However, two-player games that require large amounts of possible outcomes are very difficult to implement. Some possible outcomes of a game can run infinite. This means the network has to store infinite data.

Storing possible outcomes of a videogame or movie sequences in real life require the network to store infinite data. If you think about the possible outcomes of a human being and what kind of action it can take every millisecond, the possibilities can run infinite.

In order to solve this problem, each movie sequence (or pathway) stored in memory are stored in an encapsulated tree. Pathways may not share the same exact frames, but they do share visual objects within their encapsulated tree. The more visual objects two pathways share in their respective encapsulated tree the closer the two pathways will be from each other. This will bring association between two pathways.

This brings us to the following topic: future predictions. How, does the AI program predict the future based on an encapsulated tree? The AI program will use movie sequences “within” the encapsulated tree to predict the future.

Predicting the Future from Encapsulated Trees (or Pathways)

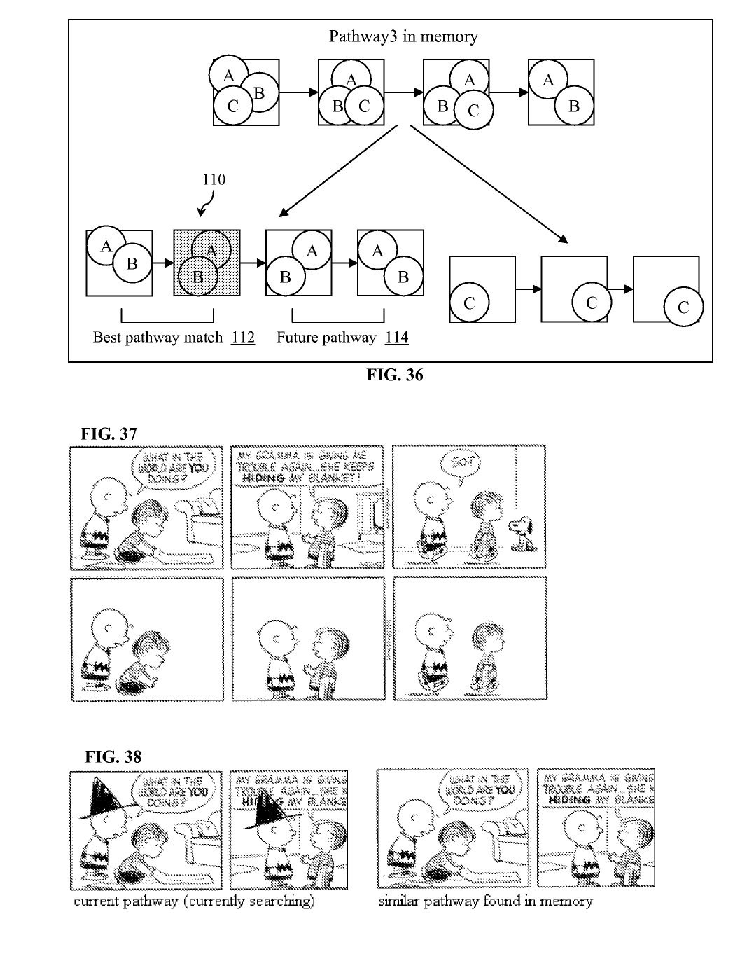

Referring to FIG. 36, pathway3 in memory is stored with its encapsulated tree. The search function found the best pathway match 112. The grey block 110 is the current state of the pathway and the AI program has to predict the future based on the future pathway 114. FIG. 36 illustrates how the AI program predicts the future from encapsulated trees. The AI program can travel on any pathway (or any sequence object in its encapsulated tree) in memory.

When my computer program doesn't find a 100 percent match in memory the AI has encountered a deviation (finding a 100 percent match is very rare). There are 4 deviation functions I have set up to solve this problem. It will allow the future prediction to do its job properly and find the most likely next step. I will be using videogames to illustrate this point. Videogame colored pictures can't be used so the images will be done with animated movies. The 4 deviation functions are:

1. Fabricate the future pathway based on minus layers.
2. Fabricate the future pathway based on similar layers.
3. Fabricate the future pathway based on sections in memory.
4. Fabricate the future pathway based on trial and error.

Fabricate the Future Pathway Based on Minus Layers

In (FIG. 37) the AI minuses layers from the pathways and finds the commonalities between the current pathway and the pathways in memory. For videogames/animation the AI minus object layers from the game. The background layer is minused from the game and the remaining layers matches the current pathway. This means the sofa, the blanket, the walls, snoopy, and the captions are minused. The two character layers (Charlie Brown and his friend) are used to play the game.

Fabricate the Future Pathway Based on Similar Layers

In (FIG. 38) the AI will find similar layers between the current pathway and pathways in memory. For videogames/animation the AI finds similar object layers. The Charlie brown layer with the hat isn't stored in memory. However there is a similar Charlie brown layer without the hat stored in memory. Because the Charlie Brown layer with the hat and the Charlie Brown layer without the hat look similar the computer will use the Charlie Brown layer without the hat instead of the Charlie Brown with the hat to play the game.

Fabricate the Future Pathway Based on Sections in Memory

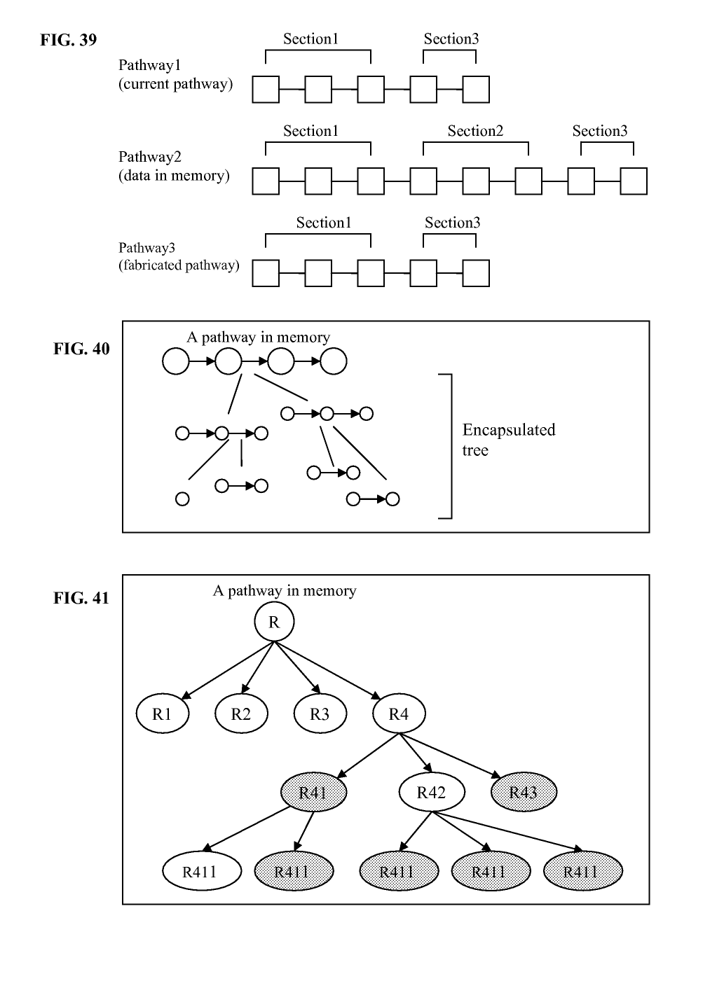

In (FIG. 39) the AI constructs new pathways from sections in memory. This process takes sections of pathways from memory and combines them to form new pathways for the AI to pick. Pathway1 is the pathway it is looking for in memory. However, there is no 100 percent match in memory. The closest match is pathway2. It takes section1 and section3 from pathway2 and fabricate pathway3. This fabricated pathway will be used to play the game.

Fabricate the Future Pathway Based on Trial and Error

The AI plots the strongest future state and fabricates a pathway to get to that future state using the other deviation functions.

With all 4 deviation function the AI program can fabricate pathways in memory if there are no exact matches found. All four deviation functions create the fuzzy logic of the system. It acts by giving the AI alternative pathways if an exact match isn't found in memory.

In terms of how the 4 deviation functions are represented in the encapsulated tree, the diagrams in FIG. 40-44 will give an illustration.

Fabricate the Future Pathway Based on Minus Layers

Referring to FIG. 40, minusing image layers is accomplished by traveling down the encapsulated tree. The farther down the search function goes the less image layers it will match.

Fabricate the Future Pathway Based on Similar Layers

Referring to FIG. 41, similar image layers is accomplished by traveling down the encapsulated tree and finding the best matches. Notice that pathway R4 is a similar match, but pathway R4 isn't an exact match. The grey nodes encased in pathway R4 are matches found. The more matches found in the lower levels the more similar pathway R4 and the searched pathway are. Since R4 is the most similar, the AI program will use pathway R4 to predict the future.

Fabricate the Future Pathway Based on Sections in Memory

There are two ways to fabricate sections of pathways together: fabricate sequential objects in the same encapsulated tree or fabricate sequential objects in different encapsulated trees. Referring to FIG. 43, current pathway 118 has a match in the encapsulated tree in pathway3. The visual object T1 is matched. The grey node represents the current state. Since T1's sequence ends at the current state it will find other associated sequences close by and fabricate a future pathway. In this case, T2 was found and T2 is used to predict the future. T1 can be combined with any sequential object in the encapsulated tree (minus layers or added layers). As long as the pathway is a sequence from T1 (or most likely a sequence).

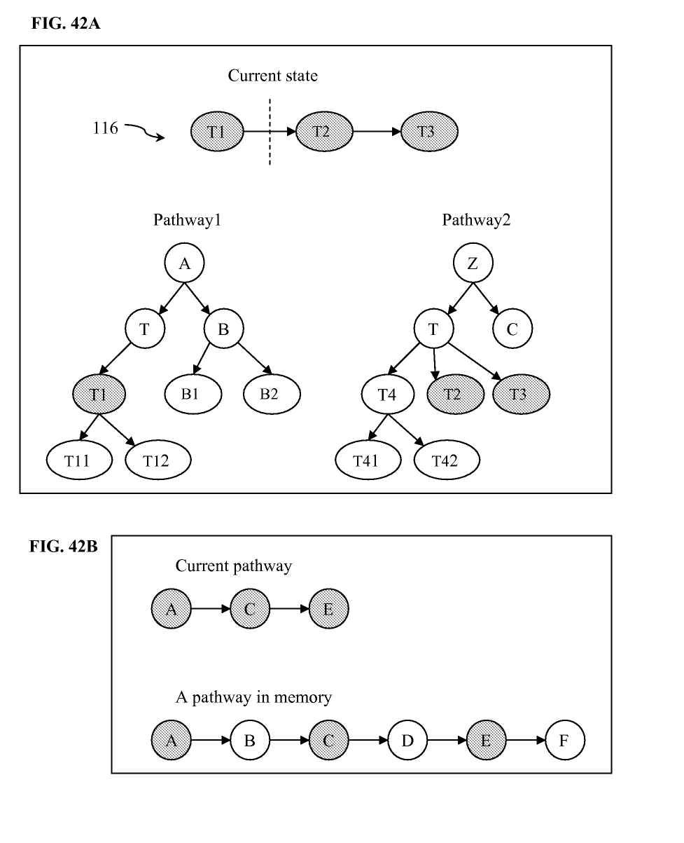

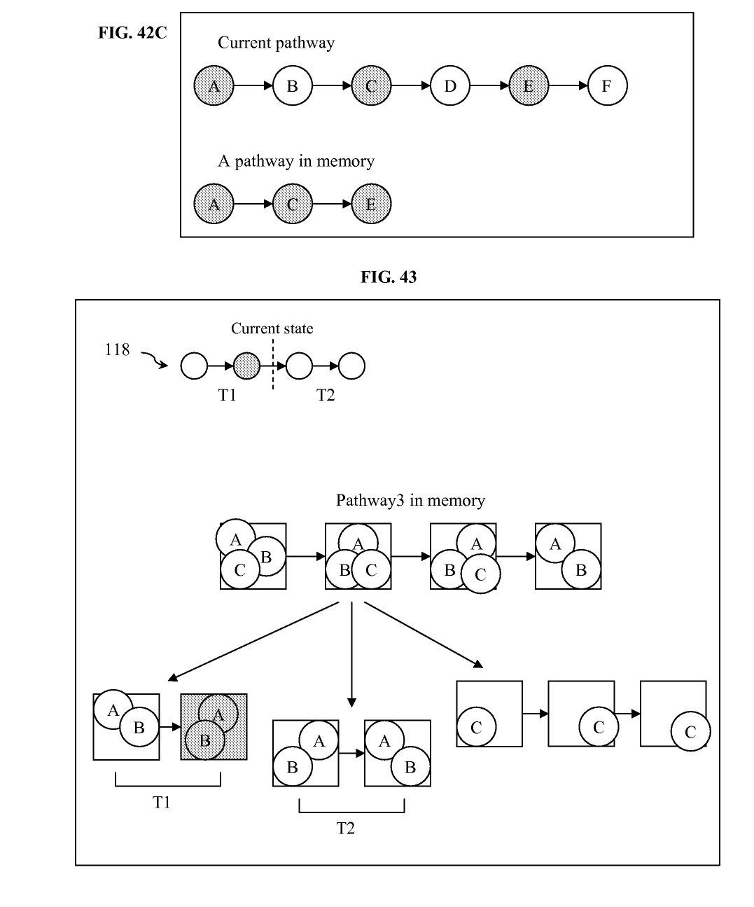

The AI program can also fabricate sequential objects from different pathways (or fabricate sequential objects from different pathway's encapsulated trees). Referring to FIG. 42A, current pathway 116 is fabricated from different sequential objects in pathway1 and pathway2. The AI program matched T1 from pathway1 as the best pathway match. Since T1 has a dead end the AI program has to find a sequential pathway in memory. The AI program found T2 and T3 from pathway2 as future sequences (or most likely sequences) to T1. T2 and T3 are used to predict the future.

Another use for this deviation function is to adapt the pathways to the speed of the game. Referring to FIG. 42B, if the game was accelerated then the AI program will skip frames from pathways. Referring to FIG. 42C, if the game was decelerated then the AI program will lock onto the pattern of the pathway.

Fabricate the Future Pathway Based on Trial and Error

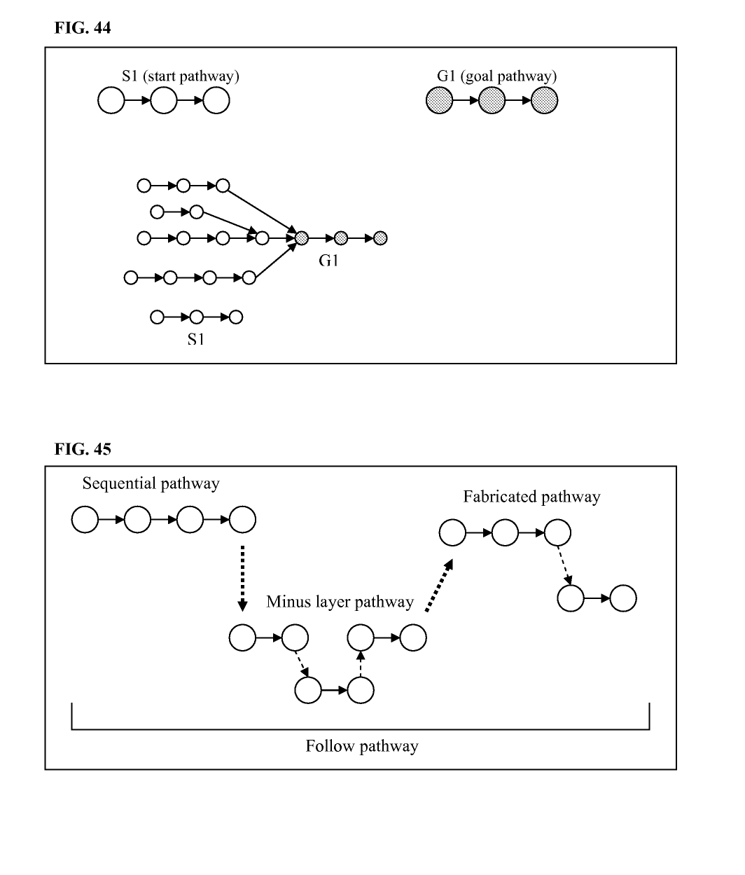

The AI plots the strongest future state and fabricates a pathway to get to that future state using the other deviation functions. This function involves two pathways: the start pathway and the goal pathway. There may or may not be sequential connections between the start pathway and the goal pathway. Usually there is no sequential connection and the AI program has to fabricate a sequential connection between the start pathway and the goal pathway by using combinations of the 4 deviation function. Referring to FIG. 44, S1 is the pathway that matches the current pathway. From pathway S1 the AI program found pathway G1 to be the strongest future pathway. Notice that all pathways lead to G1. This is an indication that pathway G1 is a goal state. The AI program will use the 4 deviation function to fabricate a pathway between S1 and G1. This fabricated pathway will be used to predict the future. If the AI program decides to use this fabricated pathway, if it finds out that it made an error, it will not pick this fabricated pathway in future decision making.

The Follow Pathway

The follow pathway is the pathway that the AI took after many iterations of the main for-loop. The follow pathway comprises at least one or a combination of: sequential pathways, minus/add layer pathways, similar layer pathways and fabricated pathways. In FIG. 45, the follow pathway was following sequential pathways at the beginning. Then it jumped to a minus layer pathway. Finally, it jumped to a fabricated pathway. As the AI program experience movie sequences from the environment it will travel on pathways in memory by jumping from one pathway to the next. What pathways it decides to choose will greatly depend on what the optimal pathway is in each iteration of the main for-loop.

Criterias to Find the Worth of Each Future Pathway

Many factors are needed to calculate the worth of each future pathway. The future pathways (both sequential or fabricated) will be ranked. The ranking is determined by the total worth of the future pathway. Among some of the factors that determine the worth of a future pathway are:

1. the certainty factor of each connection in the future pathway

2. the match percent of the current pathway to the pathway matched in memory

3. the cost of jumps in the future pathway

4. the length of the future pathway

5. the overall strength of the future pathway

1. The Certainty Factor of Each Connection in the Future Pathway

For each sequence connection in the future pathway (for both sequential or fabricated future pathway) what is the certainty factor of each connection. How certain is the next sequence from frame to frame? The constant training of data and self-organization will determine how certain sequential connections are. The most likely sequences will have higher worth than least likely sequences. All connections for each future pathway will be calculated.

2. The Match Percent of the Current Pathway to the Pathway Matched in Memory

The pathway matched in memory, how close is that match compared to the current pathway. The AI program will determine the future pathway based on the best pathway match. Determining how close a given pathway is compared to the current pathway is vital to determining the future pathway's worth. If the percentage match is low, then the future pathway is worth less. If the percentage match is high, then the future pathway is worth more.

3. The Cost of Jumps in the Future Pathway

The less jumps that the future pathway has the better the future prediction. The more jumps that the future pathway has the worst the future prediction. Future pathways that are sequential have a higher chance the next sequence will happen. Future pathways that are fabricated and comprises two or more pathways have a lesser chance the next sequence will happen.

4. The Length of the Future Pathway

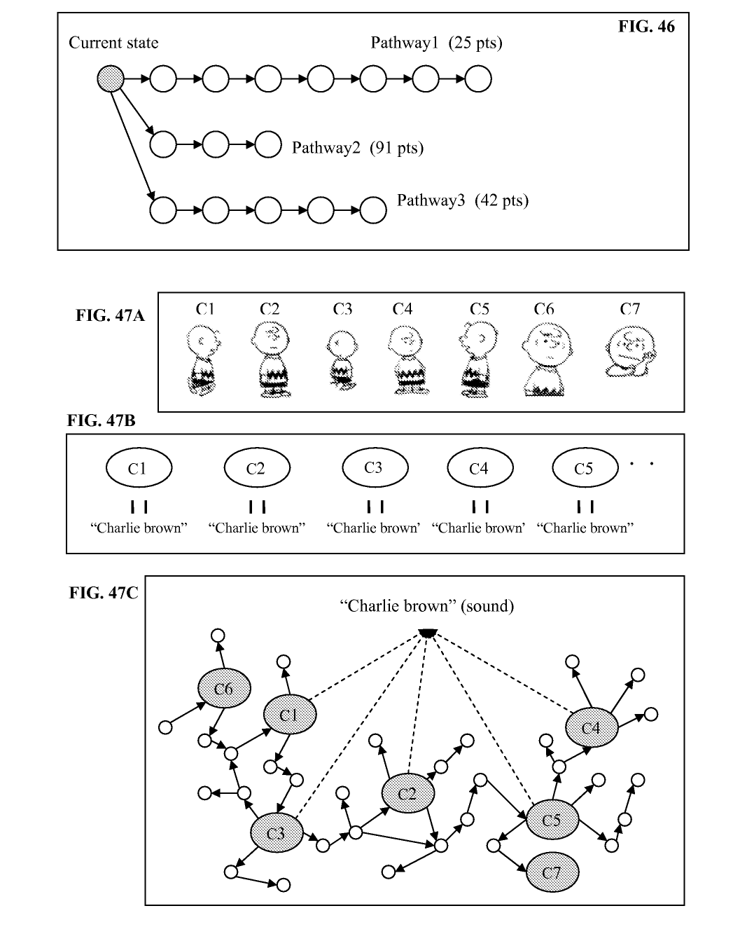

There is a factorial that is multiplied to each sequential frame closest to the current state. The closer the frame is to the current state the more important it is to the future prediction. Since future pathways can be long or short the length would not matter because of the multiplied factorial. However, if two future pathways have equal worth but one of them is longer, then the longer future pathway will be worth more. On the other hand a shorter future pathway can be worth more than the longer future pathway because many other factors are included to determine each future pathway's worth. Referring to FIG. 46, future pathway2 has higher worth than future pathway1 or future pathway3.

5. The Overall Strength of the Future Pathway

In addition to sequential connection strengths, the powerpoints of the future pathway matters. The overall future pathway is considered one object. How strong is that object? The strength of the object will depend on how many times the object was encountered by the AI program and also how important that object is based on pain or pleasure (learning how important that object is).

How do Pathways Grow in Length During Training?

The more training the pathways go through the longer the length of the pathway. There are two factors that lengthens or shorten a pathway: the existence of visual objects from one frame to the next and self-organization. In each iteration of the for-loop, the AI program will create encapsulated trees for the current pathway and store the encapsulated tree in a streaming manner where it jumps from one pathway to the next to store data. The existence of visual objects will bind sequences together and self-organization will bring common sequences together. This will lengthen a pathway (minus layer or full pathway). If the pathways are not trained often then the pathways (or encapsulated trees) forget information—the pathways will break apart into a plurality of sub-pathways or the pathways will lose data in frames.

Topics on the Conscious

The one distinction between human intelligence and animal intelligence is that human beings are able to learn and understand language. Language is the most important aspect to intelligence and building an AI program that can understand the meaning to language is very important.

Language must be understood in terms of fuzzy logic. Different words and sentences can mean the same things. In order to understand that two different sentences actually mean the same things fuzzy logic is involved. (1) “look left and right before crossing the street”. (2) “see if there are cars from all directions before walking on the street”. Although these two sentences are different they mean the same things.

Language is also the communication interface between two intelligent persons. The way to control other people's actions or to convey a message to other people or try to understand other people will depend on communication via language. Language can be conveyed in terms of hand motion, spoken words, text messages, or cell phones.

There are basically 3 things that the AI software has to represent in a language: objects, hidden objects, and time. I don't use English grammar because English grammar is a learned thing. These 3 things I mentioned are a better way to represent language. If you think of objects as nouns and hidden objects as verbs, then that is what I'm trying to represent.

Objects

Objects can be anything. It can be sound, it can be vision, it can be touch, and so forth. A visual word can be an object, a sound of a word can be an object, or the visual meaning of the word can be an object. For different senses the objects can be represented differently. There is also the consideration of combinations of objects together such as a visual object in conjunction with a sound object. A car zooming by is a combination of a visual object and the zoom sound is the sound object. Or dropping a pencil on the ground is a combination of visual and sound objects.

Another factor is that objects can be encapsulated. For example, a hand is an object that is encapsulated in another object, a human being. Another example is a foot is an object encapsulated in another object, a leg.

The way the program learns these objects is by repetition and patterns. Each object is represented by strength and if it ever repeats itself the strength gets stronger. If the object don't repeat itself then it will forget and memory won't have a trace. 1-d, 2-d, 3-d, 4-d, and N-d objects can be created by repetition and patterns.

Things like cat, dog, hat, dave, computer, pencil, tv, book are objects that have set and defined boundaries. Things like hand, mall, united states, universe don't have set boundaries. Either it doesn't have set boundaries or they are encapsulated objects. One example is the foot, when does a foot begin and when does a foot end? Since a foot is a part of a leg it is considered an encapsulated object. Another example is mall, when does the mall end and when does it begin? Since there are many stores and roads and trees that represent the mall we can't say where the mall ends and begins. The answer is the computer will figure all this out by averaging the data in memory. Another thing is that some objects are so complex that you have to use sentences to represent what it is. The Universe is one example, when does the universe begin and end? The answer is we use complex intelligence in order to represent the meaning to the word “universe”.

All 5 senses: sight, sound, taste, touch and smell have there own way of being represented. For simplicity purposes, only visual objects will be discussed.

Representing Simple Objects

Simple objects that have set and defined boundaries such as: cat, dog, hat, dave, computer, pencil, tv, and book are easy to represent. Visual objects are represented in terms of a floater. The floater is a 360 degree sequential images of one visual object.

There are objects encased in a movie sequence. Movie sequences will normalize all visual objects that it contains. The movie sequence in FIG. 11 depicts 4 normalized visual objects: Charlie brown, character with the blanket, snoopy and the background.

Referring to FIG. 11, all normalized visual objects are cut out from the movie sequence. All sequential images of Charlie brown are cut out forming a Charlie brown floater, all the sequential images of the character with the blanket are cut out forming a character with the blanket floater, all the sequential images of snoopy are cut out forming a snoopy floater and all the sequential images of the background are cut out forming a background floater.

Referring to FIG. 47A-C, boundaries of a visual object will depend on what images have strong association to a learned word. For example, if there are several Charlie brown images that have strong association to the words “Charlie brown”, then the AI program will average and calculate the most likely image sequence that represent “Charlie brown”. The existence of the image layers from frame to frame will average itself out and the most likely floater of Charlie brown is created.

For example, if several images of Charlie brown is seen and in each image the words “Charlie brown” is encountered, then the AI program will average all images and form a floater with the most likely sequences between each image.

Representing Encapsulated Objects

Hand, eyes, nose, elbow, knee, leg, back, neck and so forth are encapsulated objects of a human being. All data in memory are encapsulated. An object like a human being can have thousands and thousands of encapsulated objects. The more we encounter the encapsulated object the stronger that encapsulated object becomes. These encapsulated objects can then be assigned to words.

Determining the boundaries of an encapsulated object is very difficult to do. If a human floater is created and this floater contains the 360 degree sequential images of one object including scaling and rotation, then how is the encapsulated objects supposed to be represented? The answer is that within the human floater sections of image sequences are cut out and assigned to the encapsulated object.

It really depends on the learn words that have association with what images in a human object. The assigning of encapsulated objects is identical to the way visual objects are created. Let's use “hand” for example to represent parts of a human object. First, a learned word is associated with different hand images. A teacher will teach the robot, “this is a hand” or try to use images and associate that with the word hand. By establishing strong images related to the word hand, the AI program is able to fabricate what the sequential images that fall in between these strong images.

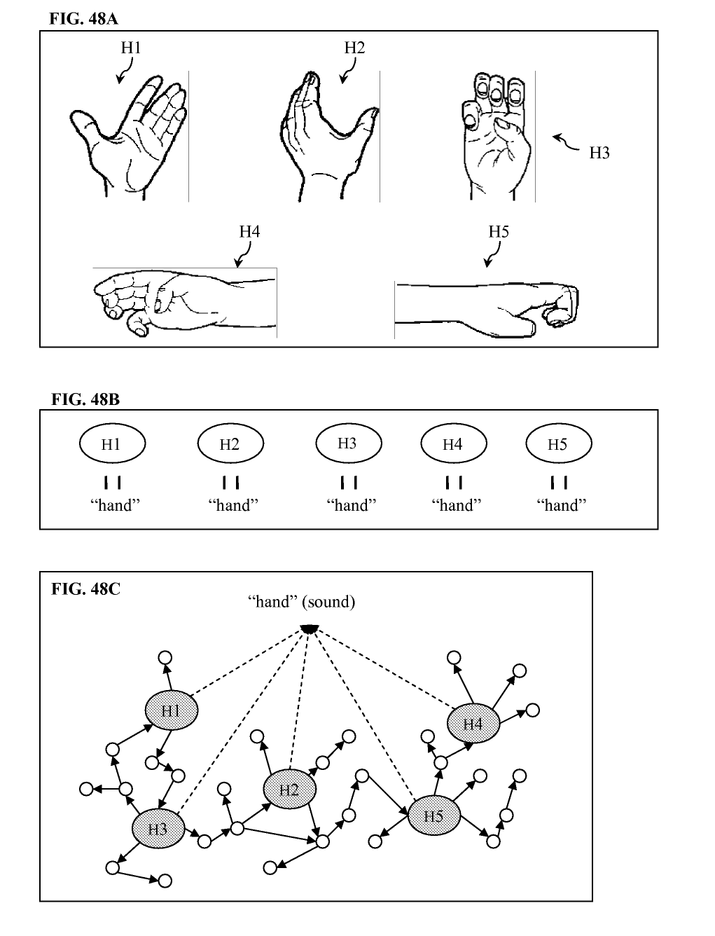

In FIG. 48A is an illustration of a hand from different angles and positions. These are the strongest images that the robot encountered in addition to the learned word “hand” (FIG. 48B). From the illustration, there are images of a hand from the front, back, side, at an angle and so forth. The sequential images that fall in between will organize itself in there proper place. The sound “hand” is what binds all the dominant images of a hand together and not only does it bind all the dominant hand images together (H1-H5), but it also brings sequential images closer together. The result is the hand floater with the “probable” sequential image boundaries from 360 degrees (FIG. 48C). The hand floater is cut out from the human floater and will be known as one object. The word “hand” will then be assigned to the hand floater.

Representing Complex Objects

More complex words, especially nouns and situations, are represented by: fabricated movie sequences or individual images or other words or sentences. Words like universe or mall or war or love can have meanings represented by images/movie sequences/even other 5 senses such as sound or touch. The word universe can be represented in a very simple way with an image of the stars and galaxies. Or the universe can have a much more defined meaning by using activated sentences. The mind can activate sentences such as: “the universe contains all planets, all galaxies and all objects around us”

On the other hand, a word like war can't be represented exactly the same for everyone, but each individual will have their own way of representing the word. War is a word that is very diverse and can represent many things. Just like the universe example, images, movie sequences, or activated sentences can represent the meaning to the word war. Images or movie sequences of guns, bombs, smoke, airplanes dropping bombs or battlefields can represent the meaning to war. Also, a more defined meaning can be had by using activated sentences to explain what war means or how it is depicted.

Other more complex words, entire situations, events, or grammar rules uses the same techniques that are used in the universe and war example. Individual images, sound, 5 sense data, movie sequences, fabricated movie sequences and other words or sentences are used in combinations to assign meaning to very complex words. Later on, examples will be given to illustrate different sentences and how the meaning of each sentence is represented.

Hidden Objects

Hidden data (or hidden objects) are data that are generated based on visual objects or multiple visual objects. Hidden data provide additional information about what is happening in the movie sequences. Words that can be represented in terms of hidden objects are: jump, walk, run, toward, in, into, on, go around, at the bottom, inside, move forward and so forth.

A hidden object like jump is a very complicated process. The AI program doesn't just use the visual object that generated the hidden object for jump, but it uses all of the encapsulated objects within the visual object. Let's use a human being for example. When a human being jumps there are many factors that are involved in generating the hidden object jump. First the ground is one object to consider, then the human object, and then the encapsulated objects in the human object such as arms, legs, head, body, waist and so forth. These objects are identified and hidden data are generated by their interactions.

The encapsulated objects such as arms and legs are moving in the movie sequence and the AI program has to keep track of all objects involved in the jump sequence. Where is the right leg in relations to the left leg at any given frame, where is the right arm in relations to the body at any given frame, where is the head facing in relation to the ground at any given frame and so forth are questions that the AI program will use to generate the hidden data for the jump sequence.

Simple words like jump and hop are words that are similar, but the hidden data generated are slightly different. A jump sequence that is done by a human and an ape looks different. The jump sequence that is witnessed from the front is different from a jump sequence from the back, side, top, or 2 yards away. There are infinite ways to show what a jump sequence looks like in a 3-d environment. It is up to the AI program to knit the strongest sequential hidden data together and average out what the jump hidden object will most likely include.

This technique of stringing groups of jump sequences that are represented from different angles are done using the same technique to assign words to visual objects or encapsulated objects (discussed previously).

Referring to FIG. 49A, walking is another hidden object that is very difficult to represent. The encapsulated objects in a human being such as arms, legs, head and body are used. There interactions with each other are factors that generate the hidden object. The right leg moves forward, the left leg moves back, the right arm is in front and the left arm is behind, the body is straight up and the head is facing forward. These details of where certain encapsulated objects are in each sequential frame are factors that generate the hidden object for the word “walk”.

Referring to FIG. 49B, walking can be represented in any angle. In picture 120 the walk is seen from the top. In picture 122 the walk is seen from the side. The AI program must associate all hidden objects of a walk from multiple angles.

Before we move on to finding meaning to entire sentences and situations a few topics have to be discussed first. Two topics will be discussed: one is the existence of objects and the other is the identification of objects. The first one basically determines wither an object is existing or non-existing or unknown in our environment. Objects can be anything. Objects can be physical objects in our environment such as car, dave, cat, dog, mall, or sky. Objects can be non-physical objects in our environment such as air or atom or bacteria. Objects can also be imaginary and things that are fabricated such as made up characters in fairy tales or comicbook superheros or ghosts or fabricated worlds and situations. Being able to know wither objects exist or not in our environment is very important. For example, if the robot is friends with a person name Jake and Jake recently past away, then the next time someone mention the word Jake, the robot needs to know that the existence of Jake is non-existing. Sometimes the existence of Jake can have multiple values. For example, if the robot believes that when people die they go to heaven then Jake exist in heaven, but doesn't exist in the real world. If the robot has doubts about heaven then the existence of Jake can have 3 values: existing, non-existing and unknown.

The next topic is the identification of objects in the current environment. Being able to understand pronouns from a story or being able to understand what objects people are referring to is vital. If the robot was watching a movie, the robot needs to identify what objects are being referred to. Imagine this scene: a driver is in a car and Jessica is outside the car. The driver says: “Jessica, get in and hang on tight”. The next thing that happens is Jessica getting into the car and the car speeds away. When the statement: “Jessica, get in and hang on tight” is said by the driver, the robot needs to identify that the word “Jessica” is referring to the visual Jessica in the movie and when Jessica got into the car the words “get in” is referring to that scene. Later on, many examples will be given to better understand the existences of objects and identification of objects.

In both cases, the existence of objects and the identification of objects, the robot's conscious will do all the assigning. However, there are patterns that can be used instead of the robot's conscious to assign existence and identification. Usually, simple situations use patterns to assign existence or identification. In more complex situations the robot's conscious will be used to assign existence or identification of objects in our current environment.

Meaning of an object activates both ways. If a sentence like: “Jessica, get in and hang on tight” is read to the robot, then a fabricated movie sequence of the sentence will activate in the robot's mind. On the other hand, if the robot was watching a movie where a girl name Jessica gets into a car and holds the steering wheel tightly then the movie is activating a sentence in the robot's mind. A sentence such as “Jessica got into the car and is holding the steering wheel tightly”. The sentence activates the movie sequence and the movie sequence activates the sentence.

The next section will cover examples illustrating how meaning is assigned to words and sentences. I discuss the specific objects that are being activated based on words and sentences. This will give the readers a better idea of what forms of meaning is assigned to what words or sentences.

Assigning Objects Using Visual Images and Diagrams

Visual images and diagrams can assign words to objects. Instead of training the AI program to associate one word with one image the AI program can learn how to assign one word to one image by using patterns in diagrams. For example, if the robot wanted to learn the word “bat”, a teacher has to show the robot a picture of a bat and the word “bat”. Many training is needed in order for the robot to associate the picture of a bat to the word “bat”. When the association between the two objects is strong enough the word “bat” and the picture of a bat are the same object.

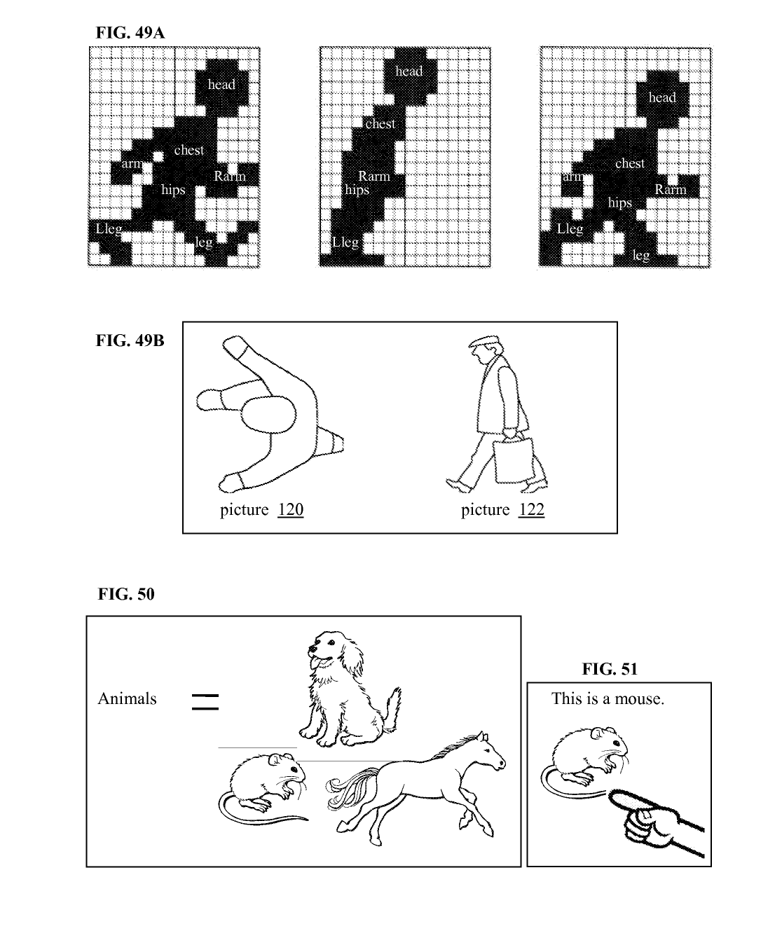

A shortcut to associating two objects is to use diagrams and forming patterns in the diagram to assign one object to another. The word animal can be assigned to images of animals, from the diagram in FIG. 50. Notice that the equals sign is the symbol that is used to assign the left object to the right object/s. The left object is the word animal, while the right objects are pictures of animals. The equals sign is the symbol that contains a pattern to assign two objects together regardless of their position in the environment. Multiple words can also be assigned to multiple pictures. Assigning all kind of words in English can be accomplished using this diagram.

Assigning Objects Using Sentences and Visual Diagrams

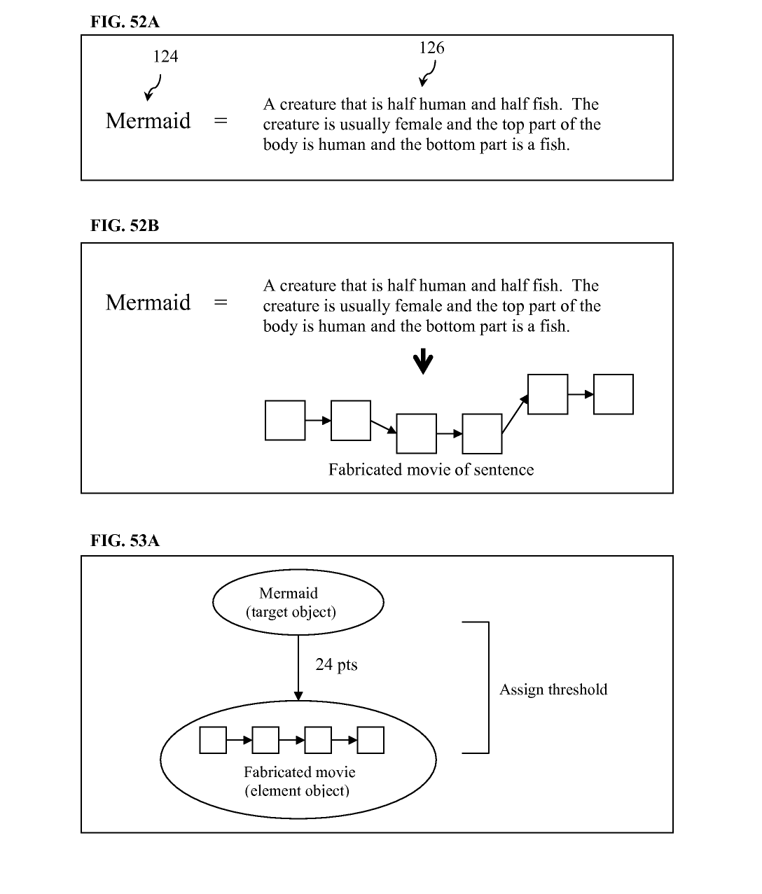

Sentences can also be used to assign one object to another object. Referring to FIG. 51, the diagram shows that the sentence is referring to visual objects in the picture. The sentence, “This is a mouse” is saying that the word mouse is the image mouse. The robot will create the word mouse in memory and store the image of the mouse very close to the word mouse. Variations of this example can be used to learn new words. Examples such as: this is a giraffe, this is a cat, this is an animal, this is a house, this is a kitchen, this is a hand and so forth.

Sentences can also assign entire meaning to a word. When you open a dictionary for example, the meaning to a word usually comprises a long sentence or series of sentences. Referring to FIG. 52A, pointer 124 is the word to be stored in memory and pointer 126 is the meaning to the word (in the form of a sentence). In order for the robot to store the meaning to the word it has to understand the sentence in pointer 126 first. When the robot reads object 126, activated element objects in terms of a fabricated movie (or 5 sense data or visual images or other sentences) will pop up in the robot's mind. Instead of storing the sentence in memory it has to store the fabricated movie instead. This fabricated movie serves as the meaning to the word (FIG. 52B).

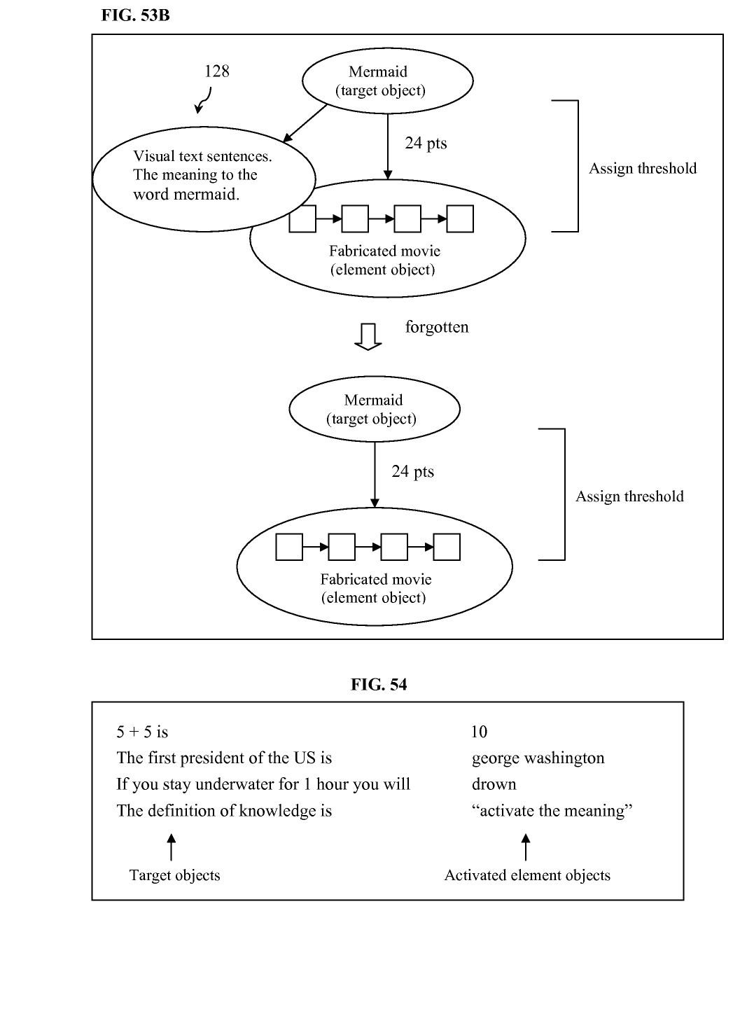

The meaning to the word can be long (it can even be several paragraphs). The AI program will simply store the meaning, in terms of a fabricated movie sequence, very close to the word. FIG. 53A illustrates this example.

This type of assigning meaning to words is faster than letting the AI program find associations between two objects. The diagrams and sentences used to learn meaning to words can be in any form. The equals symbol is just one in many examples that show diagrams and sentence can be used to assign meaning to words or sentences.

The fabricated movie is actually the meaning to the sentence. Fabricated movies activated by a sentence come from patterns. The patterns fabricate movies that are made from sections of other movies in memory.

Referring to FIG. 53A, after looking at the dictionary and reading the definition for mermaid the robot has created two objects in memory. One object is the text “mermaid” and the other object is the definition of the word. Since the task of the robot was to look up the definition, then it knows that it has to find the meaning to the word mermaid. In other words it's an assignment statement, where the robot has to assign one word to a definition and store them in memory.

Referring to FIG. 53A, the dictionary is like a diagram in that the equals sign is a symbol to indicate that the word on the left is one object and the sentence on the right is the meaning. The robot will store the text word mermaid as the target object and store the definition (in the form of a fabricated movie) as the element object and makes sure that the element object passes the assign threshold. Then it will give the associational connection a strength number. In this case the associational connection is 24 points (associational strength is just the closeness of two objects).

Referring to FIG. 53B, the question is: what happens to the visual text definition of the word “mermaid”? The visual text sentences that comprises the definition to the word “mermaid” is also stored right next to the target object mermaid (pointer 128). However, the visual text sentences are lengthy and can't be remembered for a long period of time. The fabricated movie will remain in memory, but the visual text meaning of mermaid will forget very quickly.

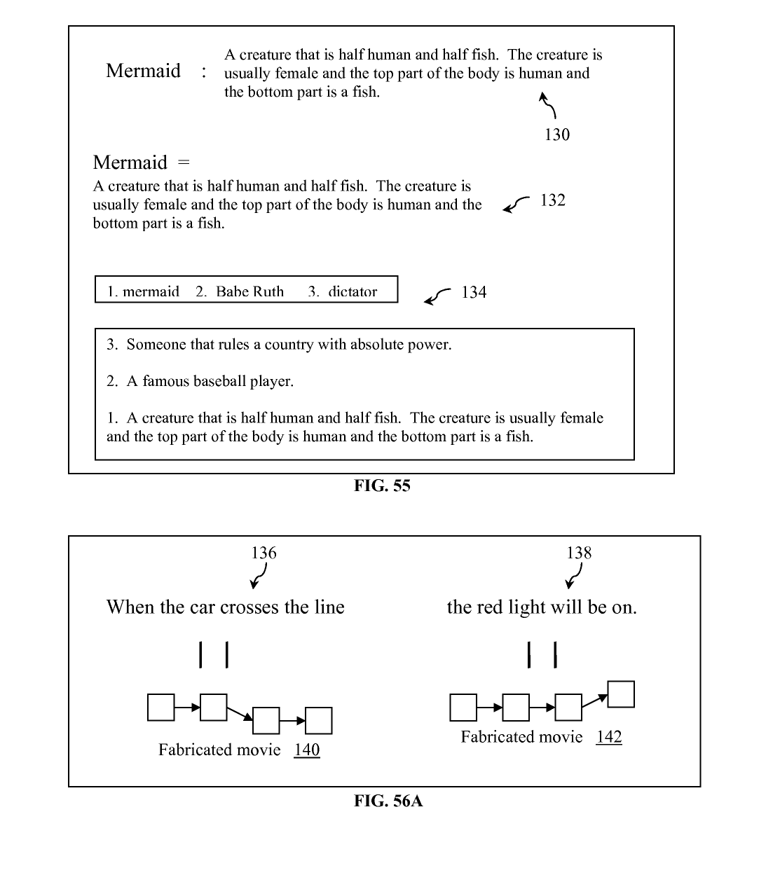

If you can imagine all the words that can be learned from a dictionary and stored in memory. Referring to FIG. 55, imagine all the different diagrams that the teacher can use to assign one word to a meaning. Pointer 130 shows that the equals sign can be replaced with a colon. Pointer 132 shows that the definition can be stationed on the bottom of the word instead of to the right of the word. Lastly, pointer 134 shows that the definition can be arranged in a variety of ways. Multiple words can be put on the page with the definition positioned anywhere on the page. The only link is the number next to the word that links it to the same number next to the definition. Teachers will teach the robot using diagrams and sentences how to assign meaning to words and it is up to the robot to find the patterns.

Representing if-then Statements, when Statements, and Other Conditional Statements

The statement, if R1 then R2, is actually a pattern telling the robot that in a movie sequence R1 will happen and if R1 does happen R2 will happen shortly after. The statement, if not R1 then not R2, is also thought to the robot. Patterns are used to understand the relationship between the two opposite statements. This is a simple way of understanding the if-then statement. A more complex way of understanding the if-then statement is by using activated sentences to explain to the robot the probabilities involved and what happens if R1 happen or don't happen and so forth.

The great thing about representing mathematical statements by using patterns is that it can be applied to all statements that are similar. For example, these are similar statements to the if-then statement: when R1 then R2 happens, R1 will lead to R2, R1 happens first then R2 will happen next, R1 then R2, R2 happens second, R1 happens first, R2 if R1, R2 is the affect of R1.

More complex math statements can be created such as nested if-then statements or multiple condition and multiple events in an if-then statement. Not only that, but very complex statements that even discrete math can't represent can be represented using complex patterns. Probability of events and probability of conditions along with other complex statements can be formed.

For-loops and while-loops can also be represented in terms of complex patterns. Imagine a for-loop statement such as: “shoot the target until you hit the red circle” (R1 until R2). In a movie pathway the AI program notices that R1 happened 3 times and on the third time R2 happens. If it compares this example with other similar pathways the AI program will notice a pattern—a loop that occurs. This pattern will then be assigned to the sentence “shoot the target until you hit the red circle”. A universal meaning and a universal sentence will also be created. “R1 until R2” will be assigned the universal meaning.

That is one way to find meaning to for-loops and while-loops. Another way, like I said before, is to use activated sentences to tell the robot what a for-loop or while-loop means. Activated sentences or diagrams will show the AI program what the function of the for-loop is. It will also tell the AI program where the condition part is and where the event part is.

And, or, Exclusive or, and Complex Combinations of and's and or's

The AI program treats grammar structure in terms of a diagram. Visual text images are on the paper and the robot has to understand the meaning of each visual text. The best way I can describe how the AI program will understand complex “and” and “or” statements is by grade school worksheets (Especially, first and second grade worksheets). There are tasks that the child needs to solve in each worksheet. Some of the problems deal with coloring specific areas in the picture while others are trying to solve a maze. By erasing the images or coloring the images or cutting out the images or writing down text on the paper, the child is doing things in order to manipulate the environment or to solve a specific problem. Teachers will guide the child at the beginning and the child will do the problem without the help of the teacher when that child understands the problem and understand how to solve that problem.

In order to understand nested and's and or's a teacher has to teach the robot about what the and-statement does and what the or-statement does. The teacher will use simple examples such as “R1 and R2” or “R1 or R2”. Then the teacher has to show what the two statements do in a situation or in a long sentence. For example, R1 and R2 is on the picture means that R1 and R2 are existing in the picture. On the other hand, the sentence: R1 or R2 is in the picture, means either R1 or R2 can be in the picture. Either the robot will use patterns to find this out or it will use activated sentences to tell itself what the sentence means.

When dealing with nested “and” and “or” statements such as: the car and the key and the dog and the house or the boat belongs to dave. This sentence has to be written out on paper and the teacher has to teach the robot what the sentence means. In the sentence the words: “and the house or the boat belongs to dave”, means the house or the boat, either one but not both, can belong to dave. In current language software nested “and” and “or” statements are taken in at once, while the human artificial intelligence program takes in sections of the sentence at any given time and interpret one section at a time. It is also required that the HAI program has to reread certain sentences to get a better and clearer understanding of the statement.

In real world examples the “and” and “or” statements don't really mean what it is intended in the statement. There can be multiple interpretations to the statements or the speaker can be joking or the statement is used as a metaphor. If using discrete math the and/or is actually fixed and there is no way of changing the meaning.

Association Between Two or More Objects

The robot's conscious works by having the robot identifying an object and the strongest association to that object will activate in the mind. Identified objects are called target objects and objects that have strong association to the target objects are called element objects. All target objects identified by the robot will have their element objects extracted and all element objects from all target objects will compete with one another to activate in the mind.

Strong associated element objects such as meaning will activate first, then less associated element objects such as stereotypes and trees will activate next. Element objects can be in the form of “anything”. Element objects can be images, 5 sense data, movie sequences, fabricated movie sequences, sound words, text words, entire sentences, meaning to sentences and so forth. For example, if the target object was the sound “bat” the activated element object might be a picture of a bat. If the target object was “George Bush” then the activated element object might be a movie of George Bush giving a speech from the white house.

With this said, object association can be applied to sequential frames. Each frame in a movie sequence can be known as an object. Closest future sequences have more association from frame to frame.

This lesson is important because the robot uses this technique to produce logic and reasoning. If the target object is sentence1, then the activated element object will be the sentence that has strong association to sentence1. In the case of sentence sequences, the activated element object is the most likely next sentence that comes after sentence1. In fact, sentence in this context doesn't have to be in a grammatical way, but can be strings of sequential words. For example, if the target object was a string of words, the AI program will activate the continuation of the string of words. In FIG. 54, the target object is “5+5 is” and the activated element object is “10”. This demonstrate that within a given movie sequence, the AI program will activate the most likely next sequence. This technique can be applied to questions/answer, statements, facts, commands, paragraphs and so forth.

The reason that the AI program activates sentences or meaning of sentences (a fabricated movie) is because these type of objects in memory are strong. Sentences are encountered many times during the life-span of a human adult. Language has repeated patterns that make them unique and because they are unique language are strong objects in memory. The meaning of sentences are also strong objects because the meaning is easier to store than the sentences itself. Different sentences look and sound different, but the meaning is virtually the same. With many training the meaning will become stronger and stronger in memory.

Below are just some examples of target object—activated element objects (robot's conscious) that solve problems in current artificial intelligence subject matters.

Activating Facts and Question-Answer

When facts are stored in memory they are stored in terms of sound words or visual text words. The robot will recognize a word at a time and the movie sequence will include the words in sequential order (basically sentences). Some sentences will be linear where it is fixed while others are universal and contains some kind of pattern. Sentences that are fixed will be sentences like: the world is round, the first president of the US is George Washington, the 50^{th} state is Hawaii, the first letter in the alphabet is A, nothing can go faster than the speed of light, superman is a make-believe character and so forth. Facts that don't change, are considered true in any time period, and stays consistent are fixed. These types of data become stronger and stronger in memory as a result of their consistency.

Referring to FIG. 54, shows a few examples of activated facts. This example will be used in the next example to show how questions are answered.

On the other hand universal patterns in sentences are created as a result of a pattern (or patterns) found between similar examples. Usually, questions rely on universal patterns in sentences in order to answer. What is 5+5, what is 7+5, what is 3+5, what time is it, where is dave, what is bat, where is the library, how old are you, does the flower smell good, where is the bathroom, where did you go, what year is it, are questions that rely on some kind of pattern in order to answer. All questions mentioned are target objects. The questions are not stored in memory (some are). Questions are so diverse that they use universal patterns in memory in order to answer. Patent application Ser. No. 11/770,734 describes some of these patterns.

Answering questions is actually a way to predict the future. Having that ability to fabricate a pattern of the future based on current data and data in memory.

Recognizing Conditions and Activating Sequential Events

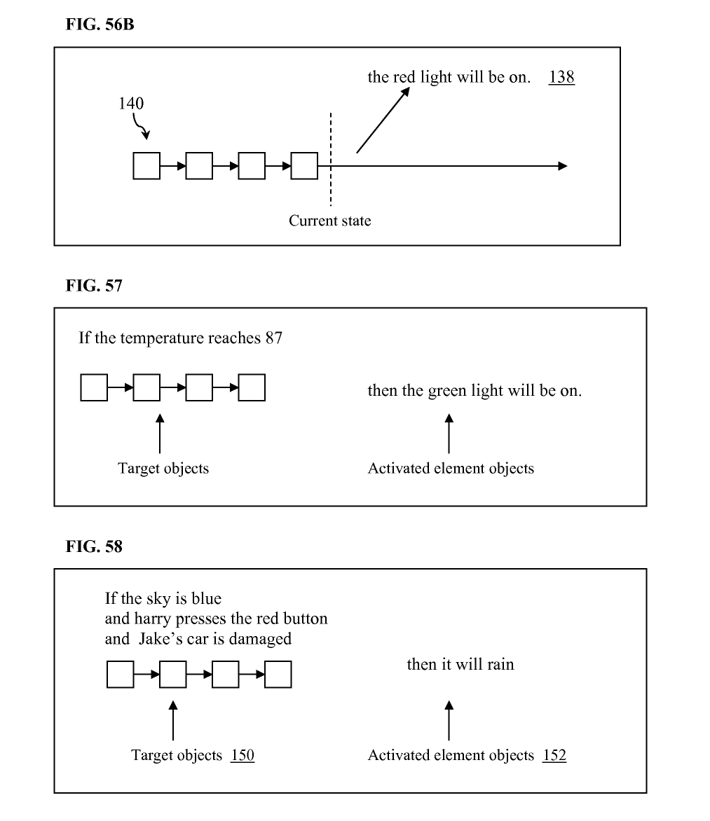

When-conditions, if-conditions or any conditional statements can be used to activate events. FIG. 56A-58 shows several examples of how the robot's conscious can represent conditions and events. The condition parts are the target object. These are the things that the robots' recognizes from the environment. The event is the activated element objects. The idea behind this technique is that when the condition part is recognized the event part is activated.

Each sentence is represented by meaning (usually in the form of a fabricated movie). The fabricated movie (or meaning) equals the sentence. If the AI program recognizes a movie sequence similar to the fabricated movie it will activate the remaining sentence. FIG. 56B illustrates this point. Movie sequence 140 is the visual representation of “the car crosses the line”. When the AI program recognize movie sequence 140 sentence 138 activates in the AI program's mind. Although movie sequence 140 isn't a sentence 136, the movie is the meaning to sentence 136. That meaning will activate the remaining sentence 138 that is the continuation of sentence 136.

Logic and reasoning greatly depend on this technique. The reason that humans are intelligent partly comes from this technique. Meaning of a sentence works both ways: the sentence activates a movie sequence and the movie sequence activates the sentence. Combinations of object meaning can also be used. When the movie sequence 140 is recognized the remaining sentence sequence 138 will activate. If a sentence 136 is recognized the remaining movie sequence 142 will activate.

Referring to FIG. 58, the movie sequence recognizes that the “sky is blue”, “harry presses the red button” and “jake's car is damaged”. Because all three criteria have been identified in the environment the remaining sentence 152 will activate in the robot's mind: “then it will rain”. The criteria, harry presses the red button, can be in any form. The robot can be watching harry press the red button from the front, side, at an angle, 50 yards away, 2 feet away and so forth, the fact that the robot identified harry pressing the red button meets the criteria. The other criteria, jake's car is damaged, can be in any form too. The robot can observe jakes car from the front, side, at an angle, 3 yards away, and so forth, the fact that the robot identified that jakes car is damaged meets the criteria. The damaged part can be anywhere on the car.

Grade School Worksheets

I can't emphasize how important it is that the AI program has the ability to solve grade school worksheets. Being able to solve a math problem, to solve a maze, accomplish coloring tasks, group species together, understand reasoning and logic, identify image boundaries, changing and modifying images in the worksheet and so forth.

Like I said the understanding of language is the key to intelligence. Understanding meaning to words and sentences and knowing what to expect in the future are abilities that will help in understanding how to solve a worksheet.

A universal pathway has to be created to solve a universal worksheet. It doesn't matter what the problem on the worksheet is, the AI program should be able to solve it. It doesn't matter if the worksheet relates to: math, science, logic, maze, puzzles, tasks, or grammar, the AI program will be able to solve the worksheet related to any subject matter.

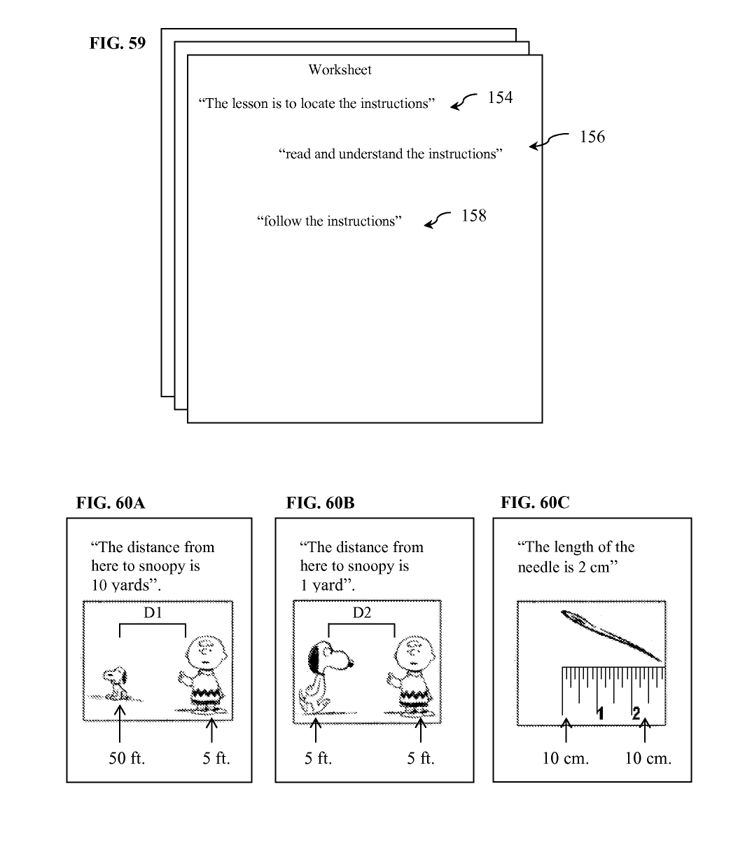

Referring to FIG. 59, a teacher will teach and guide the robot to solve different types of worksheet. The robot will average out the lessons thought and the average lessons will activate when the robot encounters a future worksheet. The activated sentences are displayed in FIG. 59. These sentences activate the moment the robot encounters a new worksheet. “The lesson is to locate the instructions” “read and understand the instructions” “follow the instructions”. Basically with these three activated sentences the robot can solve any worksheet. The instructions will be in the form of a sentence (or diagram). By understanding the sentence the robot should be able to accomplish the task. These three activated sentences serves as a planner—to understand the rules (sentence 154 and sentence 156) and to take action (sentence 158).

The specific instructions on the worksheet will give the robot a better idea what pathways in memory to follow in order to solve the worksheet. If the instructions want the robot to solve a math problem then the pathway to solve a math problem will be traveled. If the instructions want the robot to color pictures then the pathway to color pictures will be traveled.

Changing Shape of an Object

When an orange is pealed the inside of the orange is revealed, when someone takes of his shirt the shirt changes its shape, when a fish is cut into three pieces the three pieces represent the fish. These examples demonstrate how objects can change its shape over time. One object can be cut into multiple objects, objects can change its shape or multiple objects can form into one object. The way that humans understand the properties of an object is by seeing the object sequentially. The sequence of an object will link the changing shape of the object.

Floaters are created based on object sequences and patterns within object sequences. For example, a shirt can have many variations and each time the shirt can look different. Each time a person puts on a shirt the shape of the shirt is different. However, there might be some kind of pattern within these shirt sequences to suggest that all shirt sequences are the same. This pattern is used to universalize all shirt sequences. By universalizing all shirt sequences a human being can understand the changing variation of someone putting on a shirt. This is also why a human being can identify a shirt regardless of what shape the shirt is in.

This example can be applied to all objects including: hat, bag, bread, eye glasses, water melon, apple, soda can, tree, water, ice, paper, wood, dress, metal and so forth.

Thinking and Focusing

The word “think”, if understood by the robot, can be used to control itself. Sentences can be thought to the robot by teachers in terms of the word think. Sentences like: 1. think about the problem. 2. use your mind to think of a solution. 3. solve the problem by thinking of a way to solve the problem. 4. think of the image. 5. think of the sound. 6. he is thinking of a house. 7. think of how far the distance is from the supermarket to the library

The AI program will find patterns between the thought process of the machine and the meaning of each sentence. These sentences are then used as patterns to control the machine to think in a certain way. Thinking is actually just pathways in memory with specific patterns.

“Think of a cat image”, for example, means the robot has to locate the object cat in memory and activate one image of a cat. “Think of a logical solution to the problem”, means that the robot has to use data from memory and certain objects from the environment to solve a problem. “What are you thinking about”, means that the robot has to say what was on his mind before the question was asked. He must look at short-term memory to find what was activated in memory based on the environment and use these activated pathways to answer the question.

Learning to focus on an object in the environment is thought by teachers and these lessons guide the robot to focus on certain objects. Despite the countless objects that the robot senses from the environment it is able to filter out the objects that are most important—sentences such as: focus on only moving objects, focus only on animals in the picture, focus on the traffic light, concentrate on the essay, stare at the red light; when it moves follow the red light

This will greatly prioritize objects in our environment and determine which objects to search for first and last. The robot will activate the sentence in a given situation and the robot will know what to focus on. The focus sentences (examples above) demonstrate some of ways that can focus the robots attention on objects in our environment.

Focus has basically two types: one is innate focus and the other is learned focus. Innate focus are instructions built into the robot. Basically, things that get the robot's attention. Loud noises, moving objects, bright lights, beautiful objects, good food and so forth are focused on. Learned focus are the lessons thought to the robot by school teachers to focus on specific objects in our environment. This form of focus is intended to help the robot solve problems, analyze a situation, or search for objects in the environment. Both type of focus will be used by the robot.

These two important functions: thinking and focusing, greatly increase the intelligence of the machine. These two functions can be assigned by patterns in sentences and the sentences instruct the robot to think or focus. Again, this is why representing meaning to language is so important because language is the engine that produces intelligence.

Learning Distance Between Two or More Objects

Distance and measurement learning comes from lessons from school. Learning and understanding words like centimeters, millimeters, yards, meters and miles come from lessons thought by school teachers. The robot has to know that it is living in a 3-dimensional environment. The 2-d movie sequences from the environment should be interpreted as 3-d. This is important because the distance of pixels in a 2-d image and a 3-d image are interpreted differently.

Distance and measurement words in a 3-d environment are learned by teachers. In FIG. 60A, when Charlie Brown says: “the distance from here to snoopy is 10 yards”, D1 represent the distance in the 2-d image and the arrow pointers represent the eye focus (50 ft. and 5 ft. respectively). In FIG. 60B, when Charlie Brown says: “the distance from here to snoopy is 1 yard”, D2 represent the distance in the 2-d image and the arrow pointers represent the eye focus (5 ft. and 5 ft. respectively). Notice that D1 from FIG. 60A has the same distance as D2 in FIG. 60B from a 2-dimensional plane. But because the eye focuses are different and the robot is judging the distance in terms of 3-dimensional, D1 and D2 are actually different (D1 represent 10 yards and D2 represent 1 yard). FIG. 60C is another example. Eye focus is very important in terms of measurement and not what is actually measured in the 2-d image. In this example, 2 cm is derived from two points with close eye focus (10 cm. and 10 cm. respectively).

Analyzing Movie Sequences from Long-Term Memory

Just like how teachers teach the robot to analyze scenes from real life or movies, the AI program can be thought to analyze movie sequences from long-term memory. Sentences such as: “remember the hit and run car, what did the car look like” or “can you recall the person that was driving the car” or “can you remember the license plate number” or “can you tell me what happened during the car accident”. These sentences instruct the robot to recall past experiences from long-term memory and to analyze the situation.

The activated sentences from analyzing past movie sequences will also be stored in memory. This will allow the analyzed data to be recalled along with the movie sequence when the robot accesses that movie sequence in the future. This function is kind of like having a second conscious thought to a past experience.

Fabricated Movies or Meaning to Sentences

When sentences are read (or heard) by the robot, the robot's conscious will activate a fabricated movie. These fabricated movies are made up of combinations of movie sequences in memory. Images, sounds, tastes, touches, smells, hidden objects, pattern objects are combined together to form a make believe movie. For example, let's use George Bush as the object we want to fabricate a movie about. We can imagine a 360 degree image of George Bush in our head. Any movie sequence of Mr. Bush in 360 degrees can be fabricated regardless of the camera techniques used such as zoom-in, zoom-out, moving to the right or left and so forth. We can imagine George Bush jumping over a computer or imagine George Bush in a library reading a book. Any movie sequences that is contained in memory can be combined together to fabricate an imaginary movie.

We can also fabricate a 3-d movie sequence based on one 2-d image. When we read a book, sometimes there are pages that have images. We can fabricate movie sequences on what is the most likely movie sequence based on these images. For example, if the robot is reading a book on “the lion the witch and the wardrobe”, he can fabricate what the story is about based on the image on the cover and images throughout the book. The characters will have a physical appearance close to what the artist portray the characters in the images. The environment will also have a physical appearance from the imaginary mind of the artist and the writer. The robot reading the book will use the images throughout the book to fabricate a movie sequence of the story.

Fabricating a movie sequence is based on patterns and based on lessons thought by teachers. It requires that the robot cut out certain sections in a movie sequence and paste it onto another movie sequence. Imagine there is a character called Jake and we have a good image of what Jake looks like in memory, but we haven't seen Jake jumped before. In order to fabricate an image of Jake jumping we have to cut out the image of jakes face and paste it onto the “most likely” body of a jump sequence resembling Jake. This way we essentially made up a movie sequence of Jake jumping, not based on a memory of Jake jumping, but based on cutting and pasting movie sequences together.

Learning how to fabricate a movie sequence in its mind require the robot to learn how to cut and paste pictures together in the real world. Also, learning how to distinguish what are image layers and what are the boundaries of visual objects is essential. Patterns will link all these lessons together and these patterns will allow the robot to fabricate make believe movie sequences in its mind.

Universal Videogame Program

In prior art, the recursive strip program is used to plan and execute tasks, wherein tasks are accomplished recursively by solving the small problems first before solving the larger problems. The recursive strip program can be combined with a rule-based system to solve interruption of tasks or manage multiple task executions at the same time. These hybrid AI programs are not self-learning because an expert programmer has to “manually” preprogram all the rules and probabilities into the system. These AI programs are also very limited as to what they can do and complex AI programs such as human level intelligence can't be produced.

The human artificial intelligence program is a self-learning AI program because it receives all its data from the environment. No predefined rules or tasks are ever preprogrammed into the system (except innate traits such as pain or pleasure). The best way to describe how the HAI program plan tasks and solve interruption of tasks is by using examples from videogames. Human beings use some kind of universal videogame program to plan tasks and interruption of tasks. They can play any videogame for any game console (NES, Genesis, Playstation 3, X-box 360, PSP, and Nintendo Wii). They can also drive a car, fly an airplane, operate a computer, build a bridge, clean the floors, mow the lawn, ride a bike, prepare dinner and manage a business.

My all time favorite game is the Legend of Zelda for the SNES. I played this game when I was 16 years old. Even though I was considered intelligent at a teenage-level, this game was a challenge for me. It took me about 4 weeks to finally beat the game. In the middle of the game I was stuck and couldn't past level 5. No matter how hard I tried I couldn't get past level 5. Eventually, I got tired of trying and I went to the local videogame shop to buy a strategy guide for the Legend of Zelda. After reading some of the hints and strategies from the book I finally had enough knowledge to past level 5. If the strategy guide was not used I would of never past the game. This also means that a person with adult intelligence is required to past the game.

The example above illustrates that there are some videogames that are so hard only a person with adult intelligence (or beyond) will be able to past these games. To build a universal videogame program is like solving the hardest problem facing AI today—to build a machine that can think, plan, act, and solve problems at an adult level. In the next section I will outline how the AI program plays videogames.

In parent applications I demonstrate how the AI program plans tasks. Factors such as innate pain/pleasure, lessons from society, and normal behavior are used to make decisions on what a person wants to do in the future. A lifetime of lessons from teachers will make decisions for the robot. In this section I'm only concerned with the task of playing videogames. Task interruptions such as the robot is hungry, or someone is interrupting the robot, or the fire alarm goes off are not discussed. For example, if the robot is playing a videogame and someone is blocking the tv screen, the robot will stop the task of playing videogames and start a new task of getting that person away from the tv screen.

In prior art, planning a task has two states: start state and goal state. Instructions in the form of rules and knowledge are needed to get the robot from the start state to the goal state. In the HAI program there is no such thing as a start state or a goal state. There is also no such thing as instructions to get from the start state to the goal state. The AI program is only following pathways in a linear fashion, wherein it travels and jumps around from pathway to pathway in memory. The pathways contain the goals or instructions. The start of a goal is represented by a sentence or an event and the end of a goal is represented by a sentence or an event. From here on goals, instructions, start state and so forth will be referred to as tasks.

Tasks

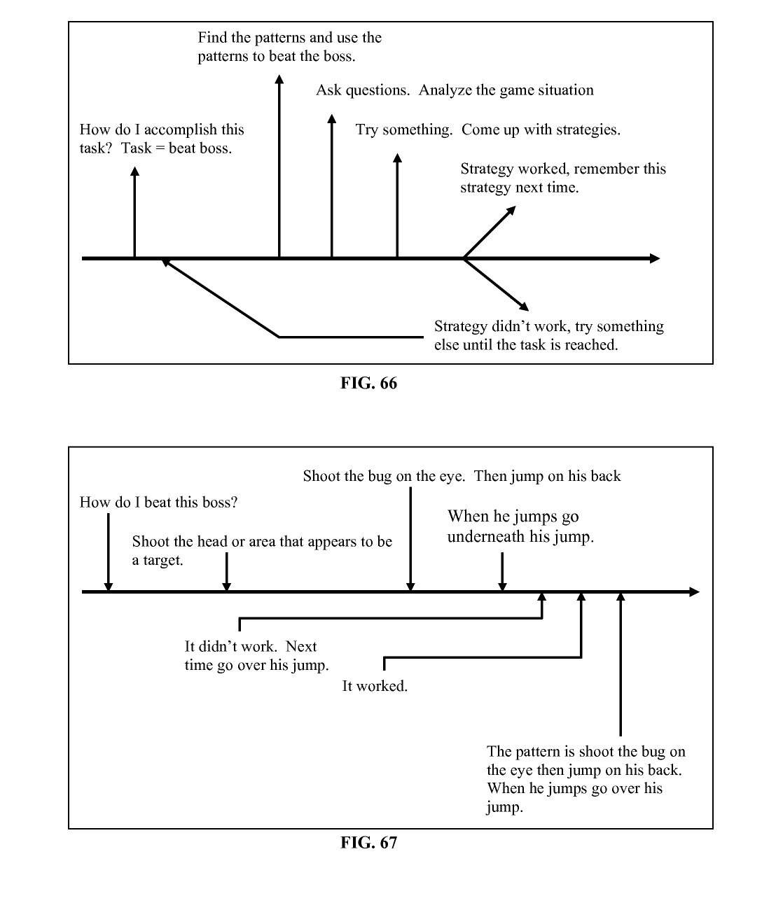

Tasks can be anything. It can be an action, a result, an event, or a current state. Tasks use language, meaning to language or 5 sense data in order to represent. Sentences or movie sequences in pathways usually represent a task. FIG. 66 shows a pathway with tasks. I use sentences to represent tasks, but in the real world, sentences, events, 5 sense objects and so forth can represent tasks.

Tasks are encapsulated in that one task can have many sub-tasks and each sub-task can have many sub-sub tasks. As the AI program learns more from the environment more tasks are added into the pathways. A task such as opening a door in a house can have multiple sub-tasks. Opening a door can have sub-tasks such as getting the key, locating the key hole, inserting the key into the key hole, turning the key, turning the door knob, and pushing the door open. With each sub-task are other sub-sub-tasks. For example, in the last step, pushing the door open, the robot has to hold on to the door knob with its hand, instruct the arm to push the door, and push the door until the door is ajar enough for the robot to enter.

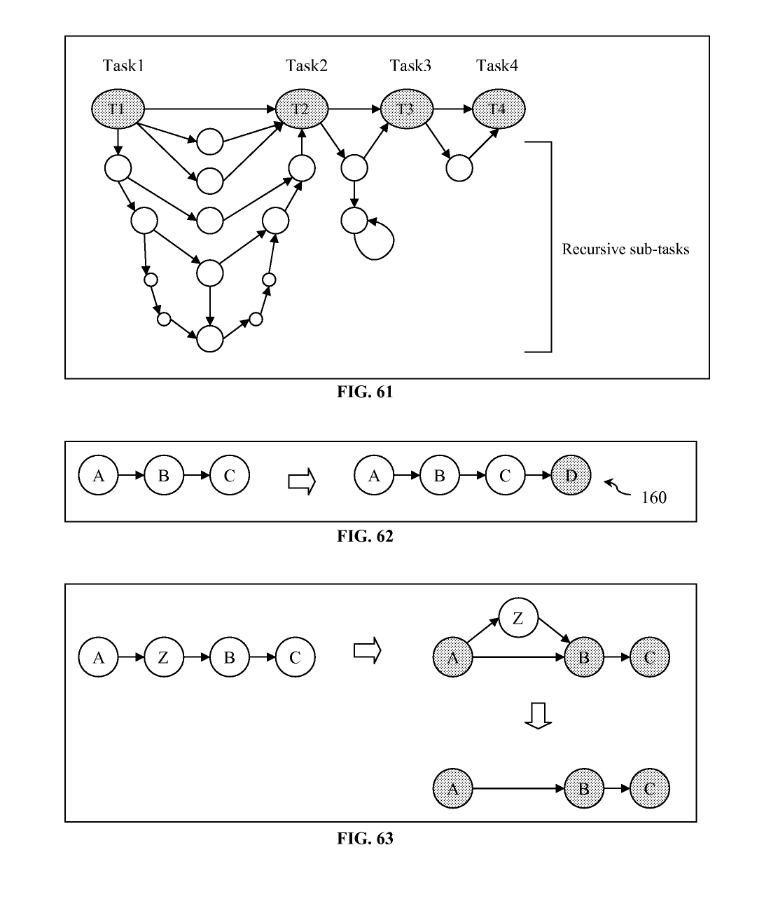

There is no distinction between sub-tasks and tasks, the tasks are arranged in a linear order where the AI program will decide how important certain tasks are. The tasks that are repeated many times will have top priority, while tasks that are not encountered many times will have low priority. When the AI program averages out similar examples, it will realize that certain tasks, most notably what humans would consider a task, are important (tasks) and what task are not important (sub-tasks). FIG. 61 illustrates this point, task1, task2, task3 and task4 are consistent, therefore they have high priority. The sub-tasks are not important and therefore have low priority. Sub-tasks such as locating a key have many variations. The key can be located in any 360 degree environment so there can be infinite possibilities (a sub-task). However, the instructions to locate the key are the same and consistent everytime (a task).

To sum things up, consistency in terms of training will determine how important tasks are. A hierarchical order of the tasks will be outlined in a pathway, wherein the pathway is universal and the AI program enters a task first before entering the sub-tasks. FIG. 61 is an illustration of a hierarchical pathway that is structured in a manner that prioritizes tasks and subtasks. The hierarchical pathway appears like a forest tree, but each pathway is still considered linear. Modification of tasks and sub-tasks are done linearly, whereby the AI program insert, delete, and modify tasks or sub-tasks in linear order.

Following a pathway is based on the best matched in terms of priority of objects (a task is an object). This means the optimal pathway can have many missing tasks compared to the current pathway. The current pathway will be stored in this optimal pathway regardless if it's a 100% match or 9% match. In FIG. 61, the matches between the optimal pathway and the current pathway can be only task1, task2, task3, and task4. The rest of the sub-tasks in the optimal pathway do not match with the sub-tasks of the current pathway. This is how the robot listens to the conscious and not what is actually sensed from the environment.

Growing and Shrinking and Breaking Apart Pathways

A human being can only remember certain lengths of pathways (sequential data) before he/she can't remember anymore. Sequential instructions, the ABC's, words from a song, and sequential chapters from a book are just some examples that demonstrate sequential data can only have a limited length before it can no longer be recalled. However, the more we learn the longer the length of the pathway. Even an entire book can be recalled if that person practices remembering each word in the book every day.

Pathways in memory forget information so that only important data gets stored. The AI program doesn't store all sequences of a pathway in memory linearly, it stores pathways by sections. Also, when pathways forget information that pathway will break apart into sub-pathways and migrate to the closest common data in memory. The length of the pathway will be determined by the beginning point of the pathway and the ending point of the pathway.

Inserting tasks—Tasks can be inserted into pathways or it can be deleted from pathways. If teachers teach us how to solve the ABC block problem and decides to add in block “D” to further our skills, then the teacher can teach us how to stack up the alphabets with not only blocks “ABC”, but also block “D”. Referring to FIG. 62, block “D” is inserted at the end of the ABC block pathway (task 160). Insertion of tasks can be anywhere in the pathway—tasks can be inserted at the beginning, between tasks or at the end of pathways.

Deleting tasks—Referring to FIG. 63, if teachers made a mistake and wanted to get rid of block “Z” then it has to re-teach the robot child the same problem, but this time, omit block “Z”. The pathways will have both AZBC and ABC. However, ABC will get stronger and stronger, while AZBC will get weaker and weaker. It will reach a point where AZBC will be forgotten (or deleted). Thus, block ABC will be the pathway stored in memory (this is the brute force way of deleting a task, a faster way of deleting or modifying a task will be explained next).

Modification of Tasks and Sub-Tasks

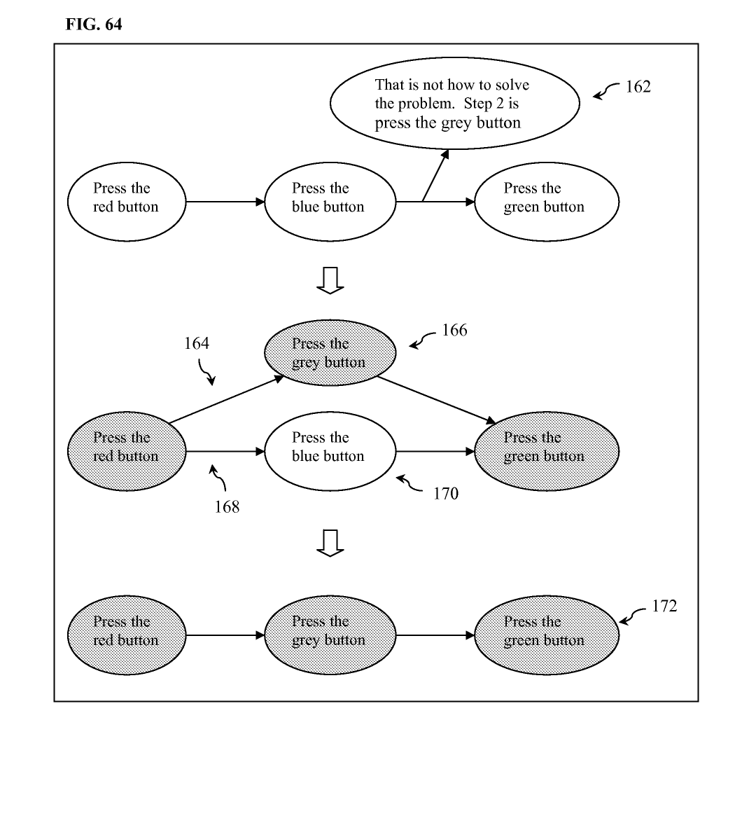

Another way of inserting or deleting or modifying a task is accomplished by patterns that will rearrange the connections in a pathway by reference pointers. Patterns can also create and strengthen a task in a pathway. The sentences from language will contain patterns that will modify tasks. Sentences like: “No. block B is supposed to be on block C”, “That is not how the problem is solved. Step 2 is press the grey button”. These sentences have patterns that will rearrange connection pointers to other data in memory. Referring to FIG. 64, the sentence “That is not how to solve the problem. Step 2 is press the grey button” (task 162) has a pattern that creates a connection 164 to newly created data 166. The previous connection 168 still exists, but the pattern lowered its strength so that data 170 gets weaker and weaker. The pattern also contain how strong the connection 164 should be and how strong data 166 should be. This method of changing data is done, not by how many times pathway 172 is trained, but by a pattern that modifies a data with 1 or several training.

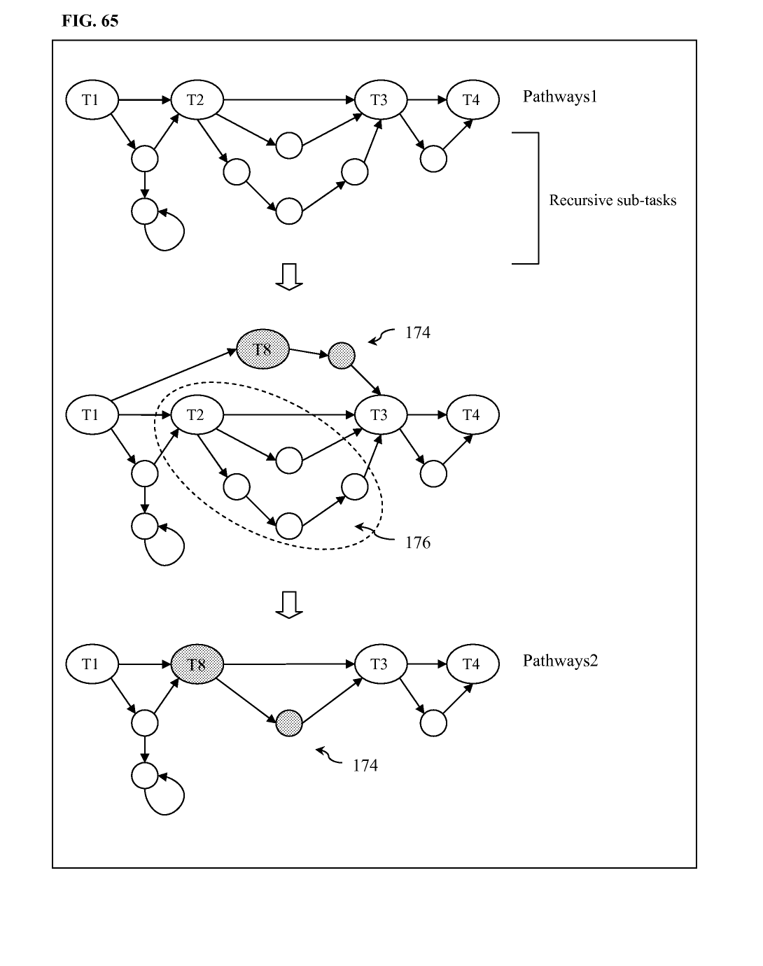

The method above only works for individual tasks, what about sub-tasks in a task? Referring to FIG. 65, sequential events will direct the modified T8 and its sub-task (pointer 174) to point to the continuation within the pathway. By doing this the sub-tasks 176 within T2 are bypassed and T8 and its sub-task is connected to T3. This means an entire task and all of its hierarchical sub-tasks are bypassed. Pathways2 will get stronger and stronger and the next time that the AI program encounters this problem it will follow pathways2 instead of the previous pathways 1.

As the robot learns more and more from teachers, it will constantly be inserting, deleting and modifying tasks in pathways. Pain and pleasure, both innate preference and social acceptance, is used in combinations to decide how desirable a pathway is. If there is an easier method of doing a task it will follow that easier method. If there is a longer method of doing a task, but the robot wants to do it the long method, then it will follow that long method. If the robot is out of time and wants to do the task quickly, then it will follow the shorter method.

Patterns within Tasks

I will be using videogames to illustrate my point about tasks. When playing any game there are rules that has to be followed. When playing golf, the player has to know that the objective is to hit the ball from the start state to the hole in the shortest amount of strokes. When playing a shooting game like Contra for the PS2 the objective is to past all the levels in the game. Fighting a boss in Contra is based on patterns; there will be a certain way that the player can play the game to beat the boss. Sometimes the boss will fire three rounds at the player or it will jump around and stomp the player or it will stay in one place, opening the opportunity for the player to shoot a target. Whatever the circumstances are the player has to know the patterns and use these patterns to beat the game.

In FIG. 66, tasks are marked by sentences and events. These sentences or events encapsulate the instructions to accomplish tasks. As discussed in parent applications, sentences contain meaning that will instruct the AI program to do things, think, focus, act, behave, store, modify, and retrieve data and so forth. Complex intelligence comes from a bootstrapping process to build on previous thought knowledge. In this case, in order to self-modify a pathway (without the help of a teacher) the pathways have to form intelligent thought in terms of trial and error. The AI program has to form a pathway that will try a task and see what the results are and either modify that task or keep that task. It's kind of like forming a practice pathway that will accomplish a goal by trying the most desirable methods first before trying less desirable methods. The AI program will keep whichever methods work and delete methods that don't work.

Patterns that Self-Modify Tasks in Pathways Based on Trial and Error

The most affective type of AI program are those programs that are self-learning and don't require a teacher. When playing a videogame the AI program will use conscious thoughts to teach itself how to past the game—“teachers have thought the robot to teach itself to solve problems”. This is how the robot can play any videogame for any game console without any prior training of the videogame.

In order to generate tasks, sentences in terms of questions are stored in the pathways. The answering of the question is the action the robot will take. Sentences can also be in the form of a statement to generate other statements about the game situation. What is activated in the mind is based on a lifetime worth of learning to play games—games such as basketball, jump rope, chase master, videogames, monopoly, connect four, board games, internet games and so forth. Referring to FIG. 66, the diagram is a universal pathway that is catered to playing and passing a videogame.

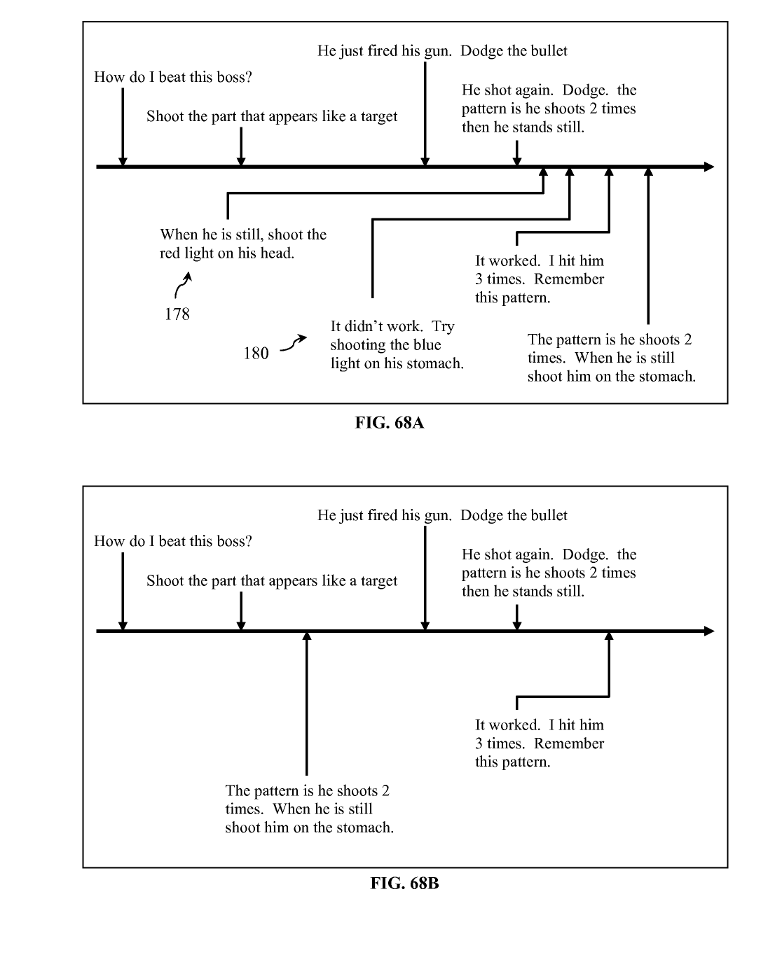

FIGS. 67-68B are pathways that contain tasks to beat bosses in Contra for the PS2. Both examples use the universal pathway to consciously think of ways to beat a boss (FIG. 66). Referring to FIG. 68A, the pathway is experienced once and the robot is trying different methods to beat the boss. Task 178 and task 180 are trial and error tasks. In FIG. 68B, after following the same pathway a second time, task 178 and task 180 from the last experience disappears (FIG. 68A).

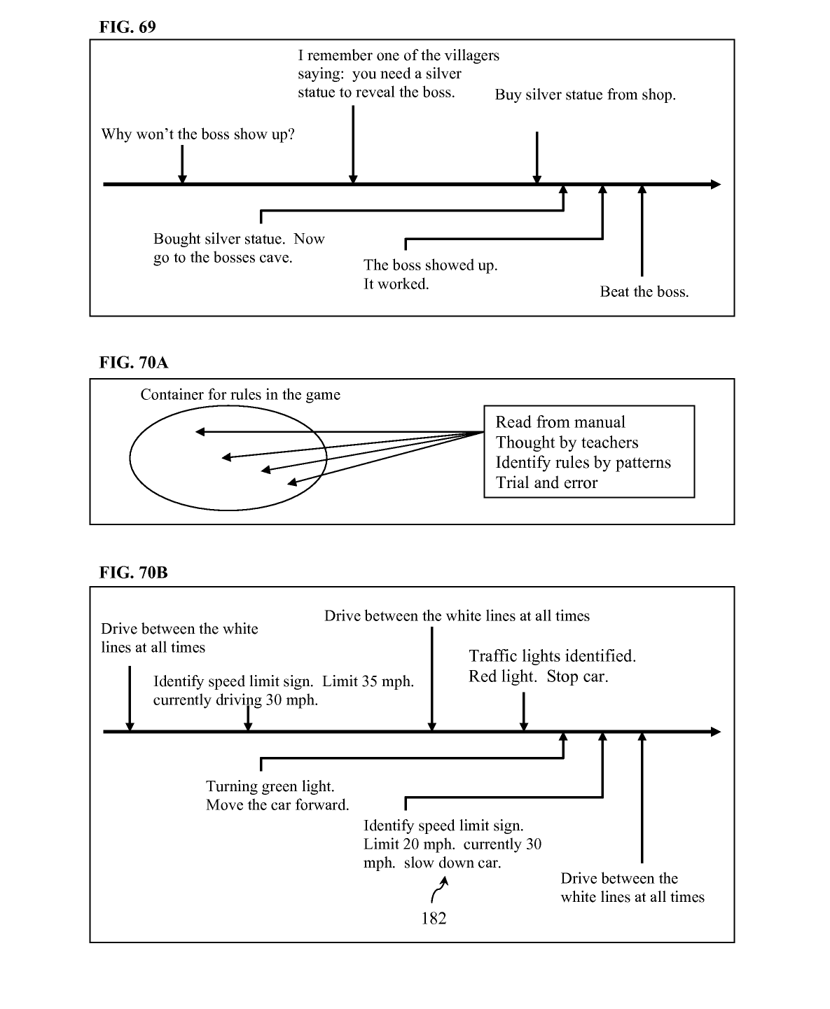

Referring to FIG. 69, this is a pathway to play an obstacle in the legend of Zelda for the Nintendo Wii. The player is wondering why the boss didn't show up. It uses past experiences to generate conscious thoughts to find a solution to the problem. The last task can use the universal pathway to beat a boss (FIG. 66).

In reality, the actual pathways to play a videogame are extremely complex. These three examples illustrate in a basic way how pathways teach itself to accomplish tasks. The average lessons from all games will be stored in a universal pathway. The instructions to accomplish tasks are generated and stored in pathways so that the next time the AI program encounters the same or similar situation it knows what to do to accomplish the task. The pathways can also self-modify instructions to tasks based on trial and error and based on the result of its actions.

Learning Rules and Following Rules in the Videogame

Pathways in memory can form “any” type of intelligence. As always, storing sentences and meaning of sentences is what allows intelligent thought to take place. As far as learning rules and following rules, teachers have to teach the robot about rules and that these rules have to be followed during the game. The universal pathway to learn and follow rules must allow patterns to form a container specifically for rules. Patterns will also identify what the rules are via sentences and events. When the rules are identified the patterns will take the identified rules and store them in the rules container. As the robot plays the game, the robot's conscious will tell itself to follow certain rules at specific times. The robot's conscious will also manage other tasks during the game like achieving goals or managing multiple goals at the same time. When the robot unintentionally breaks a rule, patterns will activate sentences in the robot's conscious to tell the robot that it broke one of the rules. This will prompt the robot to either correct the error or it will accept the rule breaking and remember not to break the same rule in the future.

FIG. 70A is a diagram depicting a pathway to learn and follow rules. Patterns in pathways will link certain data sensed from the environment and certain data from rules. From past experience of a teacher correcting a rule break during a game, the pathway will activate a universal lesson to correct a rule break. This means if the robot breaks a rule the average lessons from teachers of breaking a rule of a game will be activated in the mind. The response of breaking a rule will be activated in the robot's conscious shortly after.

FIG. 70B shows that there are multiple tasks the robot is trying to manage at the same time. Notice that the sentence: “drive between the white lines at all times” is repeatedly activated by the conscious (3 times). The reason why is because this task is ongoing during driving. While this task is being followed other tasks are also being managed such as reading and following traffic lights, identifying signs on the road and so forth. On task 182, the robot has violated a rule. Patterns will determine when the robot violated a rule. Once the robot's conscious activates a breaking of a rule it will also activate the response from breaking that rule.

Following Instruction from Manuals

When human beings follow instructions from manuals they follow the instructions in linear order—they read the first step, accomplish the first step, then they move on to the next step and so forth until the task they want to accomplish is finished. Since it isn't possible for a human being to read the entire instruction manual once and do all the steps without rereading the instructions, we have to teach the robot to read the first step, accomplish the first step, then move on to the next step. By teaching the robot with many examples on reading manuals and following the instructions step by step, it can create a universal pathway in memory to accomplish “all” tasks that require the robot to read and follow instructions from manuals step by step.

Another method is to tell the robot step-by-step instructions and let the robot recall these instructions from memory and do the steps in linear order. The teacher will be using sentences to guide the robot to either recall what the steps were or guide the robot to follow the steps. Patterns will be established between all the lessons and actions of the robot. When teachers give the robot many examples on this learning method it will be able to listen to instructions from a teacher and to follow the instructions step by step.

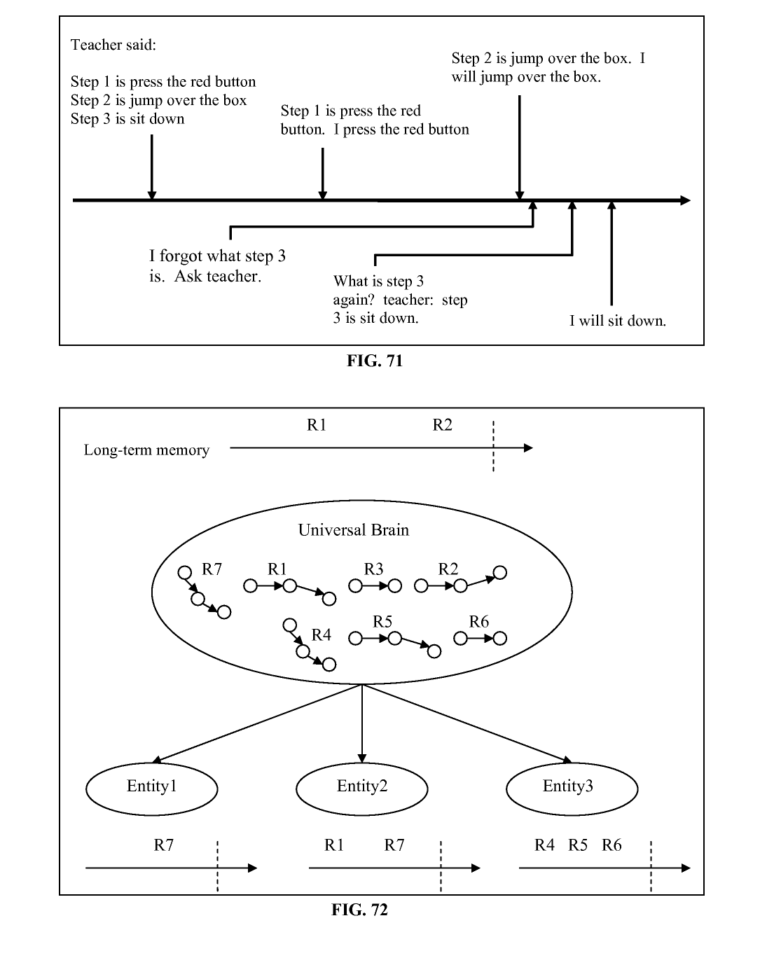

Referring to FIG. 71, there is a pattern in the pathway in that the instructions in steps 1, 2, 3 are probably scattered in different parts in memory. The only way that the instructions can be followed to accomplish steps 1, 2, 3 is by using the patterns to search for the instructions to steps 1, 2, 3 in memory. In other words, the pathway also has patterns to search for the instructions to steps 1, 2, 3. Not just search for the steps, but also copy the instructions to each step into the current pathway.

As more and more data is experienced by the robot, the pathways in memory modify itself by inserting, deleting, and changing data in pathways. Each pathway will be averaged out and the most important tasks are stored in the pathways. The environment, most notably lessons from teachers, form the pathways in memory. These pathways can be arranged in such a way that any form of intelligence can be produced. A pathway to self-learn and self-accomplish tasks can also be formed. In other words teachers can teach the robot to “teach” itself and “learn” how to solve problems. This is how the AI program can play any videogame for any game console without knowing the rules or objective of the game. And to beat any videogame for any game console regardless of how hard the game is.

Consciously Aware of the Environment

The robot stores 4 different data types in pathways: 5 sense objects, hidden objects, activated element objects and pattern objects. The activated element objects are the conscious of the robot. As the robot learns more and more from the environment the conscious thoughts get stronger and stronger. The 5 sense objects from the environment will have low powerpoints because there are many variations, but the activated element objects (or conscious thoughts) are consistent because language, in the form of sentences or meaning to sentences, repeats itself.

What happens next is the conscious thoughts get stronger and stronger to the point where the machine is “aware” of itself. This conscious controls the robot to: plan tasks, execute tasks, modify tasks, try tasks and so forth. The data from the environment is partially ignored at this point. The conscious will do things that will benefit the host's existence and to achieve goals in a dynamic way by trying and testing the environment and modifying itself so that the next time the robot will not make the same mistakes again.

The robot is now aware of its existence and the conscious is built to the point where it will listen to both god (innate built in traits) and society (environment). In terms of playing a videogame, the 5 senses are negligible and the main focus is the obstacles in the game. The conscious provide the rules, the goals, and actions to take to achieve goals. It also provides the robot with what it should be focusing on in the game. If the robot is playing a racing game it should focus its attention on multiple objects in the game. The lines on the road are important because one of the rules is to stay in the middle of the 2 lines on the road. It has to focus on signs on the road such as speed limit to follow speed limit rules or focus on street names to identify its present location or plan out what routes to take from its current location or be aware of cars around its car or identify and follow traffic lights. All these tasks are managed by the conscious.

The HAI program is not an expert system, it actually thinks like a human being. When driving a car the AI program is driving the car based on human intelligence. It doesn't use GPS as a map to drive from one destination to the next. It uses human intelligence. The way that the AI program plans a route is by lessons learned by teachers. A map that was previously observed will activate in the mind. This map can also be a fabricated map where it takes images from maps previously learned to fabricate new routes. Based on past driving experiences it will plan out which is the best route to take. If there is an accident or certain streets are blocked the machine will try alternative routes based on human intelligence. Some of the route planning is done “at the moment”, wherein the robot has to identify the street and determine where to go next.

Current expert AI cars lack the ability of common sense. Things such as: adapting to changing traffic laws, driving in different countries or environments, driving in snow or flooded streets, driving while doing other tasks, finding parking, determining which areas in the environment are dangerous and so forth. Common sense things such as smoke in the air will indicate a fire up ahead or possible falling rocks or possible hazards in the streets. Either the programmer will try to manually insert all these abilities or the AI car lack the ability of common sense. What if the country changes the rules of driving completely, the expert AI car won't be able to adapt. On the other hand, human beings are able to modify the rules and apply them immediately.

AI Machines Thousands of Times Smarter than Human Beings

This technology is a time machine. Not a time machine to travel through time, but a time machine to predict the future and past with pinpoint accuracy. Every single event in history can be predicted, everything from the origins of the earth, to the birth of Christ, to how stonehedge was built to every crime in history.

Of course the technology isn't as simple as most people think it is. The machine must be able to “know” all atoms that are in the current environment (all atoms in the entire universe for every fraction of a second). All chemical changes that each atom goes through every millisecond must be recorded. Based on patterns from past experiences it can infer from the current state where atoms where in the past. In addition to past experiences, the machine can use knowledge from books in the library to guide and validate its past predictions.

This section is devoted to expanding the human artificial intelligence program to make it think thousands of times faster—to take human intelligence into the next stage of evolution by producing an entity that can think, reason, solve problems, and predict the future thousands of times faster than a human being.

Universal Entity

Imagine that a human robot has been created and this human robot can think and feel like a human being. A human robot is called an entity. The next step is to build a universal entity. This universal entity has a universal brain that stores all pathways from individual entities. Just like how one entity store and average out pathways, the universal brain will store all pathways experienced by each entity and average all pathways.

The universal entity is an individual that has the knowledge of all of its entities. It will make decisions based on all collected data. The universal entity also experiences life and stores its experiences in the universal brain. Of course, its own pathways are more important than the individual entities' pathways, but individual entities influence the universal entity's decision making.

Building such a brain structure is very important to learning and acting in a community. If there exist 1 million entities and each entity reads a book in the library, then all books stored in a library can be read and understood in less than one day. The universal entity will have all the knowledge in a library in less than one day. If a human were to read every book in a library it will literally take him thousands of years to accomplish.

The universal brain stores new data and prevents any repeated data. If one thousand entities read the same book, only information from that one book will be stored in memory. Anything that repeats itself will be strengthened. The human brain optimizes its storage space by strengthening same data and storing only data that is new. Repeated data can be stored in memory depending on where that data is stored, but the purpose of the brain is to minimize repeated data.

The key here is that the individual entities are not aware of the universal entity. There is no communication between individual entities and the universal entity. If there is no communication then how is the universal entity supposed to control the individual entities? The answer is by changing the environment. Manipulating the environment so that the individual entities do what they are supposed to do.

Strategy games like Populous for SNES require players to make decisions to change the environment so that people living in the environment will prosper. The player can start wars, build rivers, create hurricanes, introduce diseases and so forth. Just like how the game populous works, the universal entity has to change the environment so that the entities that are living in it do what they are supposed to do. If the universal entity wants a cure for cancer, it has to introduce cancer into the population. The entities living in the population will scramble to understand the disease and try to find a cure. Eventually, if the environment is moderated correctly the entities will find a cure for cancer. If it does find a cure for cancer, it can find a faster cure for cancer in the future.

If the universal entity wants the population to build an AI machine thousands of times smarter than a human being, then it has to start a war here and there so that the entities will compete to build better and better technology. Look at what World War II did for the United States, it introduced the computer. Look what business in technology has created: cell phones, the internet, advance cars, faster planes and so forth.

The way that the universal entity can cure cancer in one second is by copying our environment and turning it into a videogame. Next, intelligent species are created that can live and evolve in the videogame. Because of computers the videogame is void of time. One second in the real world is like 1 thousand years in the videogame. By building a self-sustaining and self-evolving environment knowledge can be found by the intelligent entities in the videogame. The universal entity can simply fast forward in the timeline to see what the cure for cancer is.

The Computer Codes

Referring to FIG. 72, each entity (including the universal entity) has a long-term memory. Each pathway has a reference to each entity it came from. When each pathway in a long-term memory is forgotten then the pathway in the universal brain doesn't know where that pathway came from.

Each entity will have a priority in terms of how it influences the universal entity. The priority of each entity is determined by many factors: how similar in physical form is the entity compared to the universal entity. If the universal entity is a male, then males have higher priority. If the universal entity is in his 20's then males in their 20's will have higher priority. The mental structure of each entity's brain is also another factor. Innately, does the entity think and make decisions like the universal entity? The more similar the decision making, the more priority that entity will have. The next factor is the environment, does the entity have a similar type of environment to the universal entity. If the answer is yes, then that entity will have higher priority.

Another factor to higher priority of an entity is the average entity. Does the entity make decisions like the average entity, does the entity think like the average entity, and does the entity act like the average entity. The more normal the entity is the higher its priority.

The higher the priority of the entity the stronger its pathways are in the universal brain. The stronger the pathways are the more likely it will be picked for decision making by the universal entity. Each pathway stored will also be forgotten. If that pathway is not retrained it will be forgotten. Forgetting pathways will also depend on the priority of the individual entities. The less priority the entity has the faster it forgets data.

Like I said before the universal entity has its own long-term memory and it experiences the environment and stores these experiences in the universal brain. The universal entity's own experiences will have higher priority; its' own decision making will primarily be based on its own experiences, but the average decision making from all entities will influence the universal entity in terms of its' decision.

The main reason that the individual entities should not be aware of the universal entity is because they will start to behave chaotically. If the entities knew that the environment is some kind of videogame in a computer and that there is a universal entity that is controlling the environment, it will begin to rebel against the universal entity. It would ask questions like: why did you create cancer, why did you create the hurricane, why do people die and so forth.

The universal entity can easily communicate with the individual entities (using English) by saying: please find a cure for cancer. Depending if the individual entities like or dislike the universal entity it may or may not obey its commands. Most of them will ask this common question: what are you going to give us in return?

Another idea is to create individual entities (or human robots) and command the robots to do tasks as a team. Each team is given a team leader and the team leader coordinate each robot's task and train the robot's to acquire the necessary knowledge to fulfill their task. Since each robot is intelligent then it can go to college and study subject matters and acquire the knowledge to do certain jobs. The robots can study computer science, astrology, medicine, mathematics and so forth. With this team of robots all tasks can be accomplished. Tasks such as building a bridge, building software, commanding a starship, fighting and winning a war, produce a movie or entertain people. (See any difference between training a team of real humans and training a team of human robots to accomplish tasks?)

The question remains: how do we turn intelligent robots into slaves without enslaving them? In other words, how can we enslave human beings without actually enslaving them? The answer is we can't. I don't think this software will ever be packaged and sold in computer stores. We build one of these things and we have to treat it like a human being. As hard as I try to find a way around this problem, I don't think there is a solution. If you watch a movie like I-Robot the movie doesn't make any sense.

Modifications that can be Made to Human Robots to Increase its Intelligence

This section will discuss some of the ways to increase the intelligence of the robot. In some sense human intelligence is the peak—this is as good as it gets. However, it isn't how intelligent the machine is that makes it smart, it's actually the peripheral devices that the robot controls that makes it smart. For example, a human being can only do one math equation at a time. A calculator can do many math equations at a time. The problems that a calculator can solve can surpass human intelligence a thousand folds. Now, imagine a human being using the calculator to do math problems? With the calculator (a peripheral device) the human being can do complex math quickly.

What I'm trying to say is that building a machine that can think at a human-level is a big achievement. With the help of peripheral devices the human robot can do things thousands of times faster than a human being. Let's imagine the peripheral devices that will be introduced in the future. Imagine a small device that scans a book and all sentences, diagrams and pictures from the book are stored in the device. This device will transmit and create pathways in memory based on the contents in the book. In less than one second, the human robot is able to read an entire book. None of the pages of the book were ever flipped and none of the words were ever recognized by the human robot.

By using computers, peripheral devices, and new technology the human robot is able to think and act thousands of times faster than a human being. With this said, I am not inferring that human intelligence is the last frontier. I believe that intelligence is like numbers—it can go to infinite. Below are listings of methods that can be used to increase the intelligence of the human robot.

1. Increase the Amount of Data in Each Frame

Instead of 5 senses stored in the pathways we can store 100 different senses. Each sense can also be enhanced. For example, sight can have 50 cameras instead of one camera or sight can include x-ray vision.

2. Increase the Frame Rate

Currently, the AI program stores one frame per millisecond, we can increase the frame rate to 1,000 frames per millisecond or 1 billion frames per millisecond. The more frames stored in each pathway the more data will be recorded from the environment.

3. Find a Faster Way of Storing, Retrieving and Modifying Information

New and innovative ways of storing, retrieving and modifying information can be used to speed up the robot's mind.

4. Increase the Vocabulary of a Language

More data stored in memory require a larger array of words to describe objects. By increasing the vocabulary of the language, the robot will have more words to classify objects in the environment.

The foregoing has outlined, in general, the physical aspects of the invention and is to serve as an aid to better understanding the intended use and application of the invention. In reference to such, there is to be a clear understanding that the present invention is not limited to the method or detail of construction, fabrication, material, or application of use described and illustrated herein. Any other variation of fabrication, use, or application should be considered apparent as an alternative embodiment of the present invention.

What is claimed is:

1. A method of creating human artificial intelligence in machines and computer based software applications, the method comprising:
(a) an artificial intelligent computer program repeats itself in a single for-loop to:
(i) receive input from the environment based on the 5 senses called the current pathway,
(ii) use an image processor to dissect said current pathway into sections called partial data,
(iii) generate an initial encapsulated tree for said current pathway; and prepare variations to be searched,
(iv) average all data in said initial encapsulated tree for said current pathway,
(v) execute two search functions, one using breadth-first search algorithm and the other using depth-first search algorithm,
(vi) target objects found in memory will have their element objects extracted and all element objects from all said target objects will compete to activate in said artificial intelligent program's mind,
(vii) find best pathway matches,
(viii) find best future pathway from said best pathway matches and calculate an optimal pathway,
(ix) generate an optimal encapsulated tree for said current pathway,
(x) store said current pathway and its' said optimal encapsulated tree in said optimal pathway, said current pathway comprising 4 different data types: 5 sense objects, hidden objects, activated element objects, and pattern objects,
(xi) follow future instructions of said optimal pathway,
(xii) retrain all visual objects in said optimal encapsulated tree starting from the root node,
(xiii) universalize pathways or data in said optimal pathway; and
(xiv) repeat said for-loop from the beginning;
(b) a storage area to store all data received by said artificial intelligent program; and
(c) a long-term memory used by said artificial intelligent program.

2. A method to generate an encapsulated tree for a given movie sequence or individual frame by using dissection functions to dissect and group visual objects exclusively into a tree-like structure, the steps comprising:
(a) a dissect recursion is applied to a movie sequence or individual frame whereby each recursive thread will dissect its own group into a plurality of sub-groups exclusively,
(b) each recursive thread will stop when each group is broken down into its elemental parts, said elemental parts comprises individual pixels or predefined groups of pixels.

3. A method of claim 1, wherein generating an initial encapsulated tree for said current pathway comprising the steps of:
(a) generating an encapsulated tree for old frames in said current pathway by copying sections in previous optimal encapsulated trees,
(b) generating an encapsulated tree for new frames in said current pathway by using the image processor and other functions,
(c) modifying encapsulated trees for old frames closest to the current state based on new frames in said current pathway.

4. A method of claim 3, wherein said image processor generates an initial encapsulated tree for said current pathway by dissecting and grouping the current pathway into an encapsulated tree using 6 dissection functions, comprising:
(a) dissect image layers using previous optimal encapsulated trees,
(b) dissect image layers that are moving,
(c) dissect image layers that are partially moving,
(d) dissect image layers by calculating the 3-dimensional shape of all image layers in the movie sequence,
(e) dissect image layers by calculating dominant color regions using recursion,
(f) dissect image layers using associated rules;
wherein elements in said initial encapsulated tree are called visual objects.

5. A method of claim 4, in which each visual object comprises:
(a) a frame sequence with at least one frame;
(b) three variables, comprising:
(i) average pixel color,
(ii) average total pixel count,
(iii) average normalized point;
(c) priority percent;
(d) powerpoints;
(e) existence state;
(f) child encapsulated links;
(g) parent encapsulated links;
(h) domain number;
(i) search data.

6. A method of claim 1, wherein said averaging data from said initial encapsulated tree is accomplished by calculating the average of all variables in each visual object; and designating an existence state of each visual object from one frame to the next with one of the following: existing, non-existing, and changed.

7. A method of claim 1, in which said search function searches for said initial encapsulated tree for said current pathway and compares the data with memory encapsulated trees or pathways in memory, wherein elements in said initial encapsulated tree are called visual objects and elements in said memory encapsulated trees are called memory objects.

8. A method of claim 7, wherein said search function searches for said initial encapsulated tree or current pathway by allocating search points and guess points to certain search areas in memory, comprising two functions:
(a) a first search function uses search points to match a visual object to a memory object and uses breadth-first search, whereby it searches for visual objects in said initial encapsulated tree from the top-down and searches for all child visual objects before moving on to the next level;
(b) a second search function uses guess points to match a memory object to a visual object, uses depth-first search to find matches, and the search steps comprises:
(i) from a memory object match in memory the search function will travel on the strongest-closest memory encapsulated connections to find possible memory objects,
(ii) certain criterias determine which memory objects will be used to match with possible visual objects in said initial encapsulated tree,
(iii) when a memory object is picked, match with visual objects in said initial encapsulated tree and output a match percent.

9. A method of claim 8, wherein said certain criterias to determine which memory object to pick, comprises:
(a) the stronger the memory encapsulated connections leading to the memory object are the better chance it will be picked,
(b) the stronger the powerpoints of the memory object is the better chance it will be picked.

10. A method of claim 8, wherein said guess points will match visual objects in said initial encapsulated tree that fall in the coordinates of pixels and the actual pixels in a memory object, said memory object should match to the least amount of visual objects in said initial encapsulated tree.

11. A method of claim 8, wherein the second search function will follow the general search areas outputted by the first search function; in the case said second search function deviates from the general search area, each guess point deviated will stop, backtrack, try alternative searches, and wait for further search areas from said first search function.

12. A method of claim 8, wherein said search function initially designate a search point to each normalized visual object in said initial encapsulated tree, each search point is automatic and executes recursive search points or guess points, each recursive search point or guess point will slowly combine their visual object matches in said initial encapsulated tree and slowly converge on the current pathway.

13. A method of claim 12, wherein said search function will search for visual objects closest to the current state first and slowly search for visual objects farther away from the current state and devote more search points and guess points to visual objects closest to the current state, comprising the steps of:
(a) searching for newly created normalized visual objects from new frames first,
(b) searching for normalized visual objects from old frames,
(c) searching for unmatched visual objects from old frames.

14. A method of claim 8, wherein said search function designates search points or guess points to said first search function and said second search function, each search point or guess point will find matches in memory, the steps comprising:
(a) if matches are successful or within a success threshold, modify initial encapsulated tree by increasing the powerpoints and priority percent of visual object/s involved in successful search;
(b) if matches are not successful or within an unsuccessful threshold, try a new alternative visual object search and modify initial encapsulated tree by decreasing the powerpoints and priority percent of visual object/s involved in unsuccessful search;
(c) if alternative visual object search is a better match than the original visual object match modify initial encapsulated tree by deleting the original visual object and replacing it with said alternative visual object.

15. A method of claim 8, wherein each search point comprises radius points, said radius points are equally spaced out points that can have 1 or more copies of itself to triangulate a match area, the steps to triangulate a match area comprising:
(a) designate a visual object in said initial encapsulated tree to search for;
(b) determine the amount of radius points to use for the search;
(c) match each radius point with a memory object and triangulate an optimal memory object to compare;
(d) compare said visual object with optimal memory object and output a match percent.

16. A method of claim 8, wherein each search point or guess point will execute one or two recursive search threads depending on each search point's or guess point's search results, the steps comprising:
(a) if a search point successfully finds a visual object match in memory execute 2 search threads:
(i) search_point (visual object),
(ii) guess_point (memory object),
else if a search point unsuccessfully finds a visual object match in memory execute 1 search thread:
(iii) search_point (visual object);
(b) if a guess point successfully finds a memory object match in said initial encapsulated tree execute 2 search threads:
(i) guess_point (memory object),
(ii) search_point (visual object),
else if a guess point unsuccessfully finds a memory object match in said initial encapsulated tree execute 1 search thread:
(iii) guess_point (memory object).

17. A method of claim 1, in which additional objects generated by visual objects during the search process will generate its own encapsulated tree and each encapsulated tree will be added to said initial encapsulated tree, said additional objects comprises: hidden objects and learned objects or activated element objects.

18. A method of claim 1, wherein said generating an optimal encapsulated tree for said current pathway comprises the steps of:
(a) generating an encapsulated tree for each data type: 5 sense objects, hidden objects, activated element objects and pattern objects, said generating an encapsulated tree for visual objects comprises 5 criterias:
(i) breaking down and grouping visual objects based on the strongest encapsulated connections in memory leading to the optimal pathway,
(ii) breaking down and grouping visual objects based on previous optimal encapsulated trees,
(iii) modifying pre-existing visual objects from previous optimal encapsulated trees,
(iv) breaking down and grouping new visual objects based on the initial encapsulated tree,
(v) breaking down and grouping visual objects influenced by the encapsulated trees from the other 3 data types: hidden objects, activated element objects and pattern objects,
(b) combine each encapsulated tree from the 4 data types: 5 sense objects, hidden objects, activated element objects and pattern objects into one hybrid encapsulated tree, whereby all encapsulated objects from different data types are grouped together.

19. A method of claim 18, wherein objects in said optimal encapsulated tree provide reference pointers to objects that are equal, objects that generate hidden objects, or objects involved in pattern objects.

20. A method of claim 1, wherein sequential pathways stored in said memory or 3-dimensional grid can form any type of intelligence, the method comprising:
(a) teachers teach different subject matters to said artificial intelligent program using language and 5 sense data from the environment, said subject matters comprises: math, language, computer science, medicine, history, sports, art, science, analytical skills and life skills;
(b) sequential pathways in said memory learn knowledge by a bootstrapping process, wherein new knowledge builds on previously learned knowledge;
(c) said artificial intelligent program modifies data in sequential pathways by inserting, deleting and modifying data based on learning or trial and error techniques;
(d) sequential pathways stored in said memory forget information automatically or by means of patterns in sentences,
whereby the intelligence formed in sequential pathways comprises at least one or a combination of the following: discrete math functions comprising: for-loops, if-then statements, and-statements, or-statements, sequence data, static data, random data and pattern data; grammar rules, understanding meaning to sentences, self-learning behavior, self-modifying behavior, self-teaching behavior, planning tasks, solving interruption of tasks, execution of one or multiple tasks simultaneously, analyzing a situation, controlling the robot's own body functions, thinking, focusing and storing, retrieving and modifying data in said memory.
